(19) United States
(12) Patent Application Publication
(10) Pub. No.: US 2005/0230975 A1
(43) Pub. Date: Oct. 20, 2005

(54) Series and parallel combined dual power drive system

(76) Inventor: Tai-Her Yang, Si-Hu Town (TW)

Correspondence Address: RABIN & BERDO, P.C., Suite 500, 1101 14th Street, N.W., Washington, DC, 20005, US

(21) Appl. No.: 10/851,207

(22) Filed: May 24, 2004

Related U.S. Application Data
(63) Continuation-in-part of application No. 10/826,392, filed on Apr. 19, 2004, now abandoned.

(51) Int. Cl. H02P 9/04; F02C 6/00; F01C 13/00

(52) U.S. Cl. 290/4 R

(57) ABSTRACT

A series and parallel combined dual power system operates as a series combined power system, or as a parallel combined power system; the power from an engine directly drive the load; the system engages in the operation as the series combined power system incase of a light load; the load is driven by the engine in case of a normal load; an optional rechargeable device is adapted to the system; either or both of a primary and a secondary dynamo-electric units functions as a motor on the power from the rechargeable device to jointly drive the load with the power from the engine; and functions to provide power drive in case of a light load.

This application is a Continuation-In-Part of my U.S. patent application Ser. No. 10/826,392, filed Apr. 19, 2004.

### BACKGROUND OF THE INVENTION

(a) Field of the Invention

The present invention is related to a series and parallel combined dual power drive system for the engine functioning as the active rotation power source to directly drive a load, the system provides the following functions:
Operating as a series combined power system, wherein, the engine drives a primary dynamo-electric unit to function as a generator with the power generated to drive a secondary dynamo-electric unit to output mechanical rotation kinetics to drive the load and regulate the engine to operate at a constant speed yielding higher energy efficiency; the constant speed operation is defined as the range of operation speed wherein the engine is running at lower fuel consumption but paid the operation region with comparatively higher fuel saving of comparatively higher output power so to reach the brake specific fuel consumption; or when an optional rechargeable device is added to the system, the power generated by the primary dynamo-electric unit as driven by the engine charges the rechargeable device, or the power from the rechargeable device and that from the primary dynamo-electric unit jointly drive the secondary dynamo-electric unit to function as a motor to output to regulate the engine operating in a constant speed of comparatively higher energy efficiency; again, the constant speed operation is defined as the range of operation speed wherein the engine is running at lower fuel consumption but paid the operation region with comparatively higher fuel saving of comparatively higher output power so to reach the brake specific fuel consumption;
The load is driven by the rotation kinetics from the engine power;
When adapted with the optional rechargeable device, the system provides the operation of the parallel combined power system for the power from the rechargeable device to drive either or both of the primary and the secondary dynamo-electric units to function as a motor to jointly drive the load with the power from the engine, or in case of a light load, the kinetics form the engine is used to drive either or both of the primary and the secondary dynamo-electric units to function as a generator to charge the rechargeable device or supply power to another load;
The power from the rechargeable device drives either or both of the primary and the secondary dynamo-electric units to function as a motor for driving a load;
The power from the engine drives either or both of the primary and the secondary dynamo-electric units to function as a generator to charge the rechargeable device or to supply power to another load;
The load is used to inversely drive either or both of the primary and the secondary dynamo-electric units to function as a generator to charge the rechargeable device or supply power to another load;
Mechanical damper of the engine functions as the brake, or if the rechargeable device is adapted, either or both of the primary and the secondary dynamo-electric units operates at the same time as a generator to charge the rechargeable device or to supply power to another load for creating the braking function by regeneration;
The rechargeable device drives either or both of the primary and the secondary dynamo-electric units to function as a motor to start the engine; and
The system provides all or any part of those functions described above.
   The system by providing all or any part of those functions described above corrects the defectives of the lower efficiency and higher pollution found with the engine when operating at low power output and low speed.

(b) Description of the Prior Art

Conventional land, surface or air carriers are usually provided with a single power system. In recent years, as demanded by energy saving and pollution control appeals, major efforts have been put into the research and development of dual power drive system. Wherein, significant progress has been down in the combined dual power system containing rotation kinetics outputted form a combustion engine and that outputted from a power driven motor. Looking back those combined is dual power systems already having been developed, they include:
1. Series combined power system: the engine is used to drive the motor, in turn, the power from the generator drives the motor to create rotation kinetics to drive the load; this system has its flaw in a wild difference in the efficiency of the system under various load rate; large dynamo-electric rated capacity, consuming too much space, heavier and higher cost since the motor and the generator bear all the powers;
2. Energy storage series drive system: with normal load, the engine is used to drive the generator, in turn, the power from the generator drives the motor to output rotation kinetics to drive the load; in case of a light load, the power from generator while driving the motor, is partially inputted into the rechargeable device for storing energy so that if the engine stops running, the power from the rechargeable device drives the motor to output rotation kinetics to drive the load for reducing pollution and upgrading energy efficiency; in case of a heavy load, the power from the generator as driven the engine and that from the rechargeable device are jointly outputted to the motor to output rotation kinetics for driving the load;
3. Parallel combined power system: with a normal load, the rotation kinetics outputted from the engine directly drive the load; in case of a light load, the motor drawn by the engine is switched to function as a generator to charge the rechargeable device or to supply power to another load; or if the engine stops running, the power from the rechargeable device drives the motor to output rotation kinetics for driving the load to upgrade energy efficiency and reduce pollution; and in case of a heavy load, the rotation kinetics outputted from the engine and that from the motor as driven by the rechargeable device jointly drive the load; the flaw of the system rests in that it requires the rechargeable device with sufficient capacity.

### SUMMARY OF THE INVENTION

The primary purpose of the present invention is to provide a series and parallel combined dual power system. While providing the power form the engine to directly drive the load; the series combined power system operates and the engine drives in case of a normal load; when the optional rechargeable device is adapted to the system, either or both of the primary and the secondary dynamo-electric units operates as a motor on the power supplied from the rechargeable device so to jointly drive the load with the power from the engine; and in case of a light load, the system executes the power drive.

### BRIEF DESCRIPTION OF THE DRAWINGS

FIG. 1 is a system block chart of a preferred embodiment of the present invention.

FIG. 2 is another system block chart comprised of the primary power unit taken from the preferred embodiment as illustrated in FIG. 1.

FIG. 3 is a schematic view showing that a rechargeable device is adapted to the system of the preferred embodiment to engage in the operation as the series combined power system with controllable engine speed.

FIG. 4 is a schematic view showing that the preferred embodiment of the system illustrated in FIG. 2 adapted with the rechargeable device is operating as the series combined power system with the engine running at a constant speed.

FIG. 5 is a schematic view showing that the preferred embodiment of the system illustrated in FIG. 2 not adapted with the rechargeable device is engaged in the operation as the series combined power system with controllable engine speed.

FIG. 6 is a schematic view showing that the preferred embodiment of the system illustrated in FIG. 2 not adapted with the rechargeable device is operating as the series combined power system with the engine running at a constant speed.

FIG. 7 is a schematic view showing that the preferred embodiment of the system illustrated in FIG. 2 operates to drive a load by the power from the engine.

FIG. 8 is a schematic view showing that the preferred embodiment of the system illustrated in FIG. 2 jointly drive the load using the engine power and both of a primary and a secondary dynamo-electric units driven by the rechargeable device.

FIG. 9 is a schematic view showing that the preferred embodiment of the system illustrated in FIG. 2 jointly drive the load using the engine power and the primary dynamo-electric units driven by the rechargeable device.

FIG. 10 is a schematic view showing that the preferred embodiment of the system illustrated in FIG. 2 jointly drive the load using the engine power and the secondary dynamo-electric units driven by the rechargeable device.

FIG. 11 is a schematic view showing that the preferred embodiment of the system illustrated in FIG. 2 operates to drive the load by the power of engine, and the primary dynamo-electric unit is driven to function as a generator to charge the rechargeable device or to supply power to another load.

FIG. 12 is a schematic view showing that the preferred embodiment of the system illustrated in FIG. 2 operates to drive the load by the power of engine, and the secondary dynamo-electric unit is driven to function as a generator to charge the rechargeable device or to supply power to another load.

FIG. 13 is a schematic view showing that the preferred embodiment of the system illustrated in FIG. 2 operates to drive the load by the power of engine, and both of the primary and the secondary dynamo-electric units function as a generator to charge the rechargeable device or to supply power to another load.

FIG. 14 is a schematic view showing that the preferred embodiment of the system illustrated in FIG. 2 operates to drive the primary dynamo-electric unit by the power from the rechargeable unit for driving the load.

FIG. 15 is a schematic view showing that the preferred embodiment of the system illustrated in FIG. 2 operates to drive the secondary dynamo-electric unit by the power from the rechargeable unit for driving the load.

FIG. 16 is a schematic view showing that the preferred embodiment of the system illustrated in FIG. 2 operates to drive both of the primary and the secondary dynamo-electric units by the power from the rechargeable unit for driving the load.

FIG. 17 is a schematic view showing that the preferred embodiment of the system illustrated in FIG. 2 operates on the power from the engine running at a constant speed to drive the primary dynamo-electric unit to function as a generator to charge the rechargeable device and to supply power to another load.

FIG. 18 is a schematic view showing that the preferred embodiment of the system illustrated in FIG. 2 operates on the power from the engine running at a constant speed to drive the secondary dynamo-electric unit to function as a generator to charge the rechargeable device and to supply power to another load.

FIG. 19 is a schematic view showing that the preferred embodiment of the system illustrated in FIG. 2 operates on the power from the engine running at a constant speed to drive both of the primary and the secondary dynamo-electric units to function as a generator to charge the rechargeable device or to supply power to another load.

FIG. 20 is a schematic view showing that the preferred embodiment of the system illustrated in FIG. 2 has the load the draw the primary dynamo-electric unit to regenerate by reclaiming the kinetics so to charge the rechargeable device or to supply power to another load.

FIG. 21 is a schematic view showing that the preferred embodiment of the system illustrated in FIG. 2 has the load the draw the secondary dynamo-electric unit to regenerate by reclaiming the kinetics so to charge the rechargeable device or to supply power to another load.

FIG. 22 is a schematic view showing that the preferred embodiment of the system illustrated in FIG. 2 has the load the draw both of the primary and the secondary dynamo-electric units to regenerate for reclaiming the kinetics so to charge the rechargeable device or to supply power to another load.

FIG. 23 is a schematic view showing that the preferred embodiment of the system illustrated in FIG. 2 exercises a braking on the load by means of a mechanical damper of the engine.

FIG. 24 is a schematic view showing that the preferred embodiment of the system illustrated in FIG. 2 exercises a braking on the load by means of the mechanical damper of the engine and drives the primary dynamo-electric unit to regenerate for charging the rechargeable device or supplying power to another load.

FIG. 25 is a schematic view showing that the preferred embodiment of the system illustrated in FIG. 2 exercises a braking on the load by means of the mechanical damper of the engine and drives the secondary dynamo-electric unit to regenerate for charging the rechargeable device or supplying power to another load.

FIG. 26 is a schematic view showing that the preferred embodiment of the system illustrated in FIG. 2 exercises a braking on the load by means of the mechanical damper of the engine and drives both of the primary and the secondary dynamo-electric units to regenerate for charging the rechargeable device or supplying power to another load.

FIG. 27 is a schematic view showing that the preferred embodiment of the system illustrated in FIG. 2 uses the power from the rechargeable device to drive the primary dynamo-electric unit to start the engine.

FIG. 28 is a schematic view showing that the preferred embodiment of the system illustrated in FIG. 2 uses the power from the rechargeable device to drive the secondary dynamo-electric unit to start the engine.

FIG. 29 is a schematic view showing that the preferred embodiment of the system illustrated in FIG. 2 uses the power from the rechargeable device to drive both of the primary and the secondary dynamo-electric units to start the engine.

FIG. 30 is a schematic view showing that the preferred embodiment of the system illustrated in FIG. 2 is not adapted with a clutch between the output end and the load.

FIG. 31 is a schematic view showing that the preferred embodiment of the system illustrated in FIG. 30 is adapted with the rechargeable unit to operate as the series combined power system with controllable engine speed.

FIG. 32 is a schematic view showing that the preferred embodiment of the system illustrated in FIG. 30 adapted with the rechargeable device operates as the series combined power system with the engine running at a constant speed.

FIG. 33 is a schematic view showing that the preferred embodiment of the system illustrated in FIG. 30 operate as the series combined power system with controllable engine speed without the adaptation of a rechargeable unit.

FIG. 34 is a schematic view showing that the preferred embodiment of the system illustrated in FIG. 30 operate as the series combined power system with the engine running at constant speed without the adaptation of a rechargeable unit.

FIG. 35 is a schematic view showing that the preferred embodiment of the system illustrated in FIG. 30 operates on the power from the engine to drive the load.

FIG. 36 is a schematic view showing that the preferred embodiment of the system illustrated in FIG. 30 operates on the power from the engine to jointly drive the load with both of the primary and the secondary dynamo-electric units driven by the rechargeable device.

FIG. 37 is a schematic view showing that the preferred embodiment of the system illustrated in FIG. 30 operates on the power from the engine to jointly drive the load with the primary dynamo-electric unit driven by the rechargeable device.

FIG. 38 is a schematic view showing that the preferred embodiment of the system illustrated in FIG. 30 operates on the power from the engine to jointly drive the load with the secondary dynamo-electric unit driven by the rechargeable device.

FIG. 39 is a schematic view showing that the preferred embodiment of the system illustrated in FIG. 30 operates on the power from the engine to drive the load, and drive the primary dynamo-electric unit to function as a generator to charge the rechargeable device or supply power to another load.

FIG. 40 is a schematic view showing that the preferred embodiment of the system illustrated in FIG. 30 operates on the power from the engine to drive the load, and drive the secondary dynamo-electric unit to function as a generator to charge the rechargeable device or supply power to another load.

FIG. 41 is a schematic view showing that the preferred embodiment of the system illustrated in FIG. 30 operates on the power from the engine to drive the load, and drive both of the primary and the secondary dynamo-electric units to function as a generator to charge the rechargeable device or supply power to another load.

FIG. 42 is a schematic view showing that the preferred embodiment of the system illustrated in FIG. 30 operates on the power from the rechargeable device to drive the primary dynamo-electric unit to further drive the load.

FIG. 43 is a schematic view showing that the preferred embodiment of the system illustrated in FIG. 30 operates on the power from the rechargeable device to drive the secondary dynamo-electric unit to further drive the load.

FIG. 44 is a schematic view showing that the preferred embodiment of the system illustrated in FIG. 30 operates on the power from the rechargeable device to drive both of the primary and the secondary dynamo-electric units to further drive the load.

FIG. 45 is a schematic view showing that the preferred embodiment of the system illustrated in FIG. 30 has the engine to run at constant speed for driving the primary dynamo-electric unit to function as a generator to charge the rechargeable device or to supply power to another load.

FIG. 46 is a schematic view showing that the preferred embodiment of the system illustrated in FIG. 30 has the load to drive the primary dynamo-electric unit to regenerate by reclaiming the kinetics so to charge the rechargeable device or to supply power to another load.

FIG. 47 is a schematic view showing that the preferred embodiment of the system illustrated in FIG. 30 has the load to drive the secondary dynamo-electric unit to regenerate by reclaiming the kinetics so to charge the rechargeable device or to supply power to another load.

FIG. 48 is a schematic view showing that the preferred embodiment of the system illustrated in FIG. 30 has the load to drive both of the primary and the secondary dynamo-electric units to regenerate by reclaiming the kinetics so to charge the rechargeable device or to supply power to another load.

FIG. 49 is a schematic view showing that the preferred embodiment of the system illustrated in FIG. 30 has the mechanical damper from the engine to exercise a brake to the load.

FIG. 50 is a schematic view showing that the preferred embodiment of the system illustrated in FIG. 30 has the mechanical damper from the engine to exercise a brake on the load and to drive the primary dynamo-electric unit to regenerate for charging the rechargeable device or supplying power to another load.

FIG. 51 is a schematic view showing that the preferred embodiment of the system illustrated in FIG. 30 has the mechanical damper from the engine to exercise a brake on the load and to drive the secondary dynamo-electric unit to regenerate for charging the rechargeable device or supplying power to another load.

FIG. 52 is a schematic view showing that the preferred embodiment of the system illustrated in FIG. 30 has the mechanical damper from the engine to exercise a brake on the load and to drive both of the primary and the secondary dynamo-electric units to regenerate for charging the rechargeable device or supplying power to another load.

FIG. 53 is a schematic view showing that the preferred embodiment of the system illustrated in FIG. 30 operates on the power from the rechargeable device to drive the primary dynamo-electric unit to start the engine.

FIG. 54 is a schematic view showing that no clutch is provided between an active rotation power source and the primary dynamo-electric unit of the preferred embodiment of the system illustrated in FIG. 2 FIG. 55 is a schematic view showing that the preferred embodiment of the system illustrated in FIG. 54 is adapted with the rechargeable unit to operate as the series combined power system with controllable engine running speed.

FIG. 56 is a schematic view showing that the preferred embodiment of the system illustrated in FIG. 54 is adapted with the rechargeable unit to operate as the series combined power system with the engine running at constant speed.

FIG. 57 is a schematic view showing that the preferred embodiment of the system illustrated in FIG. 54 operates as the series combined power system with controllable engine running speed without the adaptation of the rechargeable device.

FIG. 58 is a schematic view showing that the preferred embodiment of the system illustrated in FIG. 54 operates as the series combined power system with the engine running at constant speed.

FIG. 59 is a schematic view showing that the preferred embodiment of the system illustrated in FIG. 54 operated on the power form the engine to drive the load.

FIG. 60 is a schematic view showing that the preferred embodiment of the system illustrated in FIG. 54 operates on the power from the engine to jointly drive the load with both of the primary and the secondary dynamo-electric units driven by the rechargeable device.

FIG. 61 is a schematic view showing that the preferred embodiment of the system illustrated in FIG. 54 operates on the power from the engine to jointly drive the load with both of the primary dynamo-electric unit driven by the rechargeable device.

FIG. 62 is a schematic view showing that the preferred embodiment of the system illustrated in FIG. 54 operates on the power from the engine to jointly drive the load with both of the secondary dynamo-electric unit driven by the rechargeable device.

FIG. 63 is a schematic view showing that the preferred embodiment of the system illustrated in FIG. 54 operates on the power from the engine to drive the load and to drive the primary dynamo-electric unit to function as a generator for charging the rechargeable device or supplying power to another load.

FIG. 64 is a schematic view showing that the preferred embodiment of the system illustrated in FIG. 54 operates on the power from the engine to drive the load and to drive the secondary dynamo-electric unit to function as a generator for charging the rechargeable device or supplying power to another load.

FIG. 65 is a schematic view showing that the preferred embodiment of the system illustrated in FIG. 54 operates on the power from the engine to drive the load and to drive both of the primary and the secondary dynamo-electric units to function as a generator for charging the rechargeable device or supplying power to another load.

FIG. 66 is a schematic view showing that the preferred embodiment of the system illustrated in FIG. 54 has the power from the rechargeable device to drive the secondary dynamo-electric unit to further drive the load.

FIG. 67 is a schematic view showing that the preferred embodiment of the system illustrated in FIG. 54 has the engine running at constant speed to drive the primary dynamo-electric unit to function as a generator for charging the rechargeable device or supplying power to another load.

FIG. 68 is a schematic view showing that the preferred embodiment of the system illustrated in FIG. 54 has the engine running at constant speed to drive the secondary dynamo-electric unit to function as a generator for charging the rechargeable device or supplying power to another load.

FIG. 69 is a schematic view showing that the preferred embodiment of the system illustrated in FIG. 54 has the engine running at constant speed to drive both of the primary and the secondary dynamo-electric units to function as a generator for charging the rechargeable device or supplying power to another load.

FIG. 70 is a schematic view showing that the preferred embodiment of the system illustrated in FIG. 54 has the load to draw the secondary dynamo-electric unit to regenerate by reclaiming the kinetics so to chare the rechargeable device or to supply power to another load.

FIG. 71 is a schematic view showing that the preferred embodiment of the system illustrated in FIG. 54 has the mechanical damper of the engine to exercise a brake on the load.

FIG. 72 is a schematic view showing that the preferred embodiment of the system illustrated in FIG. 54 has the mechanical damper of the engine to exercise a brake on the load and to drive the primary dynamo-electric unit to regenerate for charging the rechargeable device or supplying power to another load.

FIG. 73 is a schematic view showing that the preferred embodiment of the system illustrated in FIG. 54 has the mechanical damper of the engine to exercise a brake on the load and to drive the secondary dynamo-electric unit to regenerate for charging the rechargeable device or supplying power to another load.

FIG. 74 is a schematic view showing that the preferred embodiment of the system illustrated in FIG. 54 has the mechanical damper of the engine to exercise a brake on the load and to drive both of the primary and the secondary dynamo-electric units to regenerate for charging the rechargeable device or supplying power to another load.

FIG. 75 is a schematic view showing that the preferred embodiment of the system illustrated in FIG. 54 operates on the power from the rechargeable device to drive the primary dynamo-electric unit to start the engine.

FIG. 76 is a schematic view showing that the preferred embodiment of the system illustrated in FIG. 54 operates on the power from the rechargeable device to drive the secondary dynamo-electric unit to start the engine.

FIG. 77 is a schematic view showing that the preferred embodiment of the system illustrated in FIG. 54 operates on the power from the rechargeable device to drive both of the primary and the secondary dynamo-electric units to start the engine.

FIG. 78 is a schematic view showing that the preferred embodiment of the system illustrated in FIG. 2 is not adapted with a clutch either between the output end and the load side, or between the active rotation power source and the primary dynamo-electric unit.

FIG. 79 is a schematic view showing that the preferred embodiment of the system illustrated in FIG. 78 adapted with the rechargeable device operates as the series combine power system with controllable engine speed.

FIG. 80 is a schematic view showing that the preferred embodiment of the system illustrated in FIG. 78 adapted with the adaptation of the rechargeable device operates as the series combined power system at a constant engine speed.

FIG. 81 is a schematic view showing that the preferred embodiment of the system illustrated in FIG. 78 not adapted with the adaptation of the rechargeable device operates as the series combined power system with controllable engine speed.

FIG. 82 is a schematic view showing that the preferred embodiment of the system illustrated in FIG. 78 not adapted with the adaptation of the rechargeable device operates as the series combined power system at a constant engine speed.

FIG. 83 is a schematic view showing that the preferred embodiment of the system illustrated in FIG. 78 operates on the engine power to drive the load.

FIG. 84 is a schematic view showing that the preferred embodiment of the system illustrated in FIG. 78 operates on the power form the engine to jointly drive the load with both of the primary and the secondary dynamo-electric units driven by the rechargeable device.

FIG. 85 is a schematic view showing that the preferred embodiment of the system illustrated in FIG. 78 operates on the power form the engine to jointly drive the load with the primary dynamo-electric unit driven by the rechargeable device.

FIG. 86 is a schematic view showing that the preferred embodiment of the system illustrated in FIG. 78 operates on the power form the engine to jointly drive the load with the secondary dynamo-electric unit driven by the rechargeable device.

FIG. 87 is a schematic view showing that the preferred embodiment of the system illustrated in FIG. 78 operates on the power from the engine to drive the load, and to drive the primary dynamo-electric unit to function as a generator to charge the rechargeable device or to supply power to another load.

FIG. 88 is a schematic view showing that the preferred embodiment of the system illustrated in FIG. 78 operates on the power from the engine to drive the load, and to drive the secondary dynamo-electric unit to function as a generator to charge the rechargeable device or to supply power to another load.

FIG. 89 is a schematic view showing that the preferred embodiment of the system illustrated in FIG. 78 operates on the power from the engine to drive the load, and to drive both of the primary and the secondary dynamo-electric units to function as a generator to charge the rechargeable device or to supply power to another load.

FIG. 90 is a schematic view showing that the preferred embodiment of the system illustrated in FIG. 78 operates on the power from the rechargeable device to drive the secondary dynamo-electric unit for driving the load.

FIG. 91 is a schematic view showing that the preferred embodiment of the system illustrated in FIG. 78 operates on the power from the rechargeable device to drive the primary dynamo-electric unit for driving the load.

FIG. 92 is a schematic view showing that the preferred embodiment of the system illustrated in FIG. 78 has the load to draw the secondary dynamo-electric unit to regenerate by reclaiming the kinetics for charging the rechargeable device or supplying power to another load.

FIG. 93 is a schematic view showing that the preferred embodiment of the system illustrated in FIG. 78 operates on the mechanical damper of the engine to exercise a brake on the load.

FIG. 94 is a schematic view showing that the preferred embodiment of the system operates on the mechanical damper of the engine to exercise a brake on the load and to drive the primary dynamo-electric unit to regenerate for charging the rechargeable device or supplying power to another load.

FIG. 95 is a schematic view showing that the preferred embodiment of the system operates on the mechanical damper of the engine to exercise a brake on the load and to drive the secondary dynamo-electric unit to regenerate for charging the rechargeable device or supplying power to another load.

FIG. 96 is a schematic view showing that the preferred embodiment of the system operates on the mechanical damper of the engine to exercise a brake on the load and to drive both of the primary and the secondary dynamo-electric units to regenerate for charging the rechargeable device or supplying power to another load.

FIG. 97 is a schematic view showing that the preferred embodiment of the system illustrated in FIG. 78 operates on the power form the rechargeable device to drive the primary dynamo-electric unit to start the engine.

FIG. 98 is a schematic view showing that the preferred embodiment of the system illustrated in FIG. 78 operates on the power form the rechargeable device to drive the secondary dynamo-electric unit to start the engine.

FIG. 99 is a schematic view showing that the preferred embodiment of the system illustrated in FIG. 78 operates on the power form the rechargeable device to drive both of the primary and the secondary dynamo-electric units to start the engine.

FIG. 100 is a schematic view showing that the preferred embodiment of the system illustrated in FIG. 2 has the primary dynamo-electric unit to be independently and directly driven by the active rotation power source or through a transmission device.

FIG. 101 is a schematic view showing that the preferred embodiment of the system illustrated in FIG. 100 adapted with the rechargeable device functions as the series combined power system with controllable engine speed.

FIG. 102 is a schematic view showing that the preferred embodiment of the system illustrated in FIG. 100 adapted with the rechargeable device functions as the series combined power system at a constant engine speed.

FIG. 103 is a schematic view showing that the preferred embodiment of the system illustrated in FIG. 100 not adapted with the rechargeable device functions as the series combined power system with controllable engine speed.

FIG. 104 is a schematic view showing that the preferred embodiment of the system illustrated in FIG. 100 not adapted with the rechargeable device functions as the series combined power system at a constant engine speed.

FIG. 105 is a schematic view showing that the preferred embodiment of the system illustrated in FIG. 100 operates on the power form the engine to drive the load.

FIG. 106 is a schematic view showing that the preferred embodiment of the system illustrated in FIG. 100 operates on the power from the engine to jointly drive the load with both of the primary and the secondary dynamo-electric units driven by the rechargeable device.

FIG. 107 is a schematic view showing that the preferred embodiment of the system illustrated in FIG. 100 operates on the power from the engine to jointly drive the load with the primary dynamo-electric unit driven by the rechargeable device.

FIG. 108 is a schematic view showing that the preferred embodiment of the system illustrated in FIG. 100 operates on the power from the engine to jointly drive the load with the secondary dynamo-electric unit driven by the rechargeable device.

FIG. 109 is a schematic view showing that the preferred embodiment of the system illustrated in FIG. 100 operates on the power of the engine to drive the load, and to drive the primary dynamo-electric unit to function as a generator to charge the rechargeable device or to supply power to another load.

FIG. 110 is a schematic view showing that the preferred embodiment of the system illustrated in FIG. 100 operates on the power of the engine to drive the load, and to drive the secondary dynamo-electric unit to function as a generator to charge the rechargeable device or to supply power to another load.

FIG. 111 is a schematic view showing that the preferred embodiment of the system illustrated in FIG. 100 operates on the power of the engine to drive the load, and to drive both of the primary and the secondary dynamo-electric units to function as a generator to charge the rechargeable device or to supply power to another load.

FIG. 112 is a schematic view showing that the preferred embodiment of the system illustrated in FIG. 100 operates on the power from the rechargeable device to drive the secondary dynamo-electric unit for driving the load.

FIG. 113 is a schematic view showing that the preferred embodiment of the system illustrated in FIG. 100 operates with the engine running at a constant speed to drive the primary dynamo-electric unit to function as a generator to charge the rechargeable device or to supply power to another load.

FIG. 114 is a schematic view showing that the preferred embodiment of the system illustrated in FIG. 100 operates with the engine running at a constant speed to drive the secondary dynamo-electric unit to function as a generator to charge the rechargeable device or to supply power to another load.

FIG. 115 is a schematic view showing that the preferred embodiment of the system illustrated in FIG. 100 operates with the engine running at a constant speed to drive both of the primary and the secondary dynamo-electric units to function as a generator to charge the rechargeable device or to supply power to another load.

FIG. 116 is a schematic view showing that the preferred embodiment of the system illustrated in FIG. 100 has the load to draw the secondary dynamo-electric unit to regenerate by reclaiming the kinetics for charging the rechargeable device or supplying power to another load.

FIG. 117 is a schematic view showing that the preferred embodiment of the system illustrated in FIG. 100 has the mechanical damper of the engine to exercise the brake on the load.

FIG. 118 is a schematic view showing that the preferred embodiment of the system illustrated in FIG. 100 has the mechanical damper of the engine to exercise a brake on the load and to drive the primary dynamo-electric unit to regenerate for charging the rechargeable device or supplying power to another load.

FIG. 119 is a schematic view showing that the preferred embodiment of the system illustrated in FIG. 100 has the mechanical damper of the engine to exercise a brake on the load and to drive the secondary dynamo-electric unit to regenerate for charging the rechargeable device or supplying power to another load.

FIG. 120 is a schematic view showing that the preferred embodiment of the system illustrated in FIG. 100 has the mechanical damper of the engine to exercise a brake on the load and to drive both of the primary and the secondary dynamo-electric units to regenerate for charging the rechargeable device or supplying power to another load.

FIG. 121 is a schematic view showing that the preferred embodiment of the system illustrated in FIG. 100 operates on the power from the rechargeable device to drive the primary dynamo-electric unit to start the engine.

FIG. 122 is a schematic view showing that the preferred embodiment of the system illustrated in FIG. 100 operates on the power from the rechargeable device to drive the secondary dynamo-electric unit to start the engine.

FIG. 123 is a schematic view showing that the preferred embodiment of the system illustrated in FIG. 100 operates on the power from the rechargeable device to drive both of the primary and the secondary dynamo-electric units to start the engine.

FIG. 124 is a block chart showing that the preferred embodiment of the system illustrated in FIG. 1 has different layouts of spatial configuration among the constituent units without changing the mechanism of the system.

FIG. 125 is a schematic view showing that the preferred embodiment of the system illustrated in FIG. 1 engages in the distribution of power by a variable transmission unit driven by the active power source to drive in sequent two or more than two primary dynamo-electric units, clutches, and the secondary dynamo-electric units for driving the load.

FIG. 126 is a schematic view showing that the preferred embodiment of the system illustrated in FIG. 1 engages in the distribution of power by the variable transmission unit driven by an output end from the primary dynamo-electric unit to drive in sequent two or more than two clutches, and the secondary dynamo-electric units for respectively driving the load.

FIG. 127 is a schematic view showing that the preferred embodiment of the system illustrated in FIG. 1 has the clutch driven by the primary dynamo-electric unit to drive the variable transmission unit for power distribution so to drive two or more than two secondary dynamo-electric units.

FIG. 128 is a schematic view showing that the preferred embodiment of the system illustrated in FIG. 1 has the variable unit at the output end of the system driven by the secondary dynamo-electric unit to engage in power distribution for driving two or more than two units of load.

FIG. 129 is a schematic view showing that the preferred embodiment of the system illustrated in FIG. 1 has the individual output end of the variable transmission unit further driven by the clutch driven by the primary dynamo-electric unit to be respectively coupled to the rotation part of the secondary dynamo-electric unit and to the load end.

FIG. 130 is a schematic view showing that the preferred embodiment of the system illustrated in FIG. 1 has the output from the active rotation power source to be respectively coupled to the primary dynamo-electric unit through the variable transmission unit driven by the active rotation power source, and coupled to the secondary dynamo-electric unit through the clutch.

FIG. 131 is a schematic view showing that the preferred embodiment of the system illustrated in FIG. 1 has the output from the active rotation power source respectively coupled through the variable transmission unit driven by the active rotation power source to the primary dynamo-electric unit, and through the clutch to the individual output end of the variable transmission unit driven by the clutch for respectively driving two or more than two units of the secondary dynamo-electric units and loads.

FIG. 132 is a schematic view of another preferred embodiment yet of the system of the present invention that both the primary and the secondary dynamo-electric units share the same structure.

FIG. 133 is another schematic view showing that another preferred embodiment yet of the system of the present invention that both the primary and the secondary dynamo-electric units share the same structure.

### DETAILED DESCRIPTION OF THE PREFERRED EMBODIMENTS

The present invention of a series and parallel combined dual power system operates as a series combined power system, or as a parallel combined power system. Wherein, when an internal combustion engine is used as an active rotation power source, the rotation kinetics outputted form the engine is used to directly drive a load in case of a normal load; the system is switched to operate as the series combined power system as required with the power from the engine to drive a primary dynamo-electric unit for functioning as a generator to drive a secondary dynamo-electric unit for functioning as a motor to output rotation kinetics to drive the load in case of a light load.

The series and parallel dual power system may be adapted with an operation rechargeable device. If the rechargeable device is adapted and in case of a heavy load, the power from the rechargeable device drives either or both of the primary and the secondary dynamo-electric units to function as a motor, and to jointly drive the load with the power from the engine for operating as a parallel combined power system. In case of a normal load, the rotation kinetics outputted from the engine directly drives the load. In case of a light load, while the rotation kinetics outputted form the engine directly drives the load, either or both of the primary and the secondary dynamo-electric units functions as a generator to charge the rechargeable device or to supply power to another load. If the system is converted to operate in the mode of the series combined power system, the power from the engine drives the primary dynamo-electric unit to function as a generator to further drive the secondary dynamo-electric unit for functioning as a motor, and may charge the rechargeable device or supply power to another load at random for regulating the engine to operate at a constant speed with higher energy efficiency, the constant speed operation is defined as the range of operation speed wherein the engine is running at lower fuel consumption but paid the operation region with comparatively higher fuel saving of comparatively higher output power so to reach the optimal brake specific fuel consumption. Furthermore, as required, the power from the rechargeable device is used to drive either or both of the primary and the secondary dynamo-electric units to function as a motor to further output rotation kinetics to drive the load in correcting the defectives of the lower efficiency and higher pollution found with the engine when operating at low power output and low speed.

The system by providing all or any part of those functions described above corrects the defectives of the lower efficiency and higher pollution found with the engine when operating at low power output and low speed.

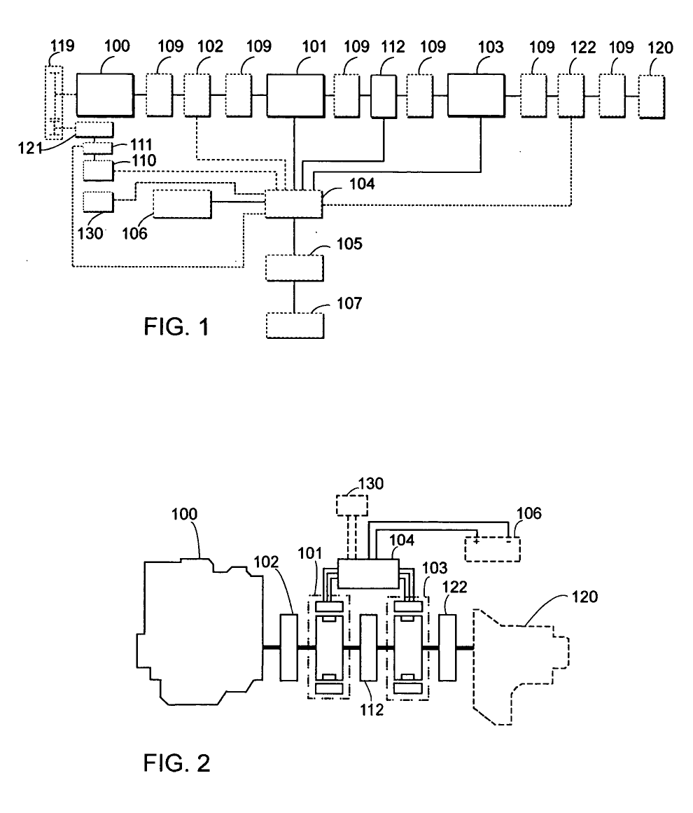

FIG. 1 is a system block chart of a series and parallel combined dual power system of the present invention. Wherein, the active rotation power source and both of the primary and the secondary dynamo-electric units, an operation clutch and an optional variable transmission unit constituting a systematic incorporation is essentially comprised of:
An active rotation power source: comprised of one or multiple internal combustion engines, external combustion engine or other rotation kinetics power sources of the prior art, an rotary part of the active power source 100 is directly or through either or both of an optional clutch 102 and an optional variable transmission unit 109, coupled to a primary dynamo-electric unit 101;
The primary dynamo-electric unit 101: comprised of one or multiple AC, DC, brushless, brush, synchronous or asynchronous rotation dynamo-electric device providing functions as a generator, or switched functions between those of a generator and a motor; a rotary part of the primary dynamo-electric unit 101 is coupled to a secondary dynamo-electric unit 103 through a clutch 112, or as required through the clutch 112 and the variable transmission unit 109;
Clutches 102, 112, 122: related to a single way clutch or a clutch controlled by manual, mechanical force, eccentric force, air pressure, hydraulic flow, or electromagnetic force used to transmit or interrupt the transmission of the mechanical rotation kinetics; one or multiple clutches 112 is required while one or multiple clutches 102 and clutches 122 may be provided or not; or idling shaft function provided at random by a clutch disposed to the input end of the load or by a variable transmission device is used to replace that of the clutch 122;
The secondary dynamo-electric unit 103: comprised of one or multiple AC, DC, brushless, brush, synchronous or asynchronous rotation dynamo-electric device providing functions as a generator, or switched functions between those of a generator and a motor; a rotary part of the secondary dynamo-electric unit 103 is coupled to a secondary dynamo-electric unit 103 through a clutch 112, or as required through the clutch 112 and the variable transmission unit 109;
A drive control unit 104: an optional item, comprised of electro-mechanical or solid-status circuit to control the power generated by the primary dynamo-electric unit 101 functioning as a generator when the system operates as the series combined power system so to drive the secondary dynamo-electric unit 103 and charge a rechargeable device 106, or control either of the generation output functions, or control the power from the rechargeable device 106 to drive either or both of the primary and the secondary dynamo-electric units 101, 103 functioning as a motor, the drive control unit 104 controls voltage, amperage, polarity (in case of a DC), torque and phase (in case of an AC) to manipulate revolving direction, speed, torque and abnormality protection of the dynamo-electric unit; or when either or both of the primary and the secondary dynamo-electric units are inversely driven by the load to function as a generator, the driven control unit 104 controls the charging power transmitted to the rechargeable device 106 or to another load thus to manipulate the dynamo-electric unit to function as a brake by regeneration;
A central control unit: an optional item, comprised of a solid-status, or an electro-mechanical device, or chip and related working software, subject to the control by a control interface 107 to further control functions provided by the series and parallel dual power system, particularly in achieving the optimal fuel consumption and pollution control; controls the relative functions provided among the first dynamo-electric unit 101, the secondary dynamo-electric unit 103 and the rechargeable device 106 by manipulating the drive control unit 104; and controls the monitor and interaction of the feedback among all units in the system;
The rechargeable device 106: an optional item, related to a rechargeable battery, super capacitor, or any other rechargeable device;
The control interface 107: an optional item, related to a solid-state, or electro-mechanical device, or chip and related software, subject to the manual input or input of control signal to control the operation of the series and parallel combined dual power system;
The variable transmission unit 109: comprised of a variable transmission device of fixed speed ration, or automatic, semi-automatic, or manual variable transmission device, or a differential gear set, epicyclical gear set, or other variable transmission device; is provided at where between the active rotation power source 100 and the clutch 102, or between the clutch 102 and the rotary part of the primary dynamo-electric unit 101, or between the rotary part primary dynamo-electric unit 101 and that of the clutch 112, or between the rotary part of the clutch 112 and that of the secondary dynamo-electric unit 103, or between the rotary part of the secondary dynamo-electric unit 103 and that of the clutch 122, or between the rotary part of the clutch 122 and that of the load; and
A redundant rechargeable device 110: comprised of a rechargeable battery, super capacitor, a flywheel for energy storage, or other rechargeable battery device with the power controlled by a start switch 111 to drive a start motor 121 of the engine set of the active rotation power source 100, thus to directly or through a transmission device start the engine set, or supply power to the peripheral equipment or another power driven load 130; all the redundant rechargeable device 110, the start switch 111 and the start motor 121 are optional items.

The rotation kinetics outputted from the system may be provided to drive a load of an air, land, or surface craft and other industrial equipment that is required to receive the input of the rotation mechanical kinetics.

With the engine as the active rotation power source, the series and parallel combined dual power system provides all or part of the following functions:
When the system operates as the series combined power system, the engine is controlled to run from low speed to high speed or run at a constant speed for driving the primary dynamo-electric unit to function as a generator; if the rechargeable device 106 is not adapted, the power generated drives the secondary dynamo-electric unit 103 to function as a motor to output rotation kinetics for driving the load 120; if the system is adapted with the rechargeable device 106 and in case of a light load, the power generated from the primary dynamo-electric unit drives the secondary dynamo-electric unit 103 while charging the rechargeable device 106; or in case of a heavy load, the power generated form the primary dynamo-electric unit 101 and that from the rechargeable device 106 jointly drive the secondary dynamo-electric unit 103 to output rotation kinetics for driving the load 120 and regulate the engine to operate at a constant speed yielding higher energy efficiency; the constant speed operation is defined as the range of operation speed wherein the engine is running at lower fuel consumption but paid the operation region with comparatively higher fuel saving of comparatively higher output power so to reach the optimal brake specific fuel consumption; or when an optional rechargeable device is added to the system, the power generated by the primary dynamo-electric unit as driven by the engine charges the rechargeable device, or the power from the rechargeable device and that from the primary dynamo-electric unit jointly drive the secondary dynamo-electric unit to function as a motor to output to regulate the engine operating in a constant speed of comparatively higher energy efficiency; again, the constant speed operation is defined as the range of operation speed wherein the engine is running at lower fuel consumption but paid the operation region with comparatively higher fuel saving of comparatively higher output power so to reach the brake specific fuel consumption;
The load 102 is driven by the rotation kinetics from the engine power;
When adapted with the optional rechargeable device 106, the system provides the operation of the parallel combined power system for the power from the rechargeable device 106 to drive either or both of the primary and the secondary dynamo-electric units 101, 103 to function as a motor to jointly drive the load 120 with the power from the engine, or in case of a light load, while driving the load 120, the power form the engine is used to drive either or both of the primary and the secondary dynamo-electric units 101, 103 to charge the rechargeable device 106 or supply power to another load 130; in case of a heavy load, the power from the rechargeable device 106 drives either or both of the primary and the secondary dynamo-electric units 101, 103 for jointly driving the load with the power from the engine;
The power from the rechargeable device 106 drives either or both of the primary and the secondary dynamo-electric units 101, 103 to function as a motor for driving the load 120;
The power from the engine drives either or both of the primary and the secondary dynamo-electric units 101, 103 to function as a generator to charge the rechargeable device 106 or to supply power to another load 130;
The load 102 is used to inversely drive either or both of the primary and the secondary dynamo-electric units 101, 103 to function as a generator to charge the rechargeable device 106 or supply power to another load 130;
Mechanical damper of the engine functions as the brake, or if the rechargeable device 106 is adapted, either or both of the primary and the secondary dynamo-electric units 101, 103 operates at the same time as a generator to charge the rechargeable device 106 or to supply power to another load 130 for creating the braking function by regeneration;
The rechargeable device 106 drives either or both of the primary and the secondary dynamo-electric units 101, 103 to function as a motor to start the engine; and
The system provides all or any part of those functions described above.

For a summary description, the variable transmission unit 109, the redundant rechargeable device 110, the start switch 111, the start motor 121, the central control unit 105, and the control interface 107 are omitted from the system illustrated in FIG. 1 while the engine functions as the active rotation power source 100 and the primary dynamo-electric unit 101, the secondary dynamo-electric unit 103, the clutches 102, 112, 122, the drive control unit 104, and the optional rechargeable device 106 and the power driven load 130 are reserved to drive the load 120.

As illustrated in FIG. 2 for another system block chart comprised of the primary power unit taken from the preferred embodiment as illustrated in FIG. 1; wherein, the functions of the system provided by the interaction among all key power units include:
System functions 1, 2: related to that the rechargeable device 106 is adapted for the system to function as the series combined power system for driving the load;
System functions 3, 4: related to that the rechargeable device 106 is not adapted to the system, and the system functions as the series combined power system for driving the load;
System function 5: related to that the power from the engine as the active power source 100 drives the load 120;
System functions 6, 7, and 8: related to that the power from the engine as the active power source 100 and the power from the rechargeable device 106 jointly drive either or both of the primary and the secondary dynamo-electric units 101, 103 to function as a generator so to jointly drive the load 120;
System functions 9, 10, and 11: related to that the power from the engine as the active power source 100 drives the load 120 and drives at the same time either or both of the primary and secondary dynamo-electric units 101, 103 to function as a generator so to charge the rechargeable device 106 or supply power to another power driven load 130 (including any external load not specified);
System functions 12, 13, and 14: related to that the power from the rechargeable device 106 drives either or both of the primary and the secondary dynamo-electric units 101, 103 to function as a motor for driving the load 120;
System functions 15, 16, and 17: related to that the power from the engine as the active power source 100 drives either or both of the primary and the secondary dynamo-electric units 101, 103 to function as a generator so to charge the rechargeable device 106 or supply power to another power driven load 130 (including any external load not specified);
System functions 18, 19, and 20: related to that the load 120 inversely draws either or both of the primary and the secondary dynamo-electric units 101, 103 to function as a generator so to charge the rechargeable device 106 or supply power to another power driven load 130 (including any external load not specified) for achieving the purpose of regenerating by reclaiming the kinetics to exercise the brake;
System function 21: related to that the mechanical damper of the engine as the active power source 100 exercises the brake on the load 120;
System functions 22, 23, and 24: related to that the mechanical damper of the engine as the active power source 100 exercises the brake on the load 120, and either or both of the primary and the secondary dynamo-electric units 101,103 simultaneously functions as the regeneration to charge the rechargeable device 106 or another load 130 driven by power, and further to exercise the brake on the load 120;
System functions 25, 26, and 27: related to that the power from the rechargeable device 106 drives either or both of the primary and the secondary dynamo-electric units 101, 103 to function as a motor for starting the engine.

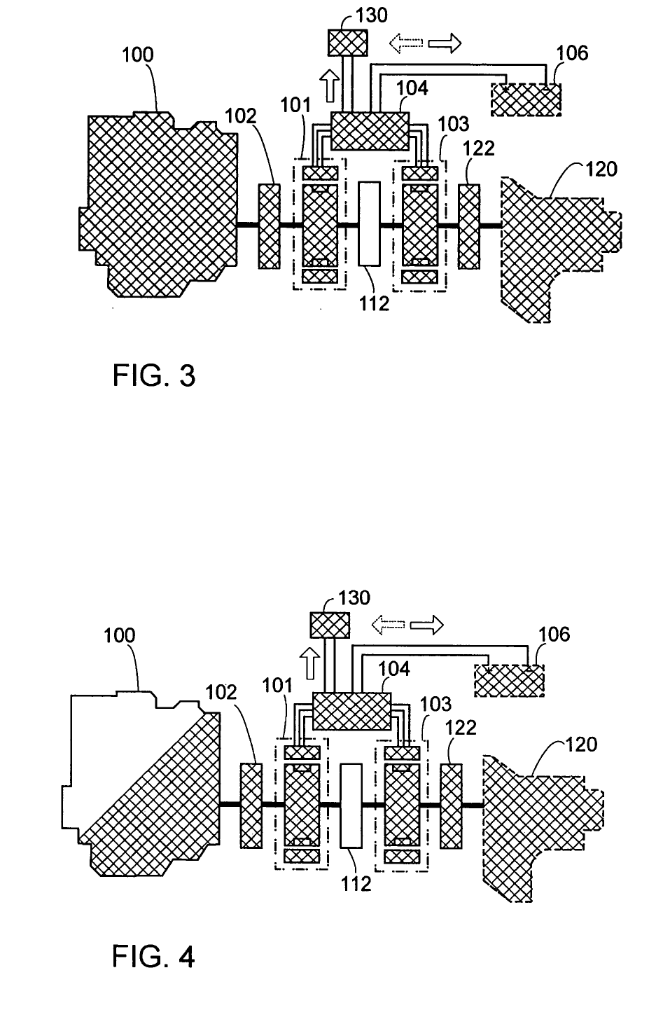

FIG. 3 through FIG. 29 show those common functions of the system listed in Table A: Provided, however, that the functions of the system are not limited to those common functions. FIG. 3 through FIG. 29 are schematic views showing those system functions listed in Table A. Wherein,

FIG. 3 shows that a rechargeable device is adapted to the system of the preferred embodiment illustrated in FIG. 2 to engage in the operation as the series combined power system with controllable engine speed. FIG. 3 shows the system function 1 of the preferred embodiment illustrated in FIG. 2, wherein, the system is adapted with the rechargeable device to provide the series combined power operation to drive the load.

FIG. 4 shows that the preferred embodiment of the system illustrated in FIG. 2 is adapted with the rechargeable device is operating as the series combined power system with the engine running at a constant speed. FIG. 4 shows system function 2 provided by the preferred embodiment illustrated in FIG. 2, wherein, the system is adapted with the rechargeable device while the engine is running at a constant speed to drive the system to provide series combined power operation for driving the load.

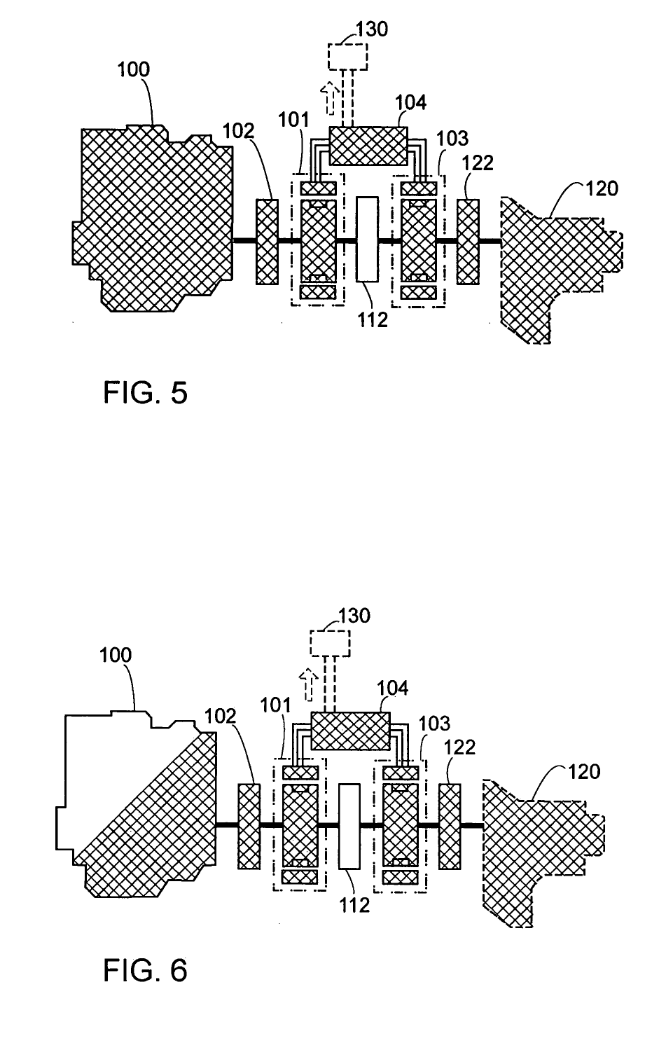

FIG. 5 is shows that the preferred embodiment of the system illustrated in FIG. 2 is not adapted with the rechargeable device and is providing the operation as the series combined power system with controllable engine speed. FIG. 5 shows system function 3 provided by the preferred embodiment illustrated in FIG. 2, wherein, the system without the adaptation of the rechargeable device provides the series combine power operation to drive the load.

FIG. 6 shows that the preferred embodiment of the system illustrated in FIG. 2 is not adapted with the rechargeable device and is operating as the series combined power system with the engine running at a constant speed. FIG. 6 shows system function 4 of the preferred embodiment illustrated in FIG. 6, wherein, the system without the adaptation of the rechargeable device has the engine running at a constant speed to drive the system to provide the series combine power operation to drive the load.

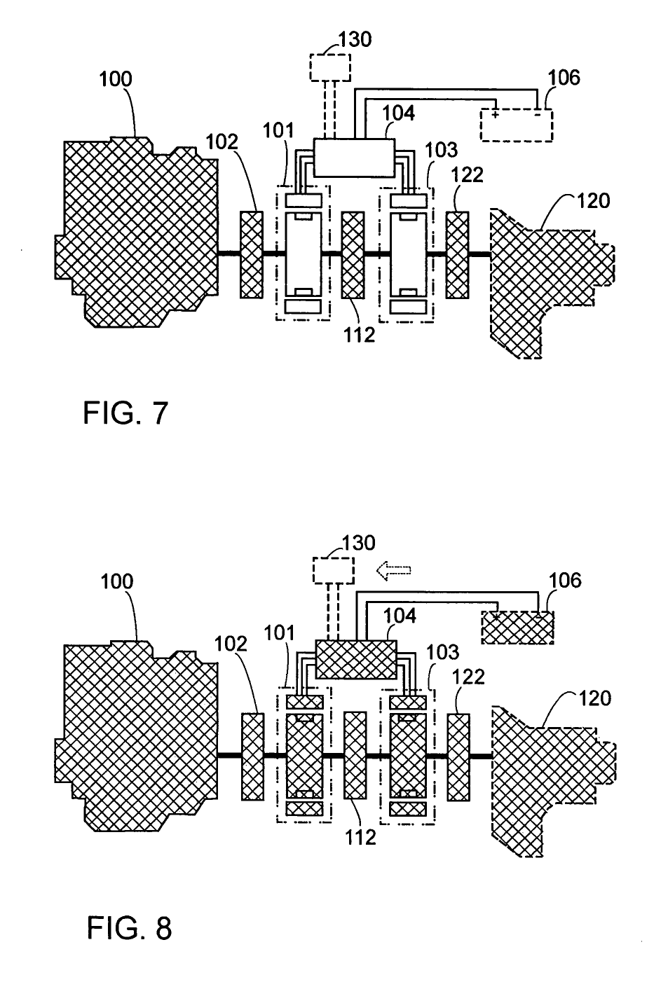

FIG. 7 shows that the preferred embodiment of the system illustrated in FIG. 2 operates to drive a load by the power from the engine. FIG. 7 shows system function 5 provided by the preferred embodiment illustrated in FIG. 2, wherein, the system drives the load by the power from the engine.

FIG. 8 shows that the preferred embodiment of the system illustrated in FIG. 2 jointly drives the load using the engine power and both of the primary and the secondary dynamo-electric units driven by the rechargeable device. FIG. 8 shows system function 6 provided by the preferred embodiment illustrated in FIG. 2, wherein, the system has the power from the engine and both of the primary and the secondary dynamo-electric units functioning as a motor in case of a heavy load to jointly drive the load.

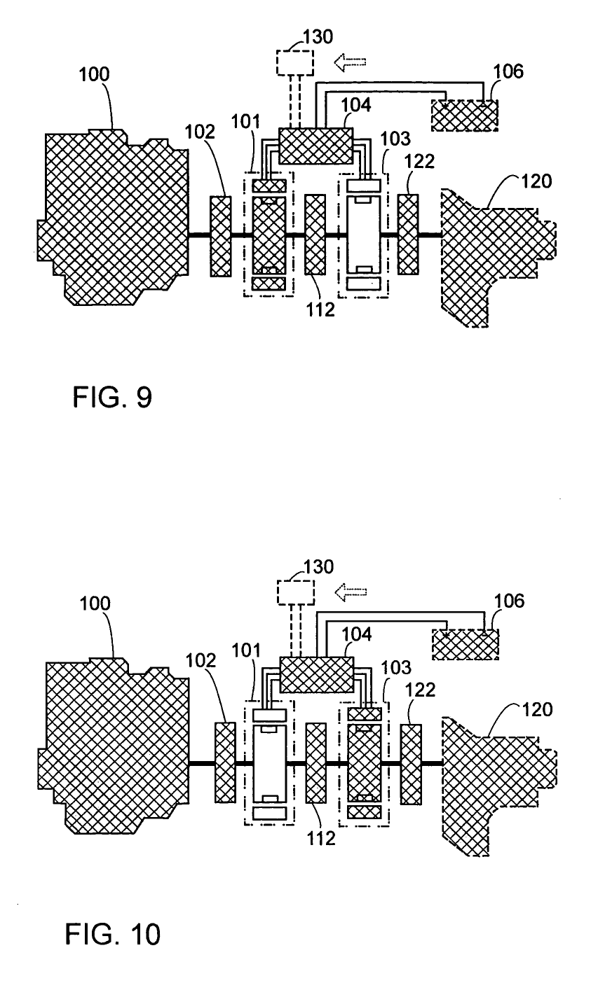

FIG. 9 shows that the preferred embodiment of the system illustrated in FIG. 2 drives the load using the engine power and the primary dynamo-electric units driven by the rechargeable device. FIG. 9 shows system function 7 provided by the preferred embodiment illustrated in FIG. 2, wherein, the system has the power from the engine and the primary dynamo-electric unit functioning as a motor driven by the rechargeable device in case of a heavy load to jointly drive the load.

FIG. 10 is shows that the preferred embodiment of the system illustrated in FIG. 2 drives the load using the engine power and the secondary dynamo-electric units driven by the rechargeable device. FIG. 10 shows system function 8 provided by the preferred embodiment illustrated in FIG. 2, wherein, the system has the power from the engine and the secondary dynamo-electric unit functioning as a motor driven by the rechargeable device in case of a heavy load to jointly drive the load.

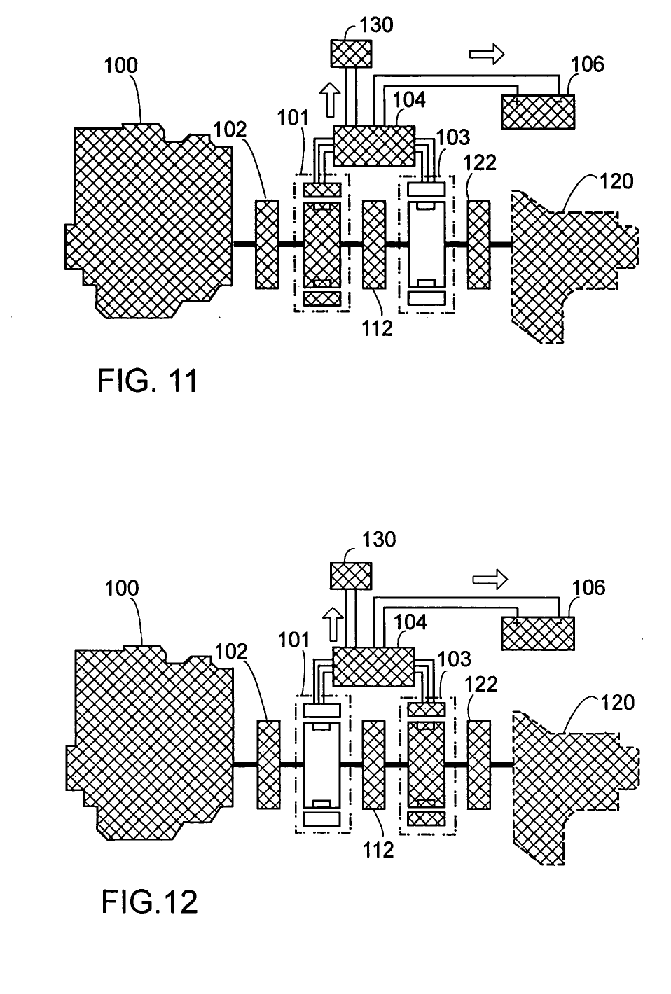

FIG. 11 shows that the preferred embodiment of the system illustrated in FIG. 2 operates to drive the load by the power of engine, and the primary dynamo-electric unit is driven to function as a generator to charge the rechargeable device or to supply power to another load. FIG. 11 shows system function 9, wherein, the power from the engine drives the load, and the primary dynamo-electric unit to function as a generator for charging the rechargeable device or supplying power to another load.

FIG. 12 shows that the preferred embodiment of the system illustrated in FIG. 2 operates to drive the load by the power of engine, and the secondary dynamo-electric unit is driven to function as a generator to charge the rechargeable device or to supply power to another load. FIG. 12 shows system function 10 provided by the preferred embodiment illustrated in FIG. 2, wherein, the power from the engine drives the load, and the secondary dynamo-electric unit to function as a generator to charge the rechargeable device or to supply power to another load.

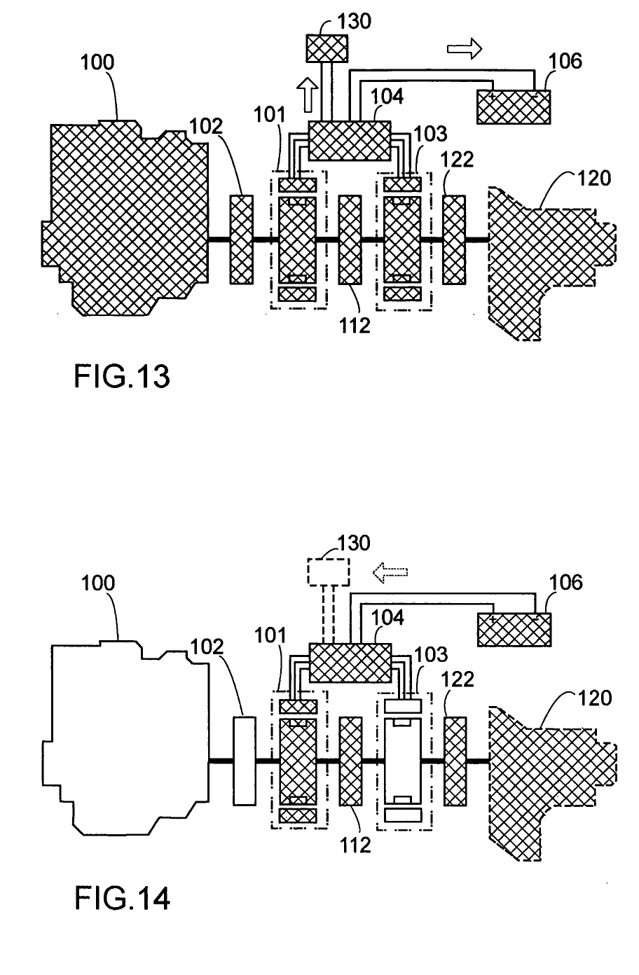

FIG. 13 shows that the preferred embodiment of the system illustrated in FIG. 2 operates to drive the load by the power of engine, and both of the primary and the secondary dynamo-electric units function as a generator to charge the rechargeable device or to supply power to another load. FIG. 13 shows system function 11 provided by the preferred embodiment illustrated in FIG. 2, wherein, the power from the engine drives the load and both of the primary and the secondary dynamo-electric units to function as a generator for charging the rechargeable device or supplying power to another load.

FIG. 14 shows that the preferred embodiment of the system illustrated in FIG. 2 operates to drive the primary dynamo-electric unit by the power from the rechargeable unit for driving the load. FIG. 14 shows system function 12 provided by the preferred embodiment illustrated in FIG. 2, wherein, the power form the rechargeable device drives the primary dynamo-electric unit to function as a motor for driving the load.

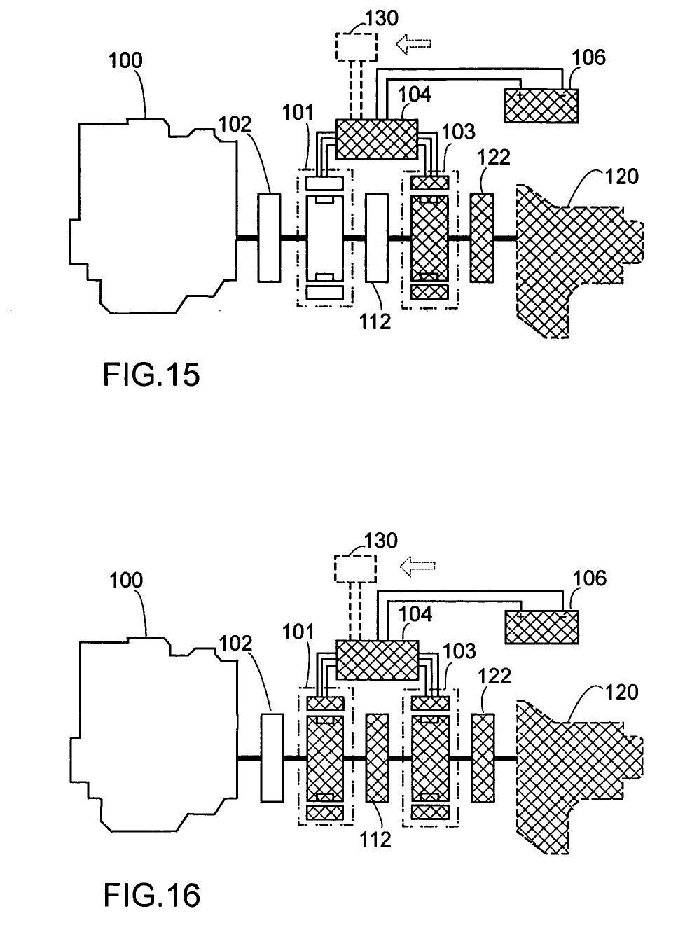

FIG. 15 shows that the preferred embodiment of the system illustrated in FIG. 2 operates to drive the secondary dynamo-electric unit by the power from the rechargeable unit for driving the load. FIG. 15 shows system function 13 provided by the preferred embodiment illustrated in FIG. 2, wherein, the power from the rechargeable device drives the secondary dynamo-electric unit to function as a motor for driving the load.

FIG. 16 shows that the preferred embodiment of the system illustrated in FIG. 2 operates to drive both of the primary and the secondary dynamo-electric units by the power from the rechargeable unit for driving the load. FIG. 16 shows system function 14 provided by the preferred embodiment illustrated in FIG. 2, wherein, the power form the rechargeable device drives both of the primary and the secondary dynamo-electric units to function as a motor for driving the load.

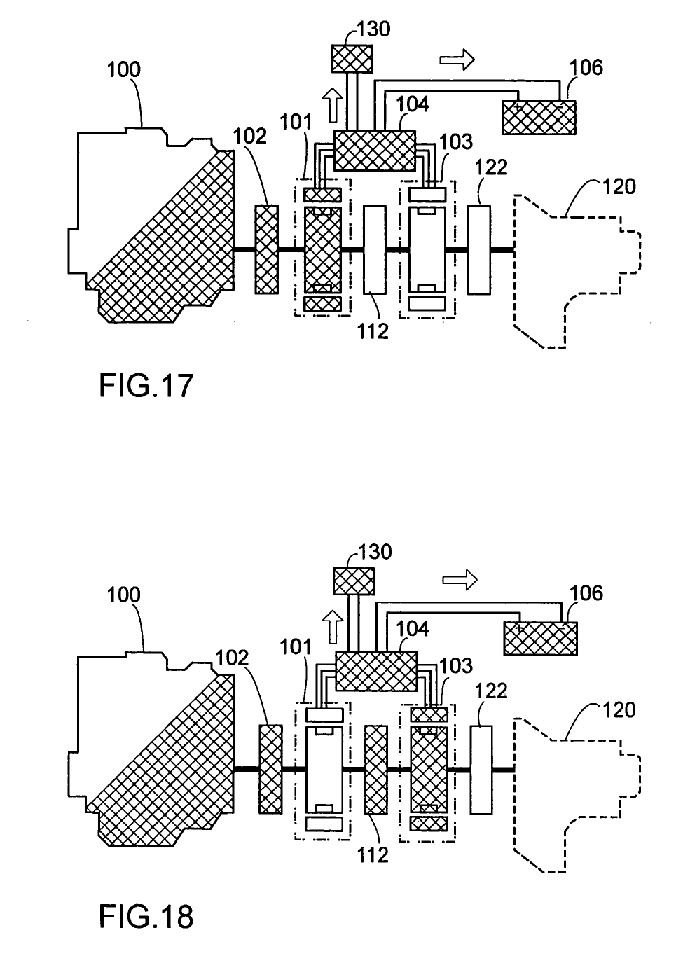

FIG. 17 shows that the preferred embodiment of the system illustrated in FIG. 2 operates on the power from the engine running at a constant speed to drive the primary dynamo-electric unit to function as a generator to charge the rechargeable device and to supply power to another load. FIG. 17 shows system function 15 provided by the preferred embodiment illustrated in FIG. 2, wherein, the engine runs at a constant speed to drive the primary dynamo-electric unit to function as a generator for charging the rechargeable device or supplying power to another load.

FIG. 18 shows that the preferred embodiment of the system illustrated in FIG. 2 operates on the power from the engine running at a constant speed to drive the secondary dynamo-electric unit to function as a generator to charge the rechargeable device and to supply power to another load. FIG. 18 shows system function 16 provided by the preferred embodiment illustrated in FIG. 2, wherein, the engine runs at a constant speed to drive the secondary dynamo-electric unit to function as a generator for charging the rechargeable device or supplying power to another load

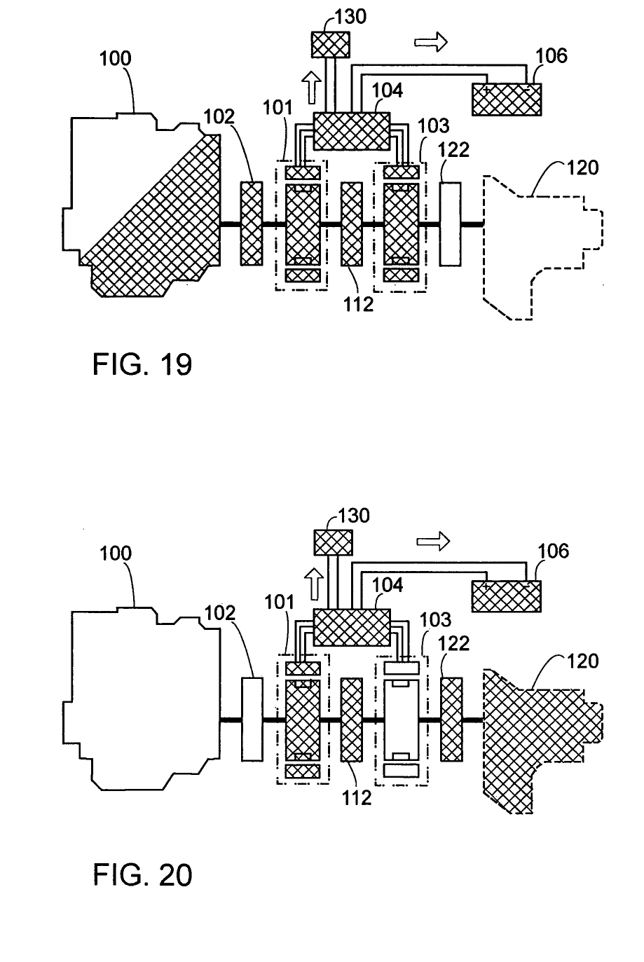

FIG. 19 shows that the preferred embodiment of the system illustrated in FIG. 2 operates on the power from the engine running at a constant speed to drive both of the primary and the secondary dynamo-electric units to function as a generator to charge the rechargeable device or to supply power to another load. FIG. 19 shows system function 17 provided by the preferred embodiment illustrated in FIG. 2, wherein, the engine runs at a constant speed to drive both of the primary and the secondary dynamo-electric units to function as a generator for charging the rechargeable device or supplying power to another load

FIG. 20 shows that the preferred embodiment of the system illustrated in FIG. 2 has the load the draw the primary dynamo-electric unit to regenerate by reclaiming the kinetics so to charge the rechargeable device or to supply power to another load. FIG. 20 shows system function 18 provided by the preferred embodiment illustrated in FIG. 2, wherein, the system has the load to operate as the brake to draw the primary dynamo-electric unit for functioning as a generator to charge the rechargeable device or to supply power to another load.

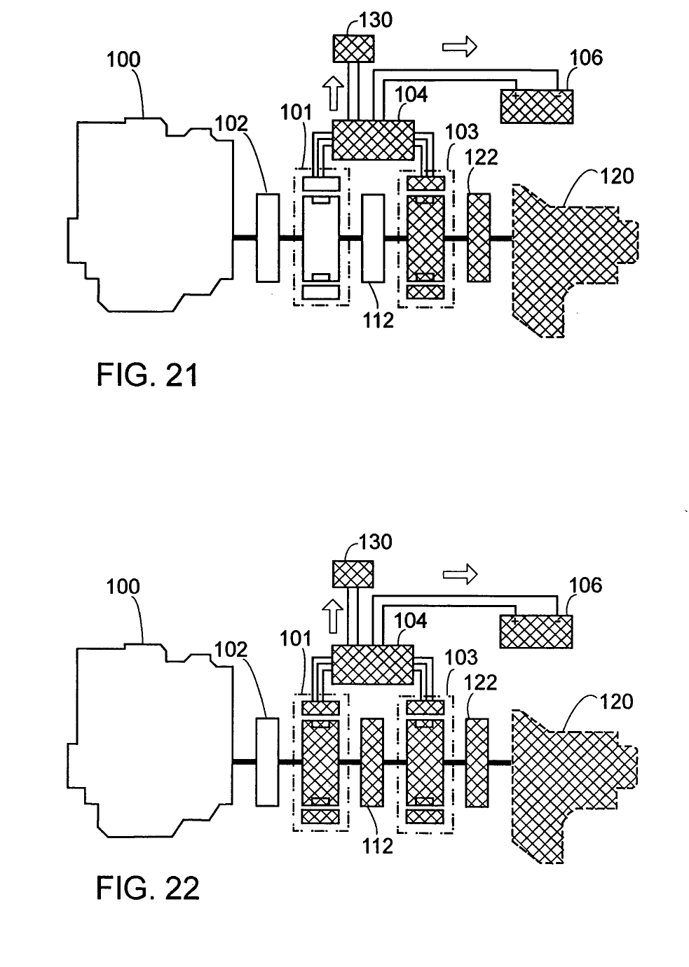

FIG. 21 shows that the preferred embodiment of the system illustrated in FIG. 2 has the load the draw the secondary dynamo-electric unit to regenerate by reclaiming the kinetics so to charge the rechargeable device or to supply power to another load. FIG. 21 shows system function 19 provided by the preferred embodiment illustrated in FIG. 2, wherein, the system has the load to exercise the operation of a brake so to draw the secondary dynamo-electric unit to function as a generator for charging the rechargeable device or supplying power to another load.

FIG. 22 shows that the preferred embodiment of the system illustrated in FIG. 2 has the load the draw both of the primary and the secondary dynamo-electric units to regenerate by reclaiming the kinetics so to charge the rechargeable device or to supply power to another load. FIG. 22 shows system function 20 provided by the preferred embodiment illustrated in FIG. 2, wherein, the system has the load to exercise the operation of a brake to draw both of the primary and the secondary dynamo-electric units to function as a generator for charging the rechargeable device or supplying power to another load.

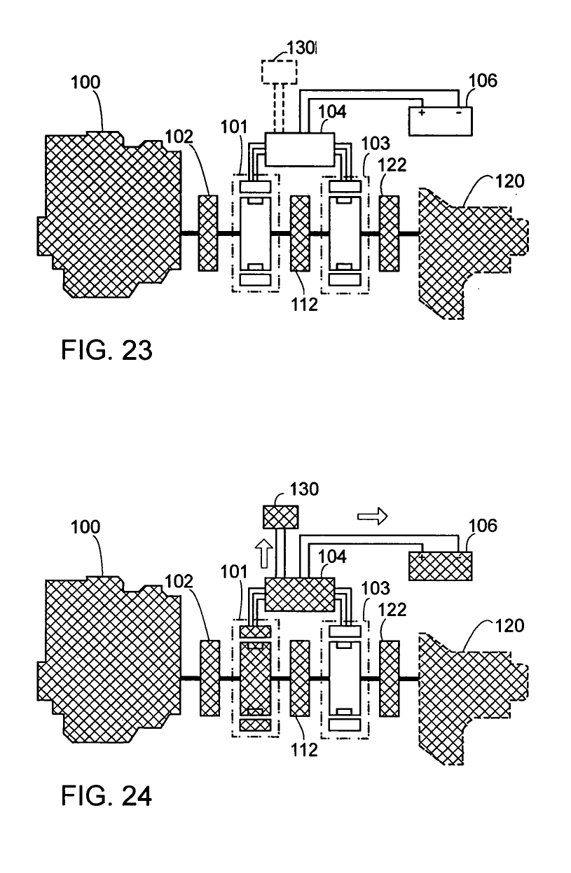

FIG. 23 shows that the preferred embodiment of the system illustrated in FIG. 2 exercises a braking on the load by means of a mechanical damper of the engine. FIG. 23 shows system function 21 provided by the preferred embodiment illustrated in FIG. 2, wherein, the engine has the damper to exercise the operation of brake on the load.

FIG. 24 shows that the preferred embodiment of the system illustrated in FIG. 2 exercises a braking on the load by means of the mechanical damper of the engine and drives the primary dynamo-electric unit to regenerate for charging the rechargeable device or supplying power to another load. FIG. 24 shows system function 22 provided by the preferred embodiment illustrated in FIG. 2, wherein, the engine is used as the damper to exercise brake on the load while the primary dynamo-electric functions as a generator to regenerate by reclaiming the kinetics for regenerating so to charge the rechargeable device or to supply power to another load.

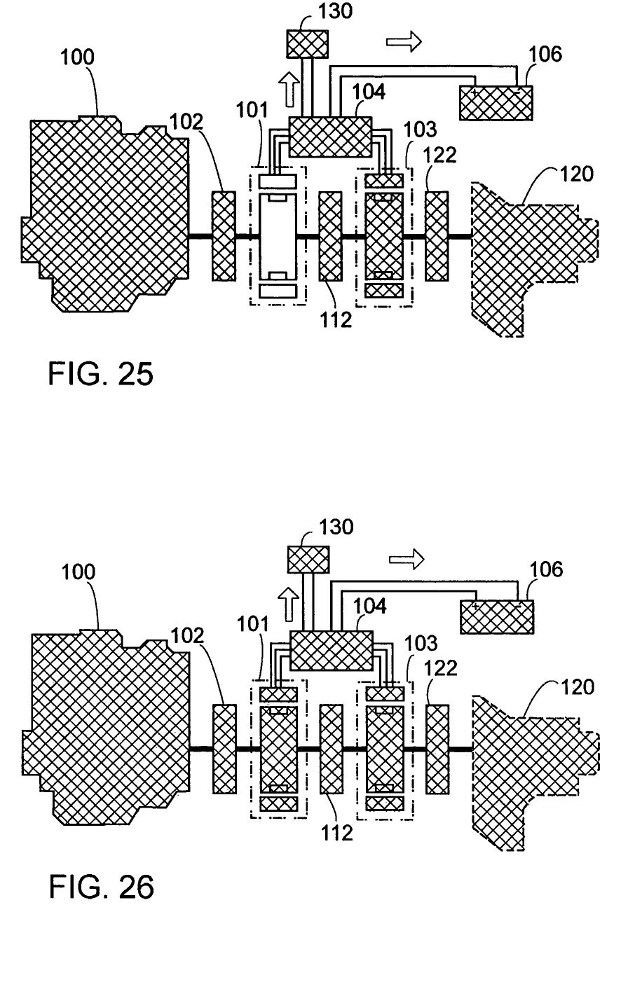

FIG. 25 shows that the preferred embodiment of the system illustrated in FIG. 2 exercises a braking on the load by means of the mechanical damper of the engine and drives the secondary dynamo-electric unit to regenerate for charging the rechargeable device or supplying power to another load. FIG. 25 shows system function 23 provided by the preferred embodiment illustrated in FIG. 2, wherein, the secondary dynamo-electric unit functions as a generator to regenerate by reclaiming the kinetics for regenerating so to charge the rechargeable device or to supply power to another load.

FIG. 26 shows that the preferred embodiment of the system illustrated in FIG. 2 exercises a braking on the load by means of the mechanical damper of the engine and drives both of the primary and the secondary dynamo-electric units to regenerate for charging the rechargeable device or supplying power to another load. FIG. 26 shows system function 24 provided by the preferred embodiment illustrated in FIG. 2, wherein, both of the primary and the secondary dynamo-electric units functioning as a generator to regenerate by reclaiming the kinetics so to charge the rechargeable device or to supply power to another load.

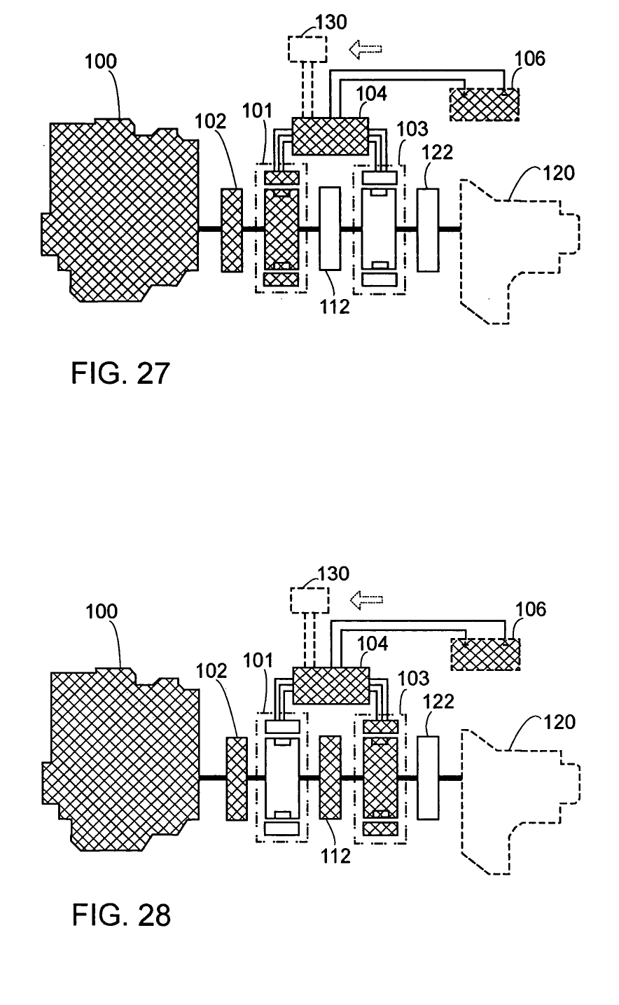

FIG. 27 shows that the preferred embodiment of the system illustrated in FIG. 2 uses the power from the rechargeable device to drive the primary dynamo-electric unit to start the engine. FIG. 27 shows system function 25 provided by the preferred embodiment illustrated in FIG. 2, wherein, the power from the rechargeable device drives the primary dynamo-electric unit to function as a motor to start the engine.

FIG. 28 shows that the preferred embodiment of the system illustrated in FIG. 2 uses the power from the rechargeable device to drive the secondary dynamo-electric unit to start the engine. FIG. 28 shows system function 26 provided by the preferred embodiment illustrated in FIG. 2, wherein, the power from the rechargeable device drives the secondary dynamo-electric unit to function as a motor to start the engine.

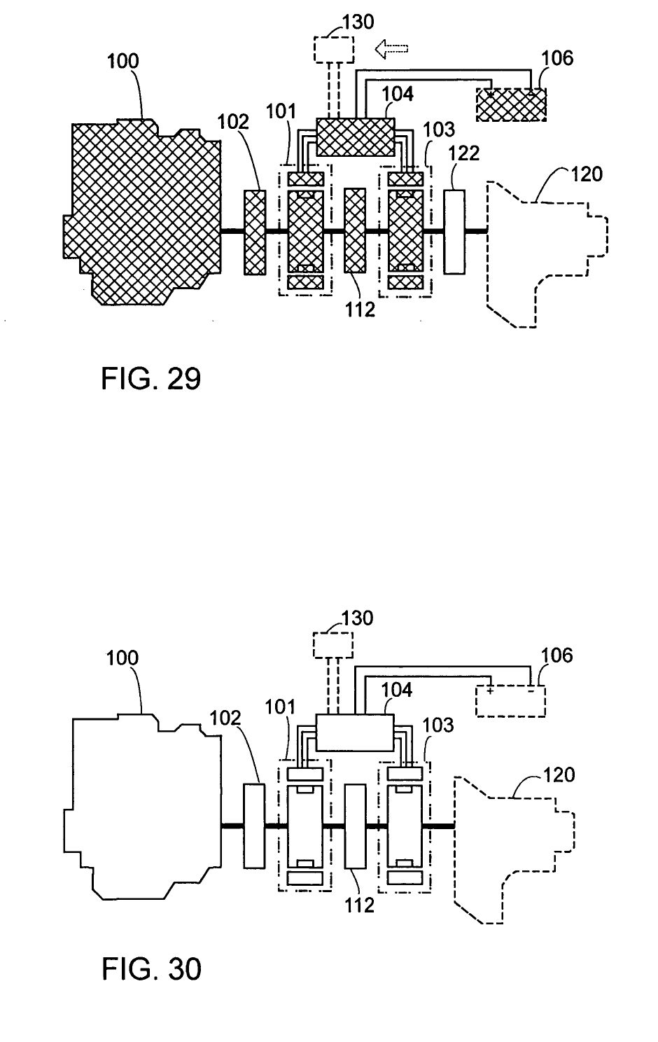

FIG. 29 shows that the preferred embodiment of the system illustrated in FIG. 2 uses the power from the rechargeable device to drive both of the primary and the secondary dynamo-electric units to start the engine. FIG. 29 shows system function 27 provided by the preferred embodiment illustrated in FIG. 2, wherein, the power from the rechargeable device drives both of the primary and the secondary dynamo-electric units to function as a motor to start the engine.

The constant speed of the engine among those system functions described above is defined as the range of operation speed wherein the engine is running at lower fuel consumption but paid the operation region with comparatively higher fuel saving of comparatively higher output power so to reach the optimal brake specific fuel consumption.

In general, the series and parallel combined dual power system of the present invention has the engine as the active power with its essential structure and functions described as follows:
The rotary part of the engine serving as the active rotation power source 100 is directly couple to that of the primary dynamo-electric unit 101; or alternatively, an optional clutch 102 or a variable transmission unit 109 may or may not be provided between the active rotation power source 100 and the primary dynamo-electric unit 101;
The rotation kinetics outputted from the engine serving as the active rotation power source 100 drives the rotary part of the primary dynamo-electric unit 101 to function as a generator; the clutch 112 is provided between the rotary part of the primary dynamo-electric unit 101 and that of the secondary dynamo-electric unit 103; when the system is converted into the operation as the series combined power system, the clutch 112 is not coupled; instead, the engine serving as the active rotation power source 100 drives the primary dynamo-electric unit to function as a generator with the outputted power to further drive the secondary dynamo-electric unit to function as a motor for driving the load; if as required, the system is adapted with the rechargeable device 106 and other power driven load, the power generated by the primary dynamo-electric unit charges the rechargeable device 106 or supplies power to another load in case of a light load or no-load;
In the normal load, the clutch 112 located between both of the primary and the secondary dynamo-electric units is closed; the optional clutch 102 may or may not be provided between the rotary part of the engine serving as the active rotation power source 100 and that of the primary dynamo-electric unit 101; if the clutch 102 is provided, it is also closed; the optional clutch 122 may or may not be provided between the secondary dynamo-electric unit 103 and the load; and if the clutch 1122 is provided, it is also closed so that the rotation kinetics outputted form the engine serving as the active rotation power source 100 drives the load through the rotary part of the primary dynamo-electric unit 101 and that of the secondary dynamo-electric unit 103. If as required, the optional rechargeable device 106 is provided and in case of a heavy load, the clutch 112 is closed and the system indicates operation of the parallel combined power system. The optional clutches 102 and 122 may or may not be provided to the system. If the clutch 102 is provide, it is also closed; if the clutch 122 is provided, it is also closed; instead, the power from the rechargeable device 106 drives either or both of the primary and the secondary dynamo-electric units 101, 103 to function as a motor with the rotation kinetics outputted and that from the engine to jointly drive the load. In case of a light load, either or both of the primary and the secondary dynamo-electric units 101, 103 is converted to function as a generator for charging the rechargeable device 106 or supplying power to another load;
If the rechargeable device 106 and the clutch 102 are provided to the system, the clutch 102 is disengaged and the clutch 112 is closed, then the power from the rechargeable device drives either or both of the primary and the secondary dynamo-electric units 101, 103 to output rotation kinetics for driving the load; if the clutch 112 is disengaged, then the rechargeable device 106 drives the secondary unit 103 to output rotation kinetics for driving the load; and including but not limited to those secondary functions with or without the optional items as the case may be:
The clutch 112 is disengaged (if the optional clutch 102 is adapted, it is also closed), and the power from the rechargeable device 106 drives the primary dynamo-electric unit 101 to function as a motor for starting the engine serving as the active rotation power source 100;
The power from the rechargeable device 106, or that from the redundant rechargeable device 110 drives the optional start motor 124 through the optional start switch 111 to start the engine serving as the active rotation power source 100 through the variable transmission unit 109;
The clutch 112 is controlled to indicate disengaged status while the power from the rechargeable device 106 controls the speed, torque, and orientation of the secondary dynamo-electric unit 104 to function as a motor through the drive control unit 104 for outputting to drive the load; and
The clutch 112 is controlled to indicate closed status for the engine serving as the active rotation power source 100 to revolve in positive or negative orientation through the optional variable transmission unit 109 to output kinetics to drive the load.

For environmental consideration, the demands of the driving power in case that the engine fails, and the energy storage demands when the regenerated power exercises a brake, the series and parallel combined dual power drive system of the present invention may be adapted with the optional rechargeable device 106, so to control the generation power when the rotation kinetics from the engine serving as the active rotation power source 100 drives the primary dynamo-electric unit 101 to serve as a generator, and further to charge the rechargeable device 106 in case of no-load, light load or at other proper time, or to supply power to another power driven load 130. Functions provided by the system include:

When the system operates as the series combined power system, it controls the clutch 112 to indicate disengaged status (as required, the clutch 102 and the clutch 122 may or may not be provided to the system; if the clutch 102 is provided, it is closed; if the clutch 122 is provided, it is also closed). As the system operates as the series combined power system, the rotation kinetics from the engine serving as the active rotation power source 100 drives the primary dynamo-electric unit 101 to function as a generator with the power generated while directly driving the secondary dynamo-electric unit to function as a motor for driving the load 120, further charges at random the rechargeable device 106 when adapted, or supplies power to another load 130 for the engine serving as the active rotation power source 100 to operate in a range featuring higher energy efficiency;
When the system operates as the parallel combined power system, the clutch 112 is closed (as required, the clutch 102 and the clutch 122 may or may not be provided to the system; if the clutch 102 is provided, it is closed; if the clutch 122 is provided, it is also closed), and the rotation kinetics fro the engine serving as the active rotation power source 100 directly drives the load 120; if the rechargeable device 106 is adapted and in case of a light load 120, the engine drives either or both of the primary and the secondary dynamo-electric units 101, 103 to function as a generator to charge the rechargeable device 106 or to supply power to another power driven load 130 for the active rotation power source 100 to operate in a range feature higher energy efficiency;
When the system operates as the parallel combined power system, the clutch 112 is controlled to indicate closed status (as required, the clutch 102 and the clutch 122 may or may not be provided to the system; if the clutch 102 is provided, it is closed; if the clutch 122 is provided, it is also closed), the power from the rechargeable device 106 drives either or both of the primary and the secondary dynamo-electric units 101, 103 to operate as a motor to output rotation kinetics together with that outputted from the engine serving as the active rotation power source to jointly drive the load;
When the system controls the clutch 112 to indicate disengaged status on the drive power outputted from the rechargeable device 106, the power from the rechargeable device 106 also drives the secondary dynamo-electric unit 103 to drive the load 120, or controls the clutch 112 to indicate closed status (if the optional clutch 102 is adapted, it is also controlled to indicate closed status), and the power from the rechargeable device 106 drives either or both of the primary and the secondary dynamo-electric units 101, 103 to function as a motor for driving the load 120; and if the clutch 122 is adapted to the system, the clutch 122 also indicates closed status;
If the system operates as a generator to control the clutch 112 to indicate disengaged status (if the optional clutch 102 is adapted, it indicates closed status), and the engine serving as the active rotation power source 100 drives the primary dynamo-electric unit 101 to function as a generator to output power, or when the optional clutch 122 is adapted to the system and the clutch 122 indicates disengaged status (if the optional clutch 102 is adapted, it is also controlled to indicate closed status), the engine serving as the active rotation power source 100 drives either or both of the primary and the secondary dynamo-electric units 101, 103 to function as a generator to output power to charge the rechargeable device 106 or to supply power to another power driven load 13o;
Both of the primary and the secondary dynamo-electric units to regenerate by reclaiming the kinetics for exercising the brake, the clutch 112 indicates disengaged status, and the secondary dynamo-electric unit 103 is converted to function as a generator to charge the rechargeable device 106 or to supply power to another power driven load 130; if the optimal clutch 122 is adapted to the system, both clutches 10, 112 indicate closed status; or when the optimal clutch 102 is adapted to the system with the clutch 102 indicating disengaged status and the clutch 112 indicating closed status, then either or both of the primary and the secondary dynamo-electric units 101, 103 is converted to function as a generator for charging the rechargeable device 106 or supplying power to another power driven load 130 to exercise the brake by the regenerated power, and if the optional clutch 122 is adapted to the system, the clutch 122 indicates closed status;
The mechanical damper of the engine is directly used to exercise the brake, or if the rechargeable device 106 is adapted, either or both of he primary and the secondary dynamo-electric units 101, 103 functions at the same time as a generator to charge the rechargeable device 106 or to supply power to another power driven load 130 for providing the brake by the regenerated power;
When the power from the rechargeable device 106 drives the dynamo-electric unit to start the engine, the clutch 112 is controlled to indicate disengaged status, the power from the rechargeable device 106 drives the primary dynamo-electric unit 101 to function as the start motor to start the engine serving as the active rotation power source 100; or when the optional clutch 122 is adapted to the system, the clutch indicates disengaged status and the clutch 112 indicates closed status, and the power from the rechargeable device 106 drives either or both of he primary and the secondary dynamo-electric units 101, 103 to function as a start motor to start the engine serving as the active rotation power source 100; and
The system provides all or any of those functions described above.

Under the same operation mechanism of the system, the spatial location of each of all the units may be arranged as required. Each unit may be made into a standing alone unit as required before being coupled to another unit; or as required, two or more than two units of the system may be made by sharing the same structure in various arrangements depending on the spatial conditions and other factors including heat dissipation, noise, manageability, and service.

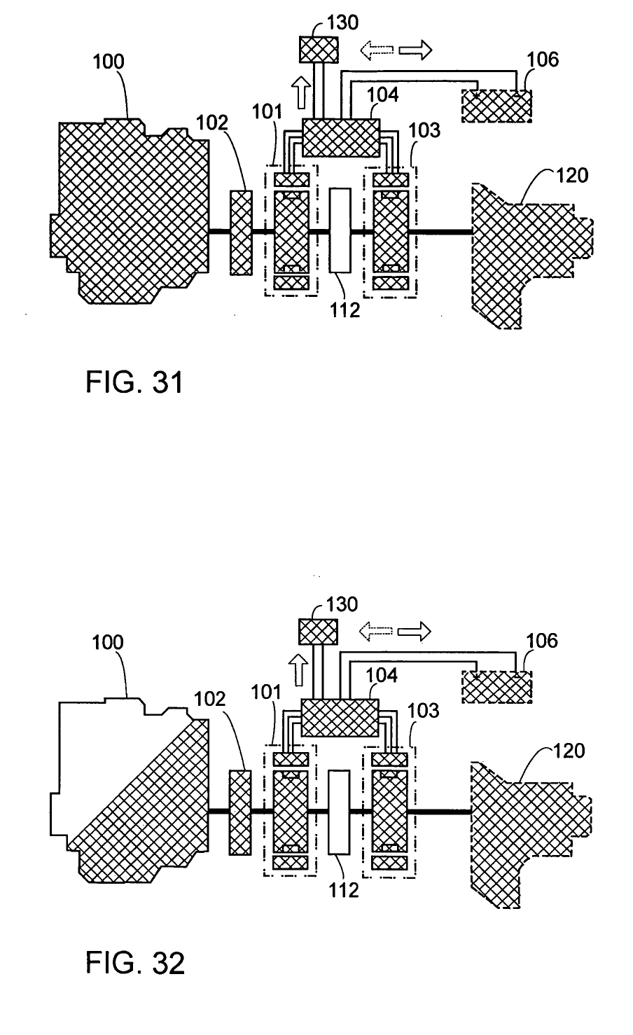

FIG. 30 shows that the preferred embodiment of the system illustrated in FIG. 2 is not adapted with a clutch between the output end and the load. As illustrated in FIG. 30, the clutch 112 is not adapted to where between the output end and the load side of the system. If the input end of the load is adapted with a clutch, the variable transmission dose not provide idling shift function, and the secondary dynamo-electric unit 103 fails to function as a generator driven by the engine serving as the active power source 100 of the system, nor as a motor to start the engine as illustrated in FIG. 2. The system may be selected to provide system functions 1˜15, and all or any part of system functions 18˜15 listed in Table B. Those system functions listed in Table B are illustrated in FIGS. 31˜53.

FIG. 31 shows that the preferred embodiment of the system illustrated in FIG. 30 is adapted with the rechargeable unit to operate as the series combined power system with controllable engine speed. FIG. 31 shows system function 1 provided by the preferred embodiment illustrated in FIG. 30, wherein, the rechargeable device is adapted to the system and the system engages in the series combined power operation to drive the load.

FIG. 32 shows that the preferred embodiment of the system illustrated in FIG. 30 adapted with the rechargeable device operates as the series combined power system with the engine running at a constant speed. FIG. 32 shows system function 2 provided by the preferred embodiment illustrated in FIG. 30, wherein, the rechargeable device is adapted for the engine to run at a constant speed for driving the system to engage in the series combined power operation to drive the load.

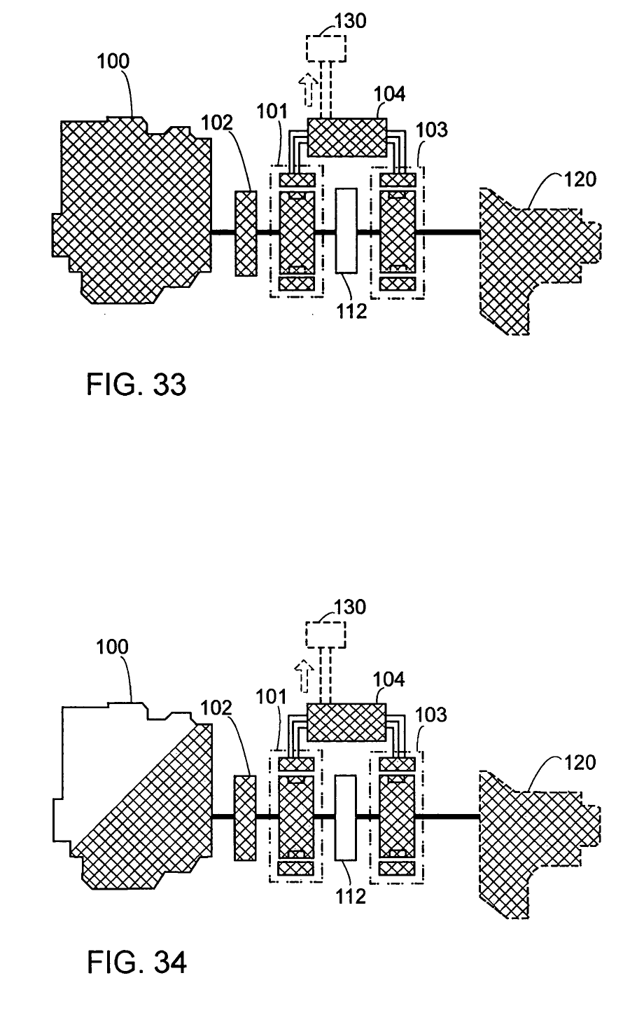

FIG. 33 shows that the preferred embodiment of the system illustrated in FIG. 30 operate as the series combined power system with controllable engine speed without the adaptation of a rechargeable unit.

FIG. 34 is a schematic view showing that the preferred embodiment of the system illustrated in FIG. 30 operate as the series combined power system with the engine running at constant speed without the adaptation of a rechargeable unit. FIG. 34 shows system function 4 provided by the preferred embodiment illustrated in FIG. 30, wherein, no rechargeable device is adapted to the system, and the engine runs at a constant speed to drive the system to engage in the series combined power operation for driving the load.

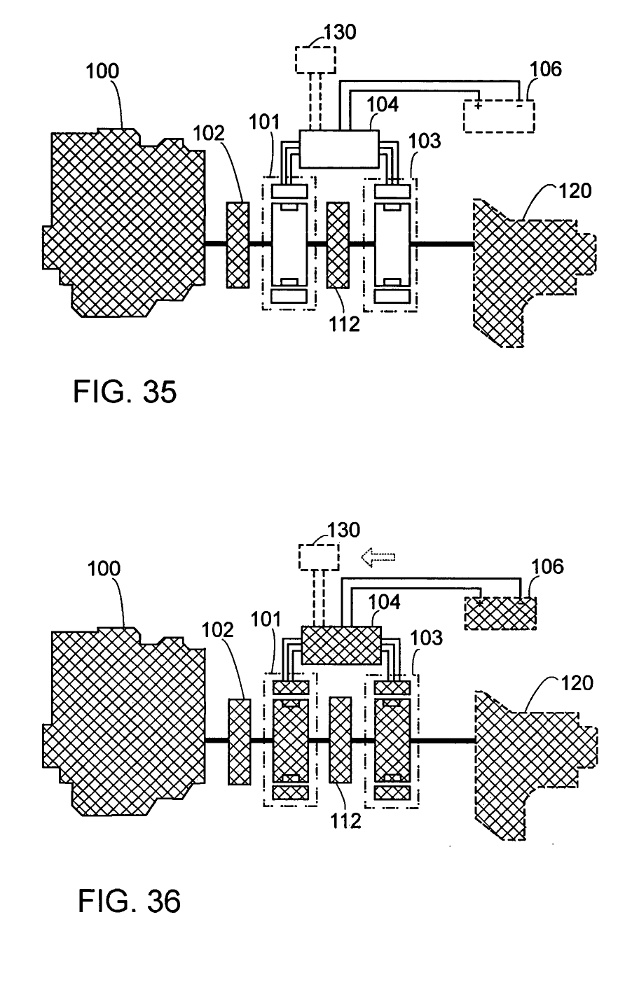

FIG. 35 shows that the preferred embodiment of the system illustrated in FIG. 30 operates on the power from the engine to drive the load. FIG. 35 shows system function 5 provided by the preferred embodiment illustrated in FIG. 35, wherein, the system has the engine to drive the load.

FIG. 36 shows that the preferred embodiment of the system illustrated in FIG. 30 operates on the power from the engine to jointly drive the load with both of the primary and the secondary dynamo-electric units driven by the rechargeable device. FIG. 36 shows system function 6 by the preferred embodiment illustrated in FIG. 30, wherein, the power from the engine and both of the primary and the secondary dynamo-electric units driven by the rechargeable device function as a motor in case of a heavy load to jointly drive the load.

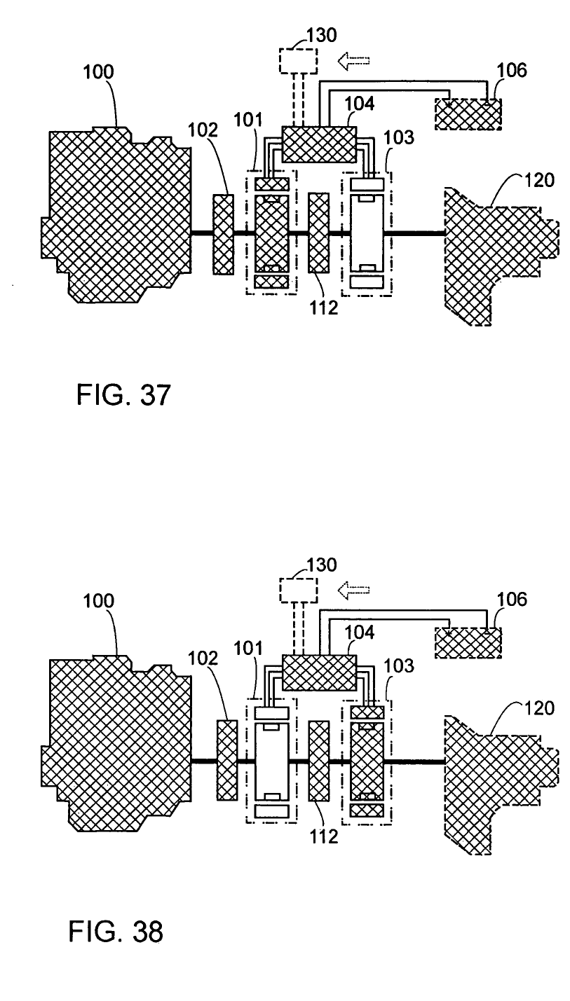

FIG. 37 shows that the preferred embodiment of the system illustrated in FIG. 30 operates on the power from the engine to jointly drive the load with the primary dynamo-electric unit driven by the rechargeable device. FIG. 37 shows system function 7 provided by the preferred embodiment illustrated in FIG. 30, wherein, in case of a heavy load, it is jointly driven by the power from the engine and both of the primary and the secondary dynamo-electric units functioning as a motor.

FIG. 38 shows that the preferred embodiment of the system illustrated in FIG. 30 operates on the power from the engine to jointly drive the load with the secondary dynamo-electric unit driven by the rechargeable device. FIG. 38 shows system function 8 provided by the preferred embodiment illustrated in FIG. 30, wherein, in case of a heavy load, the power from the engine and the secondary dynamo-electric unit driven by the rechargeable device functions a motor to jointly drive the load.

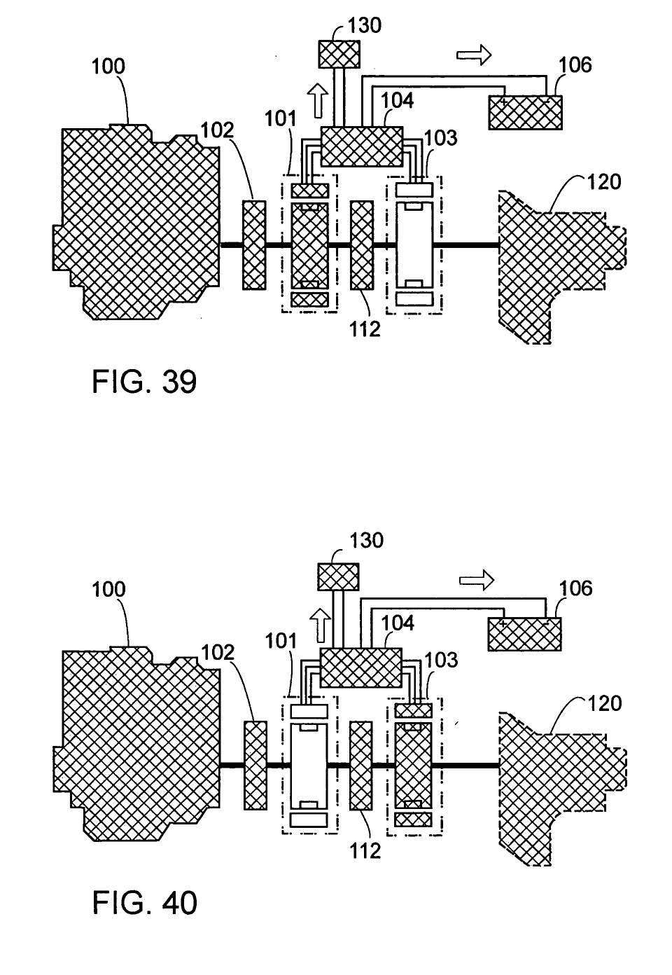

FIG. 39 shows that the preferred embodiment of the system illustrated in FIG. 30 operates on the power from the engine to drive the load, and drive the primary dynamo-electric unit to function as a generator to charge the rechargeable device or supply power to another load. FIG. 39 shows system function 9 provided by the preferred embodiment illustrated in FIG. 30, wherein, the power from the engine drives the load and the primary dynamo-electric unit to function as a generator for charging the rechargeable device or supplying power to another load.

FIG. 40 shows that the preferred embodiment of the system illustrated in FIG. 30 operates on the power from the engine to drive the load, and drive the secondary dynamo-electric unit to function as a generator to charge the rechargeable device or supply power to another load. FIG. 40 shows system function 10 provided by the preferred embodiment illustrated in FIG. 30, wherein, the power from the engine drives the load and the secondary dynamo-electric unit to function as a generator for charging the rechargeable device or supplying power to another load.

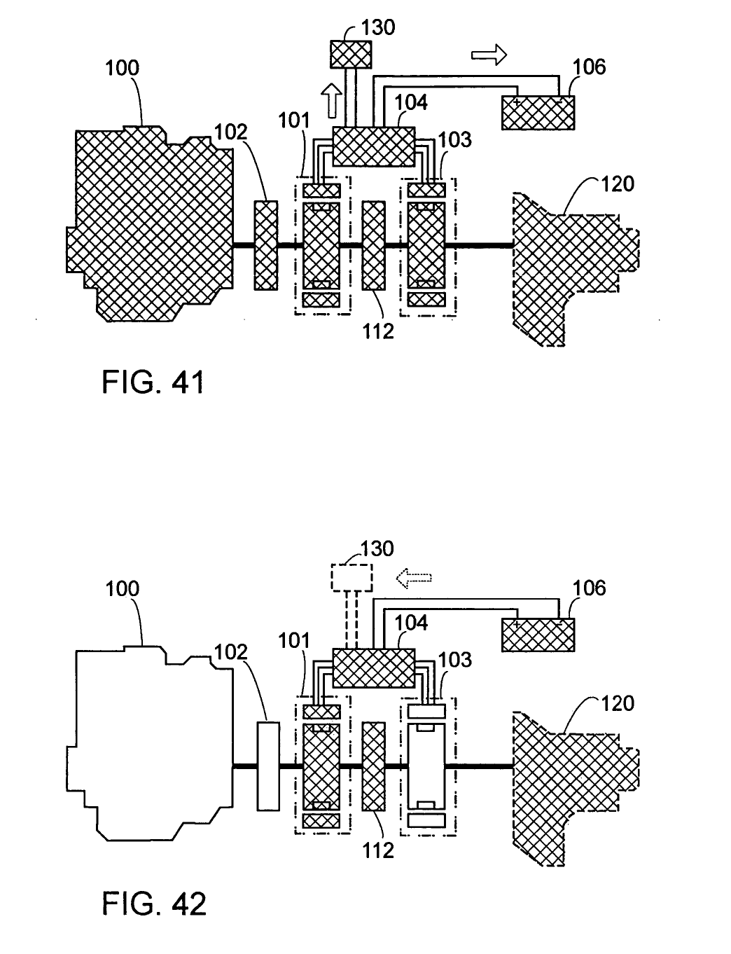

FIG. 41 shows that the preferred embodiment of the system illustrated in FIG. 30 operates on the power from the engine to drive the load, and drive both of the primary and the secondary dynamo-electric units to function as a generator to charge the rechargeable device or supply power to another load. FIG. 41 shows system function 11 provided by the preferred embodiment illustrated in FIG. 30, wherein, the power from the engine drives the load and both of the primary and the secondary dynamo-electric units to function as a generator for charging the rechargeable device or supplying power to another load.

FIG. 42 shows that the preferred embodiment of the system illustrated in FIG. 30 operates on the power from the rechargeable device to drive the primary dynamo-electric unit to further drive the load. FIG. 42 shows system function 12 provided by the preferred embodiment illustrated in FIG. 30, wherein, the power form the rechargeable device drives the primary dynamo-electric unit to function as a motor for driving the load.

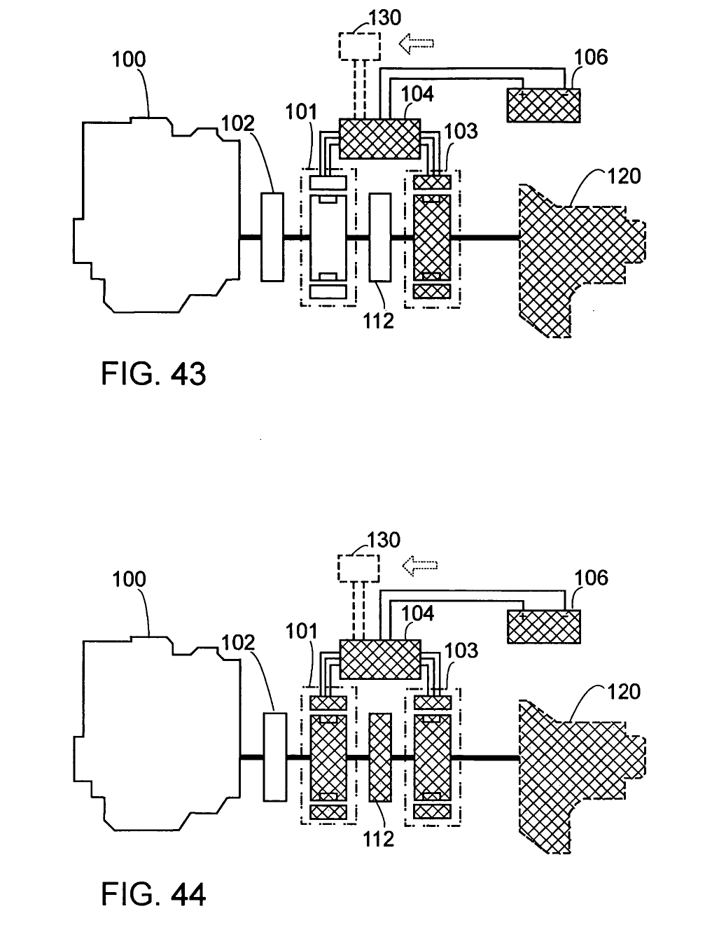

FIG. 43 shows that the preferred embodiment of the system illustrated in FIG. 30 operates on the power from the rechargeable device to drive the secondary dynamo-electric unit to further drive the load. FIG. 43 shows system function 13 provided by the preferred embodiment illustrated in FIG. 30, wherein, the power form the rechargeable device drives the secondary dynamo-electric unit to function as a motor for driving the load.

FIG. 44 shows that the preferred embodiment of the system illustrated in FIG. 30 operates on the power from the rechargeable device to drive both of the primary and the secondary dynamo-electric units to further drive the load. FIG. 44 shows system function 14 provided by the preferred embodiment illustrated in FIG. 30, wherein, the power form the rechargeable device drives both of the primary and the secondary dynamo-electric units to function as a motor for driving the load.

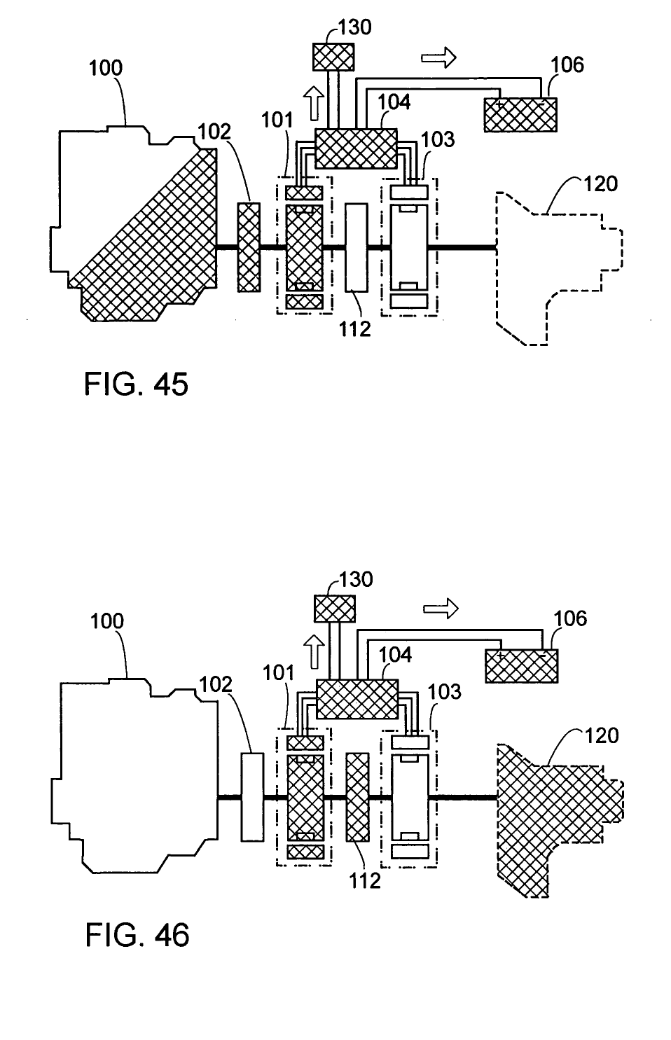

FIG. 45 shows that the preferred embodiment of the system illustrated in FIG. 30 has the engine to run at constant speed for driving the primary dynamo-electric unit to function as a generator to charge the rechargeable device or to supply power to another load. FIG. 45 shows system function 15 provided by the preferred embodiment illustrated in FIG. 30, wherein, the engine runs at a constant speed to drive the primary dynamo-electric unit to function as a generator to charge the rechargeable device or to supply power to another load.

FIG. 46 shows that the preferred embodiment of the system illustrated in FIG. 30 has the load to drive the primary dynamo-electric unit to regenerate by reclaiming the kinetics r so to charge the rechargeable device or to supply power to another load. FIG. 46 shows system function 18 provided by the preferred embodiment illustrated in FIG. 30, wherein, the system has the load to exercise the operation of a brake thus to draw the primary dynamo-electric unit to function as a generator for charging the rechargeable device or supplying power to another load.

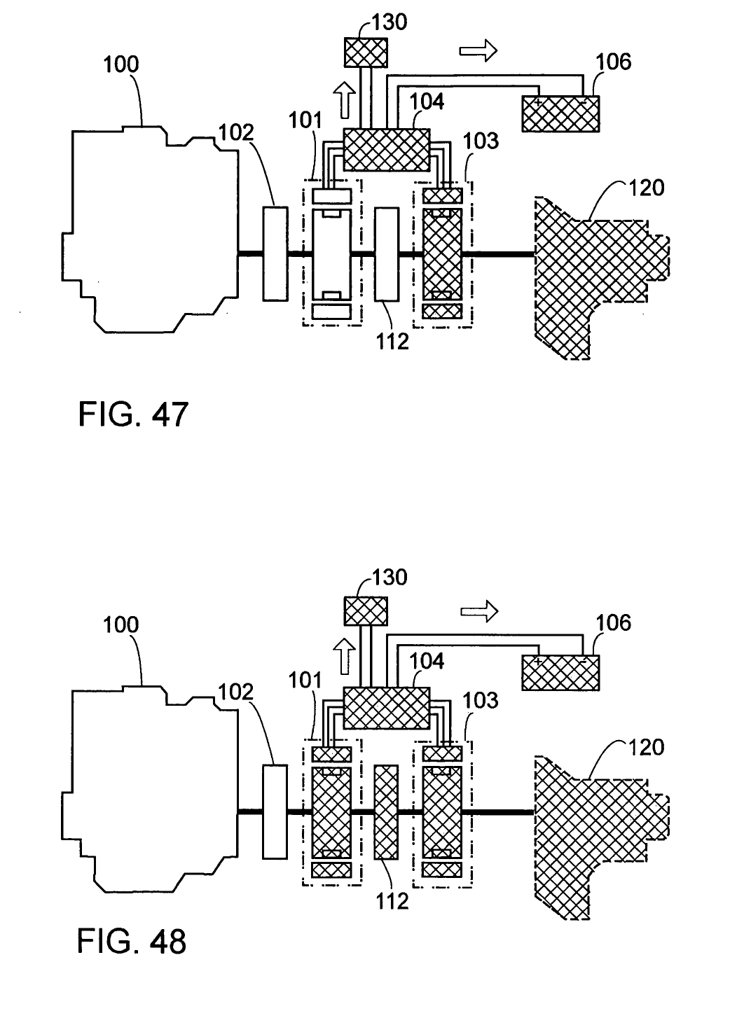

FIG. 47 shows that the preferred embodiment of the system illustrated in FIG. 30 has the load to drive the secondary dynamo-electric unit to regenerate by reclaiming the kinetics so to charge the rechargeable device or to supply power to another load. FIG. 47 shows system function 19 provided by the preferred embodiment illustrated in FIG. 30, wherein, the system has the load to exercise the operation of a brake thus to draw the secondary dynamo-electric unit to function as a generator for charging the rechargeable device or supplying power to another load.

FIG. 48 shows that the preferred embodiment of the system illustrated in FIG. 30 has the load to drive both of the primary and the secondary dynamo-electric units to regenerate by reclaiming the kinetics so to charge the rechargeable device or to supply power to another load. FIG. 48 shows system function 20 provided by the preferred embodiment illustrated in FIG. 30, wherein, the system has the load to exercise the operation of a brake thus to draw both of the primary and the secondary dynamo-electric units to function as a generator for charging the rechargeable device or supplying power to another load.

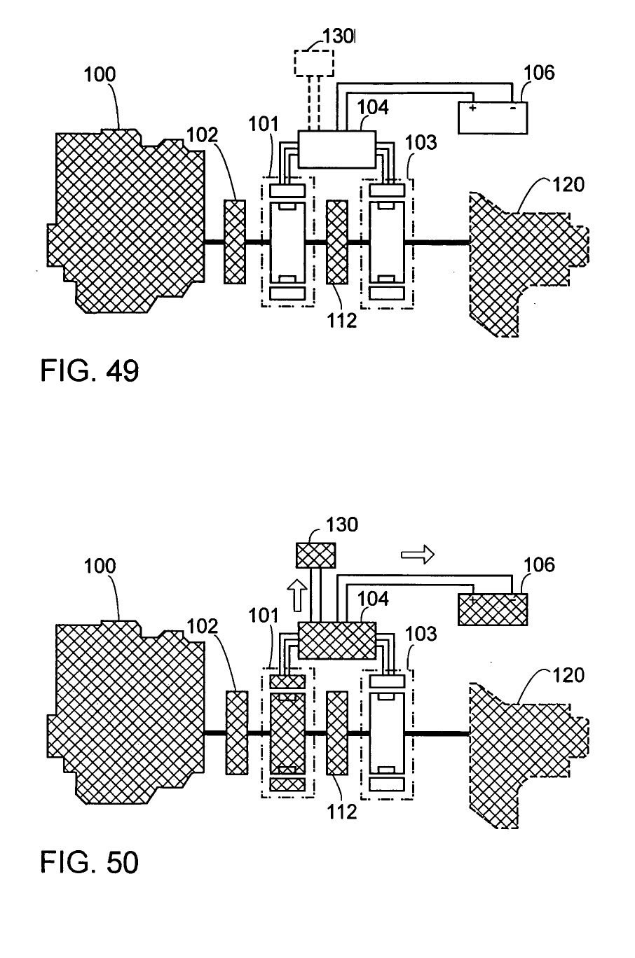

FIG. 49 shows that the preferred embodiment of the system illustrated in FIG. 30 has the mechanical damper from the engine to exercise a brake to the load. FIG. 49 shows system function 21 provided by the preferred embodiment illustrated in FIG. 30, wherein, the mechanical damper from the engine exercises the braking operation on the load.

FIG. 50 shows that the preferred embodiment of the system illustrated in FIG. 30 has the mechanical damper from the engine to exercise a brake on the load and to drive the primary dynamo-electric unit to regenerate for charging the rechargeable device or supplying power to another load. FIG. 50 shows system function 22 provided by the preferred embodiment illustrated in FIG. 30, wherein, the mechanical damper from the engine exercises the braking operation on the load while the primary dynamo-electric unit operates as a motor to regenerate by reclaiming the kinetics to charge the rechargeable device or to supply power to another load.

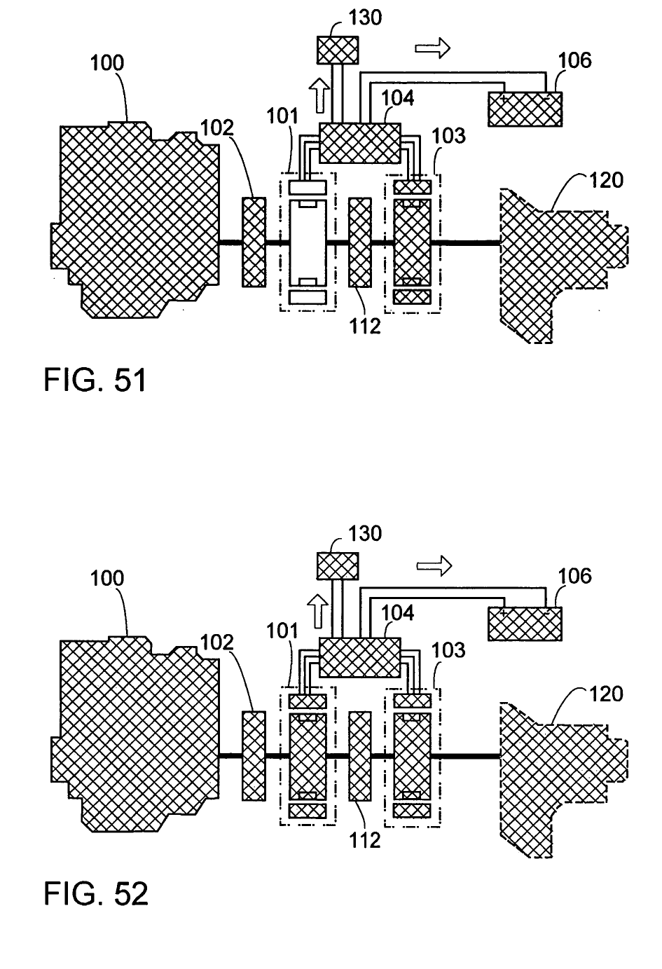

FIG. 51 shows that the preferred embodiment of the system illustrated in FIG. 30 has the mechanical damper from the engine to exercise a brake on the load and to drive the secondary dynamo-electric unit to regenerate for charging the rechargeable device or supplying power to another load. FIG. 51 shows system function 23 provided by the preferred embodiment illustrated in FIG. 30, wherein, the mechanical damper from the engine exercises the braking operation on the load while the secondary dynamo-electric unit operates as a motor to regenerate by reclaiming the kinetics to charge the rechargeable device or to supply power to another load.

FIG. 52 shows that the preferred embodiment of the system illustrated in FIG. 30 has the mechanical damper from the engine to exercise a brake on the load and to drive both of the primary and the secondary dynamo-electric units to regenerate for charging the rechargeable device or supplying power to another load. FIG. 52 shows system function 24 provided by the preferred embodiment illustrated in FIG. 30, wherein, the mechanical damper from the engine exercises the braking operation on the load while both of the primary and the secondary dynamo-electric units function as a motor to regenerate by reclaiming the kinetics to charge the rechargeable device or to supply power to another load.

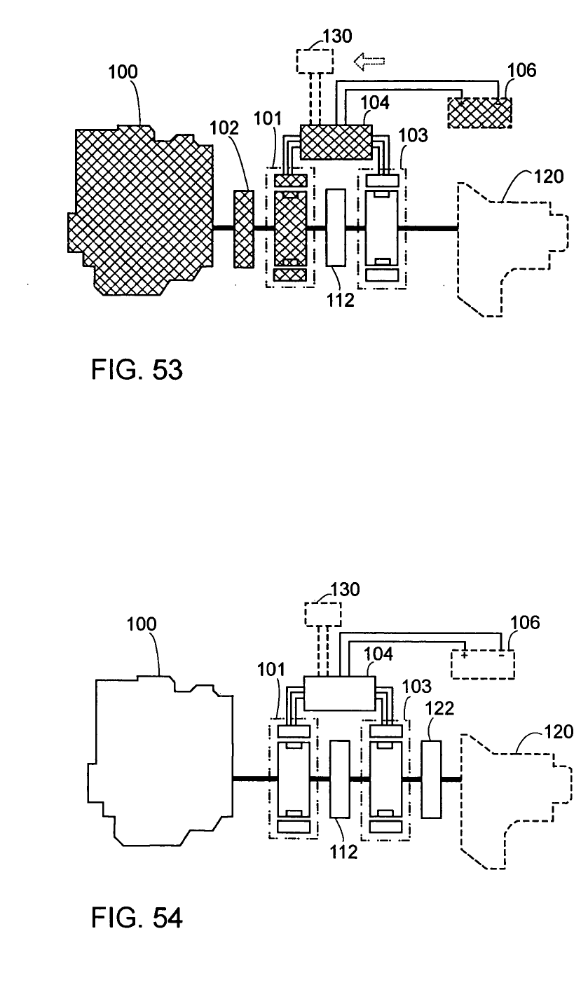

FIG. 53 shows that the preferred embodiment of the system illustrated in FIG. 30 operates on the power from the rechargeable device to drive the primary dynamo-electric unit to start the engine. FIG. 53 shows system function 25 provided by the preferred embodiment illustrated in FIG. 30, wherein, the power from the rechargeable device drives the primary dynamo-electric unit to function as a motor to start the engine.

FIG. 54 shows that no clutch is provided between an active rotation power source and the primary dynamo-electric unit of the preferred embodiment of the system illustrated in FIG. 2. Wherein, no optional clutch 102 is provided at where between the engine serving as the active rotation power source 100 and the primary dynamo-electric unit 101; therefore, the primary dynamo-electric unit 101 does not function as a motor to drive the load as illustrated in FIG. 2, nor regenerates by reclaiming the kinetics to exercise the brake; instead, the system as selected provides all or any part of those system functions 1˜11, 13, 15˜17, 19, 21˜27 as listed in Table C as illustrated in FIGS. 55˜77.

FIG. 55 shows that the preferred embodiment of the system illustrated in FIG. 54 is adapted with the rechargeable unit to operate as the series combined power system with controllable engine running speed. FIG. 55 shows system function 1 provided by the preferred embodiment illustrated in FIG. 54, wherein, the rechargeable device is adapted to the system to engage in the series combined power operation to drive the load.

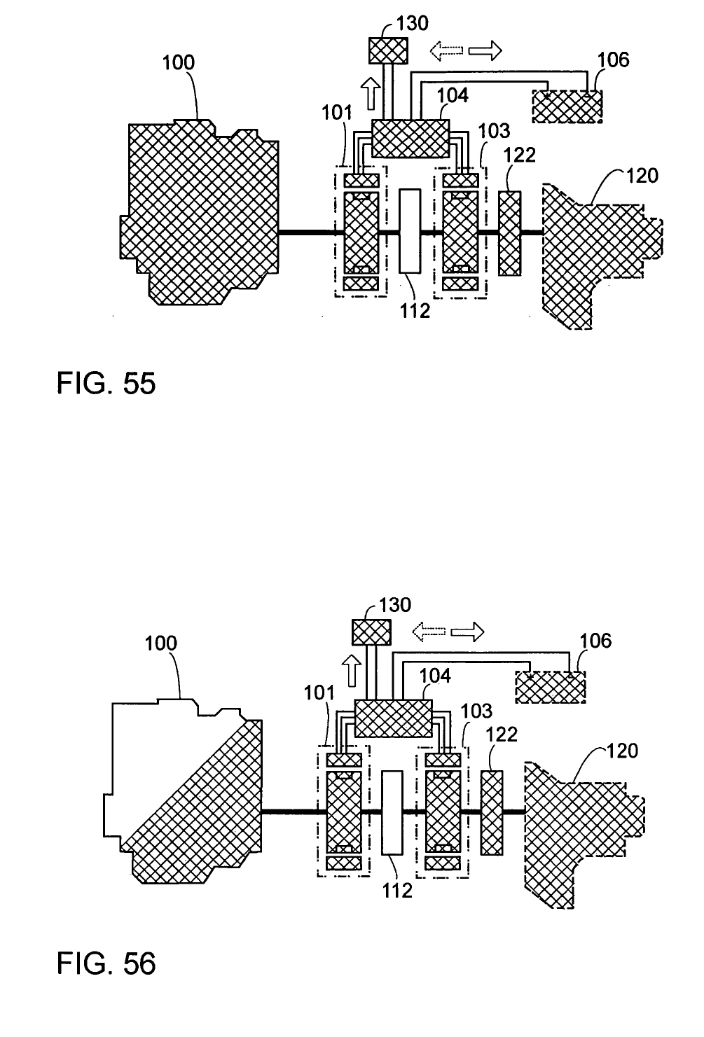

FIG. 56 shows that the preferred embodiment of the system illustrated in FIG. 54 is adapted with the rechargeable unit to operate as the series combined power system with the engine running at constant speed. FIG. 56 shows system function 2 provided by the preferred embodiment illustrated in FIG. 54, wherein, the rechargeable device is adapted to the system and the engine runs at a constant speed to drive the system to engage in the series combined power operation for driving the load.

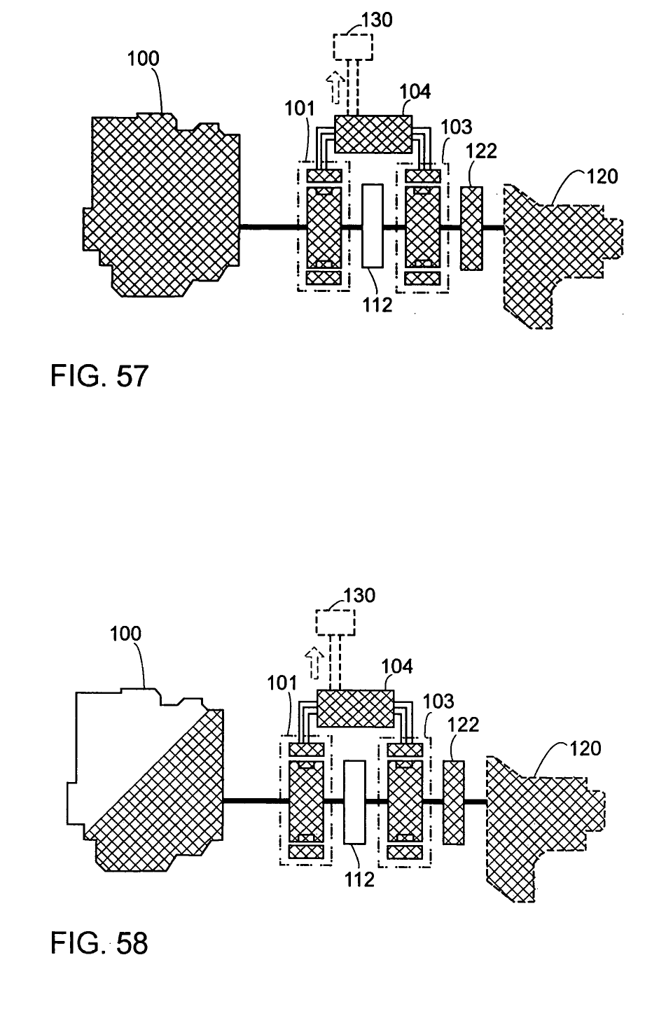

FIG. 57 shows that the preferred embodiment of the system illustrated in FIG. 54 operates as the series combined power system with controllable engine running speed without the adaptation of the rechargeable device. FIG. 57 shows system function 3 provided by the preferred embodiment illustrated in FIG. 54, wherein, the system is not adapted with the rechargeable device and is engaging in the series combined power operation to drive the load.

FIG. 58 shows that the preferred embodiment of the system illustrated in FIG. 54 operates as the series combined power system with the engine running at constant speed. FIG. 58 shows system function 4 provided by the preferred embodiment illustrated in FIG. 54, wherein, the system is not adapted with the rechargeable device and the engine runs at a constant speed to drive the system to engage in the series combined power operation for driving the load.

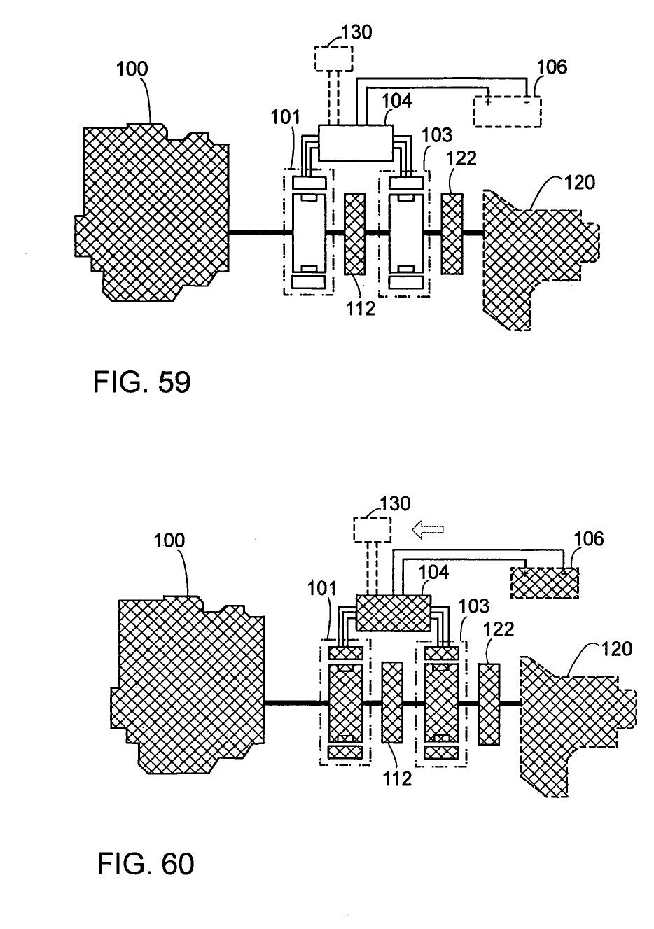

FIG. 59 shows that the preferred embodiment of the system illustrated in FIG. 54 operated on the power form the engine to drive the load. FIG. 59 shows system function 5 provided by the preferred embodiment illustrated in FIG. 54, wherein, the system has the power from the engine to drive the load.

FIG. 60 shows that the preferred embodiment of the system illustrated in FIG. 54 operates on the power from the engine to jointly drive the load with both of the primary and the secondary dynamo-electric units driven by the rechargeable device. FIG. 60 shows system function 6 provided by the preferred embodiment illustrated in FIG. 54, wherein, the power from the engine, and in case of a heavy load, both of the primary and the secondary dynamo-electric units driven by the rechargeable device functioning as a motor jointly drive the load

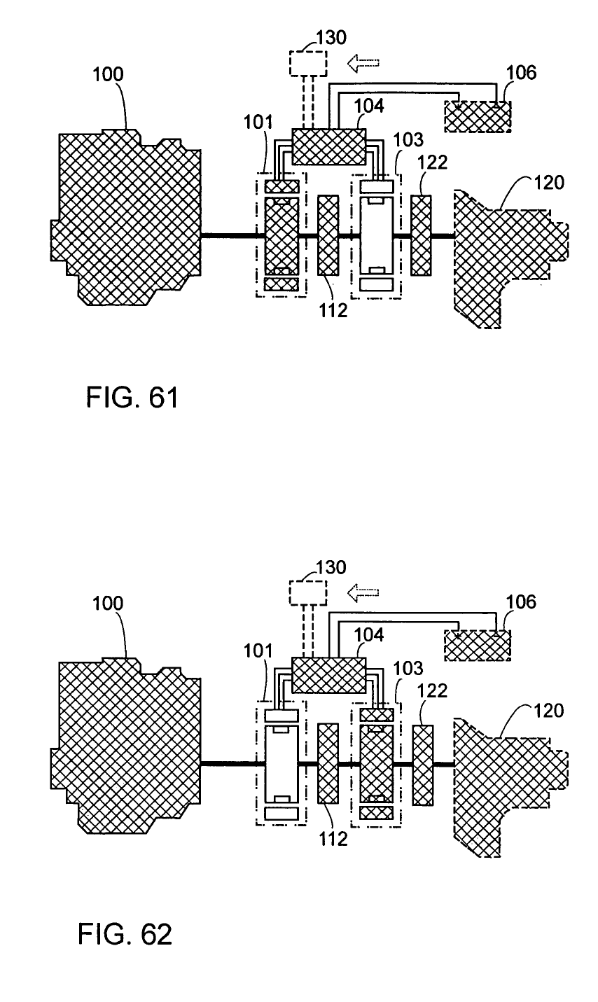

FIG. 61 shows that the preferred embodiment of the system illustrated in FIG. 54 operates on the power from the engine to jointly drive the load with both of the primary dynamo-electric unit driven by the rechargeable device. FIG. 61 shows system function 7 provided by the preferred embodiment illustrated in FIG. 54, wherein, the system in case of a heavy load has the power from the engine and the primary dynamo-electric unit driven by the rechargeable device to function as a motor jointly drive the load.

FIG. 62 shows that the preferred embodiment of the system illustrated in FIG. 54 operates on the power from the engine to jointly drive the load with both of the secondary dynamo-electric unit driven by the rechargeable device. FIG. 62 shows system function 8 provided by the preferred embodiment illustrated in FIG. 54, wherein, the system in case of a heavy load has the power from the engine and the secondary dynamo-electric unit driven by the rechargeable device to function as a motor jointly drive the load.

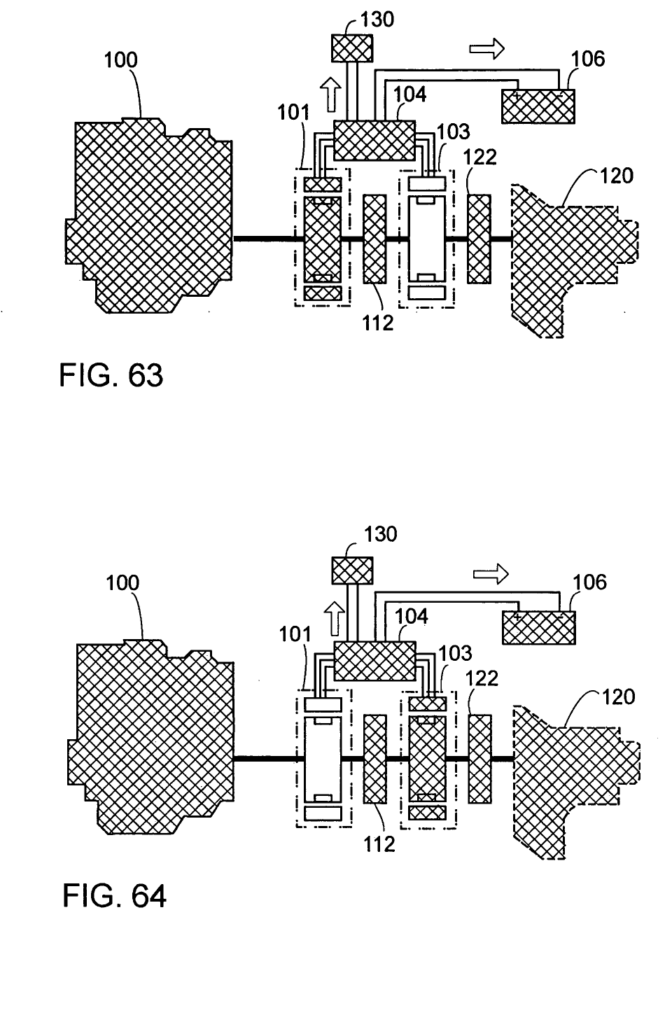

FIG. 63 shows that the preferred embodiment of the system illustrated in FIG. 54 operates on the power from the engine to drive the load and to drive the primary dynamo-electric unit to function as a generator for charging the rechargeable device or supplying power to another load. FIG. 63 shows system function 9 provided by the preferred embodiment illustrated in FIG. 54, wherein, the power from the engine drives the load and the primary dynamo-electric unit to function as a generator for charging the rechargeable device or supplying power to another load.

FIG. 64 shows that the preferred embodiment of the system illustrated in FIG. 54 operates on the power from the engine to drive the load and to drive the secondary dynamo-electric unit to function as a generator for charging the rechargeable device or supplying power to another load. FIG. 64 shows system function 10 provided by the preferred embodiment illustrated in FIG. 54, wherein, the power from the engine drives the load and the secondary dynamo-electric unit to function as a generator for charging the rechargeable device or supplying power to another load.

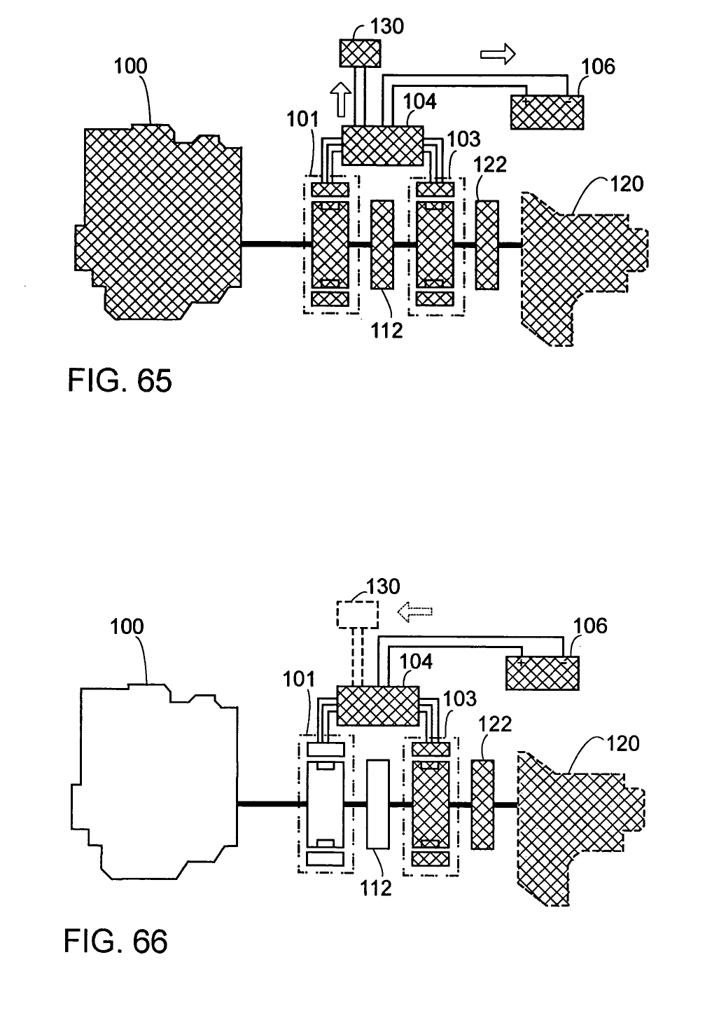

FIG. 65 shows that the preferred embodiment of the system illustrated in FIG. 54 operates on the power from the engine to drive the load and to drive both of the primary and the secondary dynamo-electric units to function as a generator for charging the rechargeable device or supplying power to another load. FIG. 65 shows system function 11 provided by the preferred embodiment illustrated in FIG. 54, wherein, the power from the engine drives the load and both of the primary and the secondary dynamo-electric units to function as a generator for charging the rechargeable device or supplying power to another load.

FIG. 66 shows that the preferred embodiment of the system illustrated in FIG. 54 has the power from the rechargeable device to drive the secondary dynamo-electric unit to further drive the load. FIG. 66 shows system function 13 provided by the preferred embodiment illustrated in FIG. 54, wherein, the power from the rechargeable device drives the secondary dynamo-electric unit to function as a motor to drive the load.

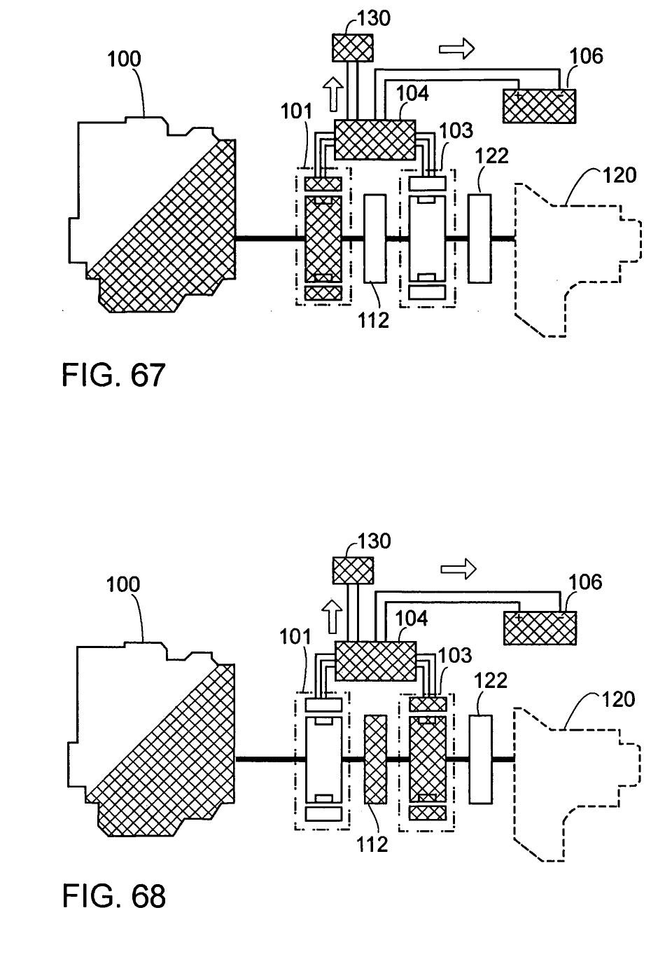

FIG. 67 shows that the preferred embodiment of the system illustrated in FIG. 54 has the engine running at constant speed to drive the primary dynamo-electric unit to function as a generator for charging the rechargeable device or supplying power to another load. FIG. 66 shows system function 15 provided by the preferred embodiment illustrated in FIG. 54, wherein, the power from the rechargeable device drives the primary dynamo-electric unit to function as a motor to drive the load.

FIG. 68 shows that the preferred embodiment of the system illustrated in FIG. 54 has the engine running at constant speed to drive the secondary dynamo-electric unit to function as a generator for charging the rechargeable device or supplying power to another load. FIG. 68 shows system function 16 provided by the preferred embodiment illustrated in FIG. 54, wherein, the engine runs at a constant speed to drive the secondary dynamo-electric unit to function as a generator for charging the rechargeable device or supplying power to another load.

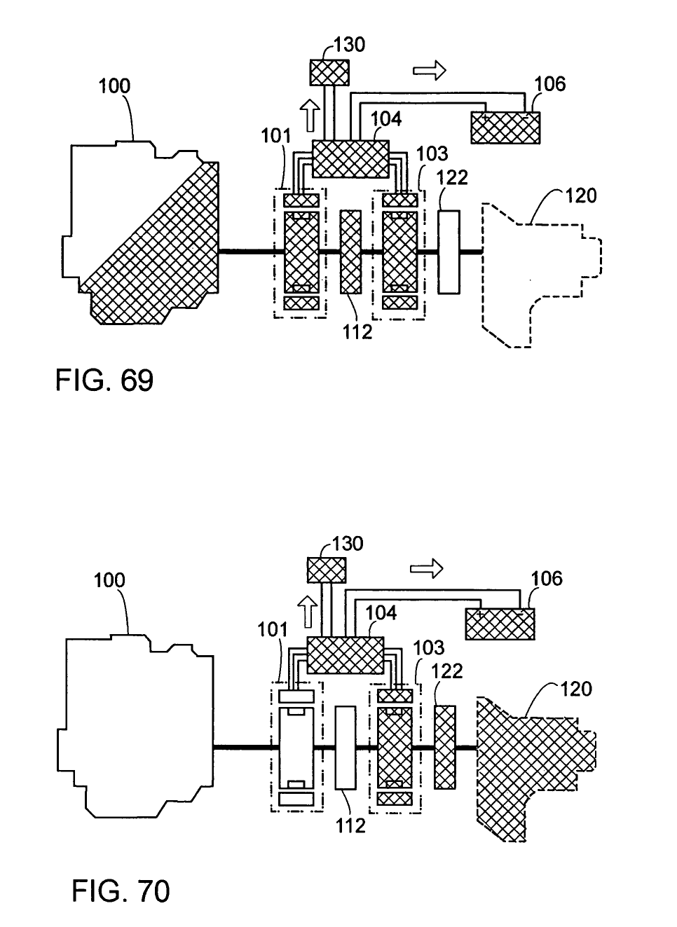

FIG. 69 shows that the preferred embodiment of the system illustrated in FIG. 54 has the engine running at constant speed to drive both of the primary and the secondary dynamo-electric units to function as a generator for charging the rechargeable device or supplying power to another load. FIG. 69 shows system function 17 provided by the preferred embodiment illustrated in FIG. 54, wherein, the engine runs at a constant speed to drive both of the primary and the secondary dynamo-electric units to function as a generator for charging the rechargeable device or supplying power to another load.

FIG. 70 shows that the preferred embodiment of the system illustrated in FIG. 54 has the load to draw the secondary dynamo-electric unit to regenerate by reclaiming the kinetics so to chare the rechargeable device or to supply power to another load. FIG. 70 shows system function 19 provided by the preferred embodiment illustrated in FIG. 54, wherein, the system has the load to exercise the braking operation to draw the secondary dynamo-electric unit to function as a generator for charging the rechargeable device or supplying power to another load.

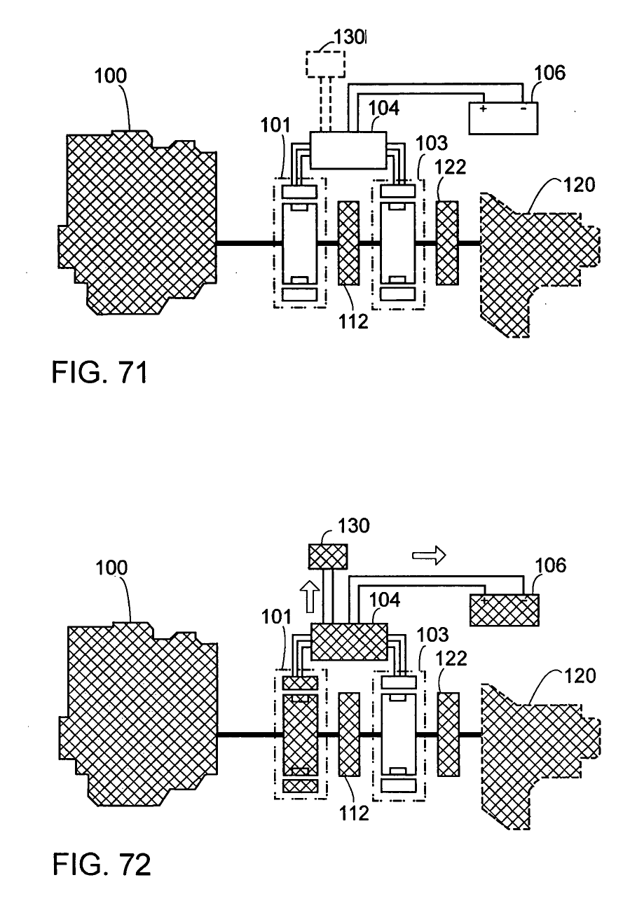

FIG. 71 shows that the preferred embodiment of the system illustrated in FIG. 54 has the mechanical damper of the engine to exercise a brake on the load. FIG. 71 show system function 21 provided by the preferred embodiment illustrated in FIG. 54, wherein, the mechanical damper from the engine exercises the braking operation on the load.

FIG. 72 shows that the preferred embodiment of the system illustrated in FIG. 54 has the mechanical damper of the engine to exercise a brake on the load and to drive the primary dynamo-electric unit to regenerate for charging the rechargeable device or supplying power to another load. FIG. 72 shows system function 22 provided by the preferred embodiment illustrated in FIG. 54, wherein, mechanical damper of the engine exercises the braking operation on the load while the primary dynamo-electric unit functions as a generator to regenerate by reclaiming the kinetics so to charge the rechargeable device or to supply power to another load.

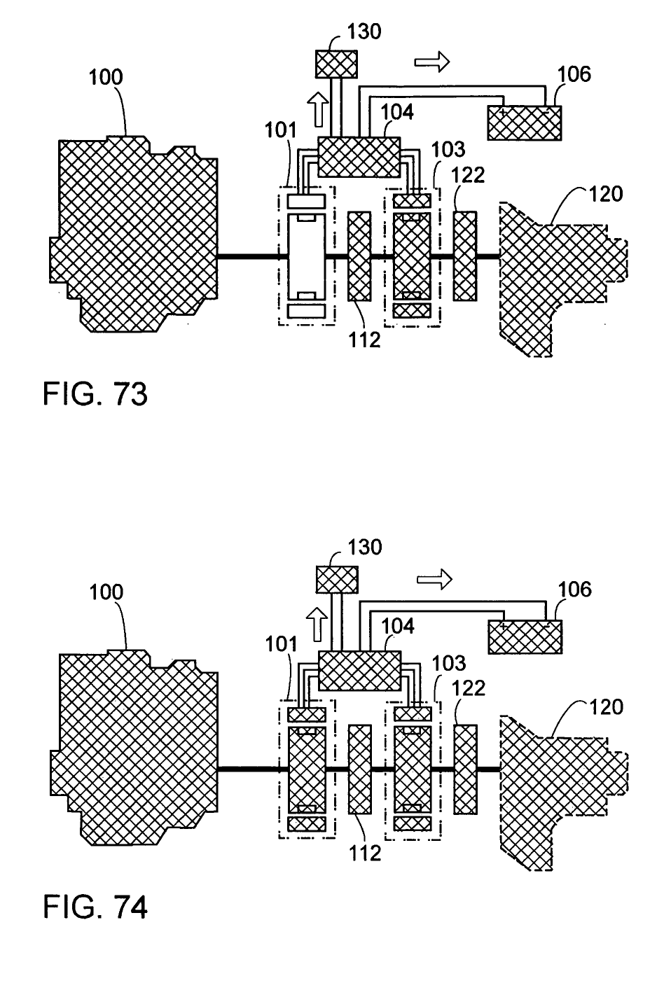

FIG. 73 shows that the preferred embodiment of the system illustrated in FIG. 54 has the mechanical damper of the engine to exercise a brake on the load and to drive the secondary dynamo-electric unit to regenerate for charging the rechargeable device or supplying power to another load. FIG. 73 shows system function 23 provided by the preferred embodiment illustrated in FIG. 54, wherein, mechanical damper of the engine exercises the braking operation on the load while the secondary dynamo-electric unit functions as a generator to regenerate by reclaiming the kinetics so to charge the rechargeable device or to supply power to another load.

FIG. 74 shows that the preferred embodiment of the system illustrated in FIG. 54 has the mechanical damper of the engine to exercise a brake on the load and to drive both of the primary and the secondary dynamo-electric units to regenerate for charging the rechargeable device or supplying power to another load. FIG. 74 shows system function 24 provided by the preferred embodiment illustrated in FIG. 54, wherein, mechanical damper of the engine exercises the braking operation on the load while both of the primary and the secondary dynamo-electric units functions as a generator to regenerate by reclaiming the kinetics so to charge the rechargeable device or to supply power to another load.

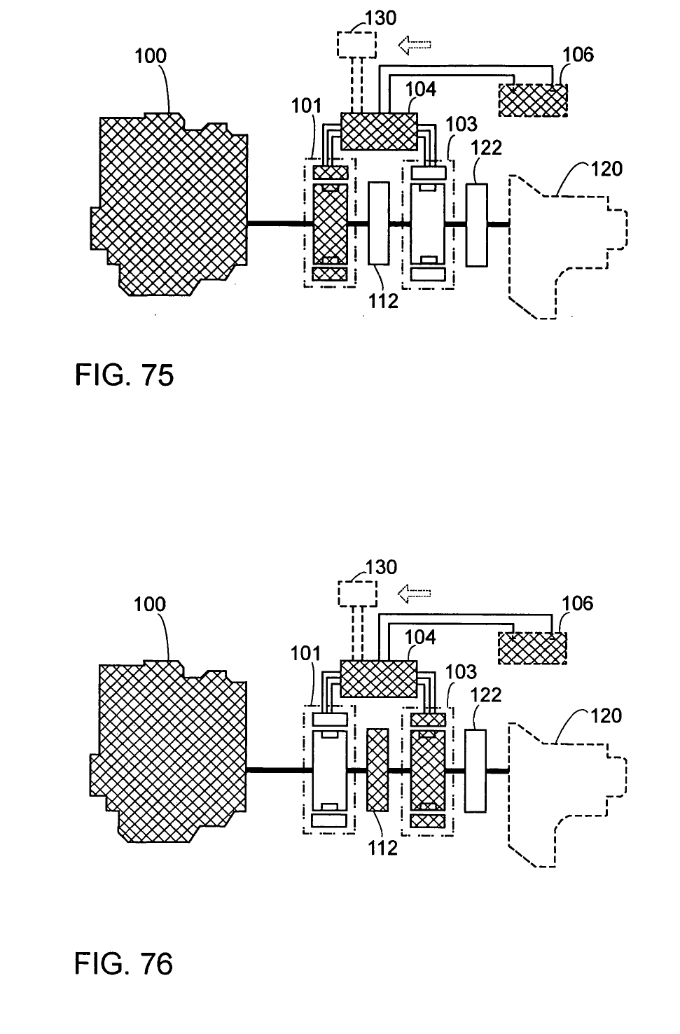

FIG. 75 shows that the preferred embodiment of the system illustrated in FIG. 54 operates on the power from the rechargeable device to drive the primary dynamo-electric unit to start the engine. FIG. 75 shows system function 25 provided by the preferred embodiment illustrated in FIG. 54, wherein, the power from the rechargeable device drives the primary dynamo-electric unit to function as a motor for starting the engine.

FIG. 76 shows that the preferred embodiment of the system illustrated in FIG. 54 operates on the power from the rechargeable device to drive the secondary dynamo-electric unit to start the engine. FIG. 76 shows system function 26 provided by the preferred embodiment illustrated in FIG. 54, wherein, the power from the rechargeable device drives the secondary dynamo-electric unit to function as a motor for starting the engine.

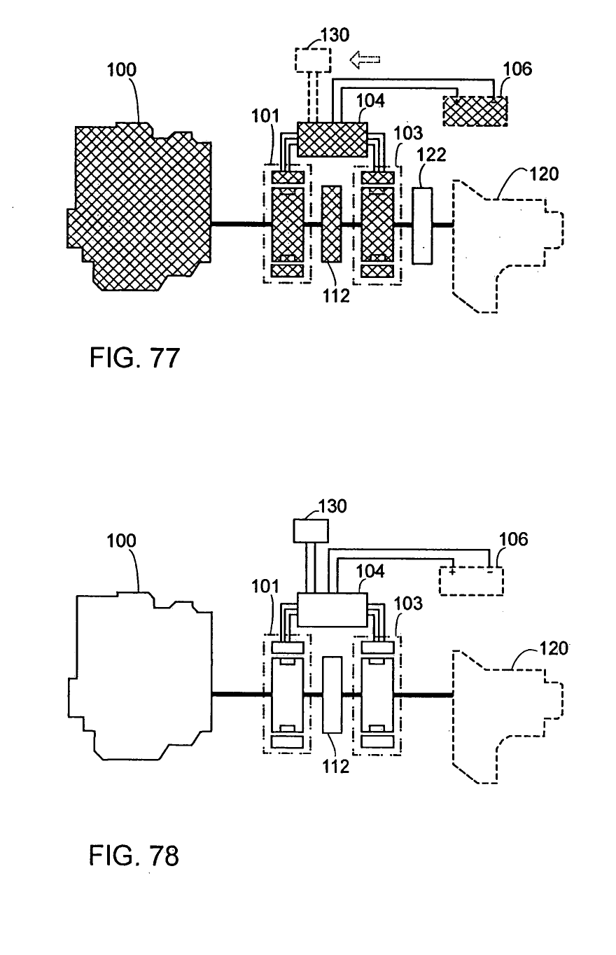

FIG. 77 shows that the preferred embodiment of the system illustrated in FIG. 54 operates on the power from the rechargeable device to drive both of the primary and the secondary dynamo-electric units to start the engine. FIG. 77 shows system function 27 provided by the preferred embodiment illustrated in FIG. 54, wherein the power from the rechargeable device drives both of the primary and the secondary dynamo-electric units to function as a motor for starting the engine.

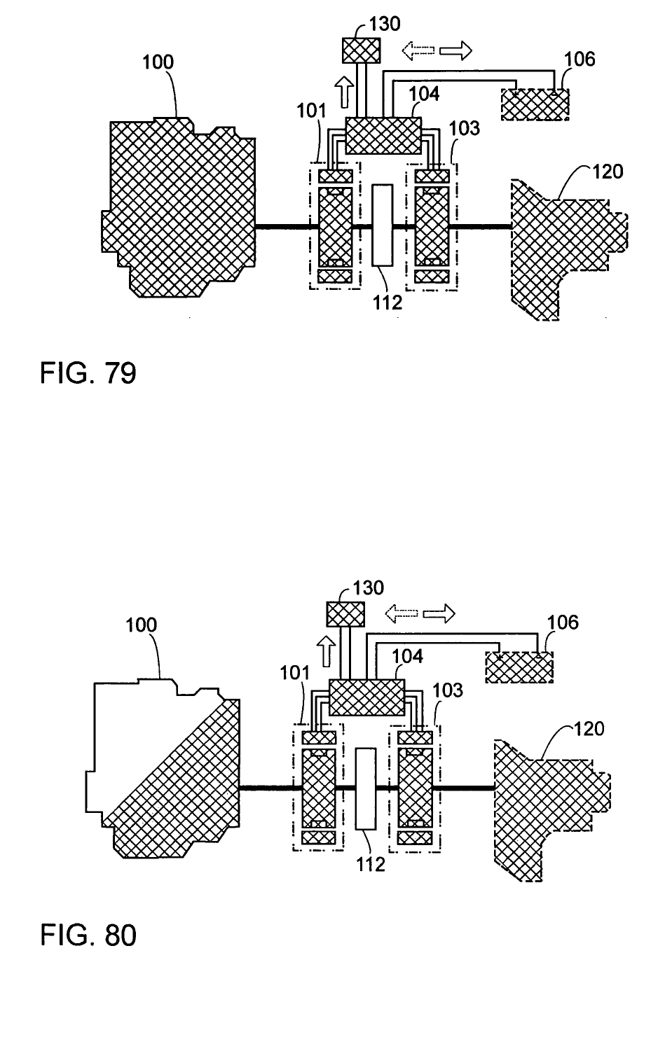

FIG. 78 is a schematic view showing that the preferred embodiment of the system illustrated in FIG. 2 is not adapted with a clutch either between the output end and the load side, or between the active rotation power source and the primary dynamo-electric unit. Wherein, there is no clutch 102 provided between the engine serving as the active rotation power source 100 and the primary dynamo-electric unit 101; nor the clutch 122 provided between the output end and the load side of the system; if the input end of the load is not adapted with a clutch, the variable transmission device does not provide idling function, then the secondary dynamo-electric unit 103 fails to provide the function as a generator for the engine driven by the active power source 100 or as a start motor to start the engine among the system functions as illustrated in FIG. 2; nor the primary dynamo-electric unit 101 to function as a motor to drive the load or regenerate by reclaiming the kinetics for exercising the brake among those functions as illustrated in FIG. 2. The system may provide all or any part of system functions 1˜11, 13, 15, 19, and 21˜25 of those functions listed in Table D. FIGS. 79˜99 show those system functions listed in Table D.

FIG. 79 shows that the preferred embodiment of the system illustrated in FIG. 78 adapted with the rechargeable device operates as the series combine power system with controllable engine speed. FIG. 79 shows system function 1 provided by the preferred embodiment illustrated in FIG. 78, wherein, the rechargeable device is adapted to the system for the system to engage in the series combined power operation for driving the load.

FIG. 80 shows that the preferred embodiment of the system illustrated in FIG. 78 adapted with the adaptation of the rechargeable device operates as the series combined power system at a constant engine speed. FIG. 80 shows system function 2 provided by the preferred embodiment illustrated in FIG. 78, wherein, the rechargeable device is adapted to the system, and the engine runs at a constant speed to drive the system to engage in the series combined power operation for driving the load.

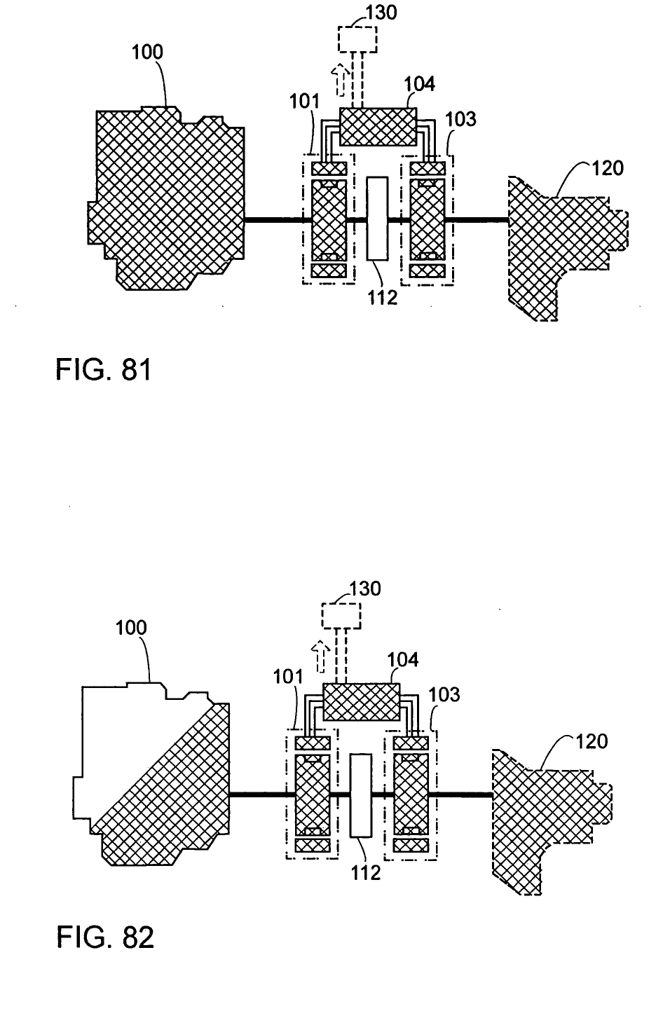

FIG. 81 shows that the preferred embodiment of the system illustrated in FIG. 78 not adapted with the adaptation of the rechargeable device operates as the series combined power system with controllable engine speed. FIG. 81 shows system function 3 provided by the preferred embodiment illustrated in FIG. 78, wherein, the system is not adapted with the rechargeable device and is engaging in the series combined power operation to drive the load.

FIG. 82 shows that the preferred embodiment of the system illustrated in FIG. 78 not adapted with the adaptation of the rechargeable device operates as the series combined power system at a constant engine speed. FIG. 82 shows system function 4 provided by the preferred embodiment illustrated in FIG. 78, wherein, the system is not adapted with the rechargeable device, and the engine runs at a constant speed to drive the system to engage in the series combined power operation for driving the load.

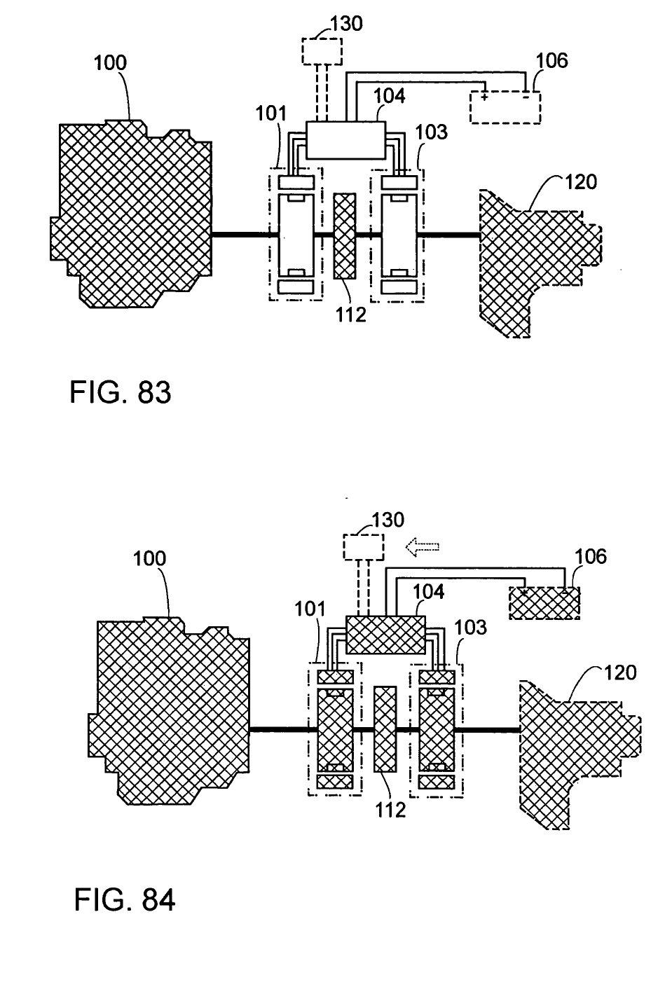

FIG. 83 shows that the preferred embodiment of the system illustrated in FIG. 78 operates on the engine power to drive the load. FIG. 83 shows system function 5 provided by the preferred embodiment illustrated in FIG. 78, wherein, the system has the power from the engine to drive the load.

FIG. 84 shows that the preferred embodiment of the system illustrated in FIG. 78 operates on the power form the engine to jointly drive the load with both of the primary and the secondary dynamo-electric units driven by the rechargeable device. FIG. 84 shows system function 6 provided by the preferred embodiment illustrated in FIG. 78, wherein, the system in case of a heavy load has the power form the engine and both of the primary and the secondary dynamo-electric units driven by the rechargeable device to function as a motor for jointly driving the load.

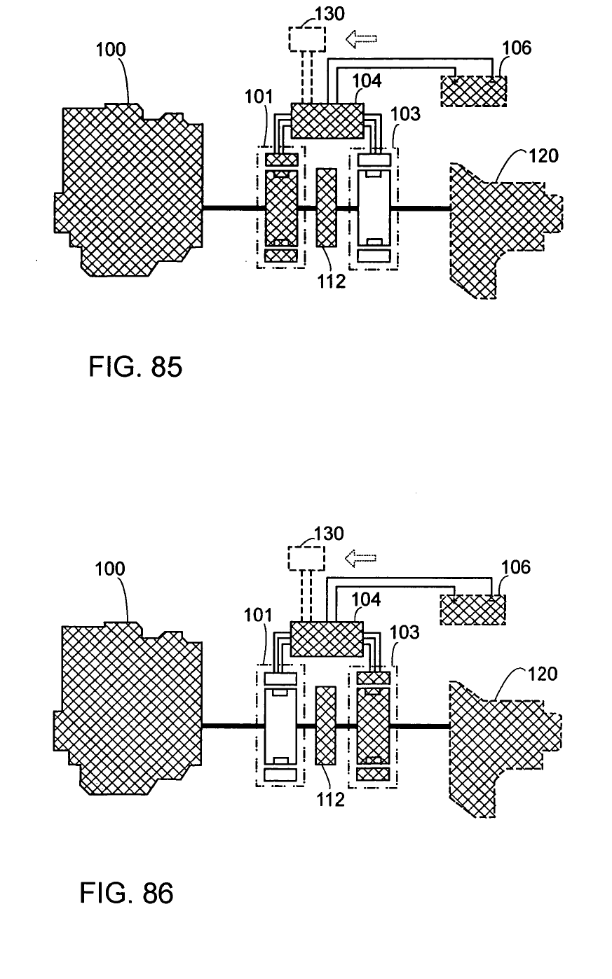

FIG. 85 shows that the preferred embodiment of the system illustrated in FIG. 78 operates on the power form the engine to jointly drive the load with the primary dynamo-electric unit driven by the rechargeable device. FIG. 85 shows system function 7 provided by the preferred embodiment illustrated in FIG. 78, wherein, the system in case of a heavy load has the power form the engine and the primary dynamo-electric unit driven by the rechargeable device to function as a motor for jointly driving the load.

FIG. 86 shows that the preferred embodiment of the system illustrated in FIG. 78 operates on the power form the engine to jointly drive the load with the secondary dynamo-electric unit driven by the rechargeable device. FIG. 86 shows system function 8 provided by the preferred embodiment illustrated in FIG. 78, wherein, the system in case of a heavy load has the power form the engine and the secondary dynamo-electric units driven by the rechargeable device to function as a motor for jointly driving the load.

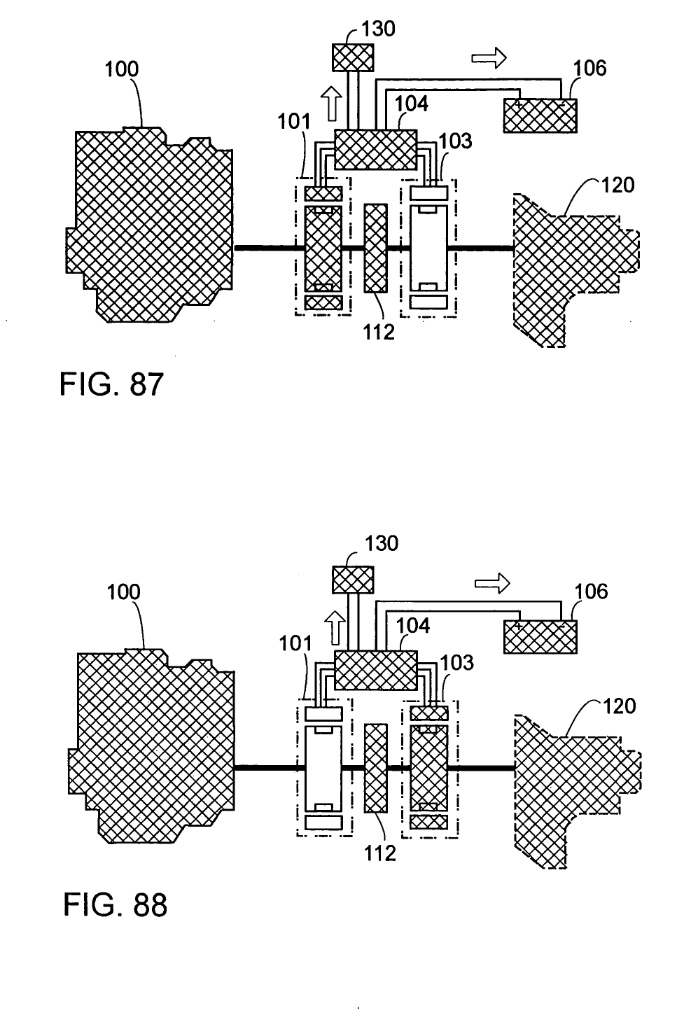

FIG. 87 shows that the preferred embodiment of the system illustrated in FIG. 78 operates on the power from the engine to drive the load, and to drive the primary dynamo-electric unit to function as a generator to charge the rechargeable device or to supply power to another load. FIG. 87 shows system function 9 provided by the preferred embodiment illustrated in FIG. 78, wherein, the power from the engine drives the load and the primary dynamo-electric unit to function as a generator for charging the rechargeable device or supplying power to another load.

FIG. 88 shows that the preferred embodiment of the system illustrated in FIG. 78 operates on the power from the engine to drive the load, and to drive the secondary dynamo-electric unit to function as a generator to charge the rechargeable device or to supply power to another load. FIG. 88 shows system function 10 provided by the preferred embodiment illustrated in FIG. 78, wherein, the power from the engine drives the load and the secondary dynamo-electric unit to function as a generator for charging the rechargeable device or supplying power to another load.

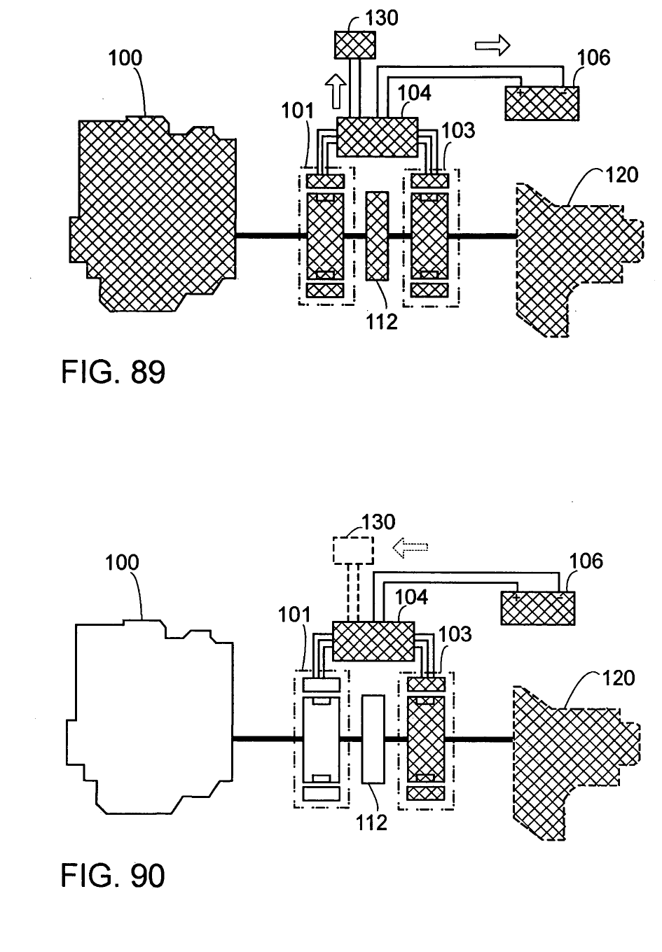

FIG. 89 shows that the preferred embodiment of the system illustrated in FIG. 78 operates on the power from the engine to drive the load, and to drive both of the primary and the secondary dynamo-electric units to function as a generator to charge the rechargeable device or to supply power to another load. FIG. 89 shows system function 11 provided by the preferred embodiment illustrated in FIG. 78, wherein, the power from the engine drives the load and both of the primary and the secondary dynamo-electric units to function as a generator for charging the rechargeable device or supplying power to another load.

FIG. 90 shows that the preferred embodiment of the system illustrated in FIG. 78 operates on the power from the rechargeable device to drive the secondary dynamo-electric unit for driving the load. FIG. 90 shows system function 13 provided by the preferred embodiment illustrated in FIG. 78, wherein, the power from the rechargeable device drives the secondary dynamo-electric unit to function as a motor for driving the load.

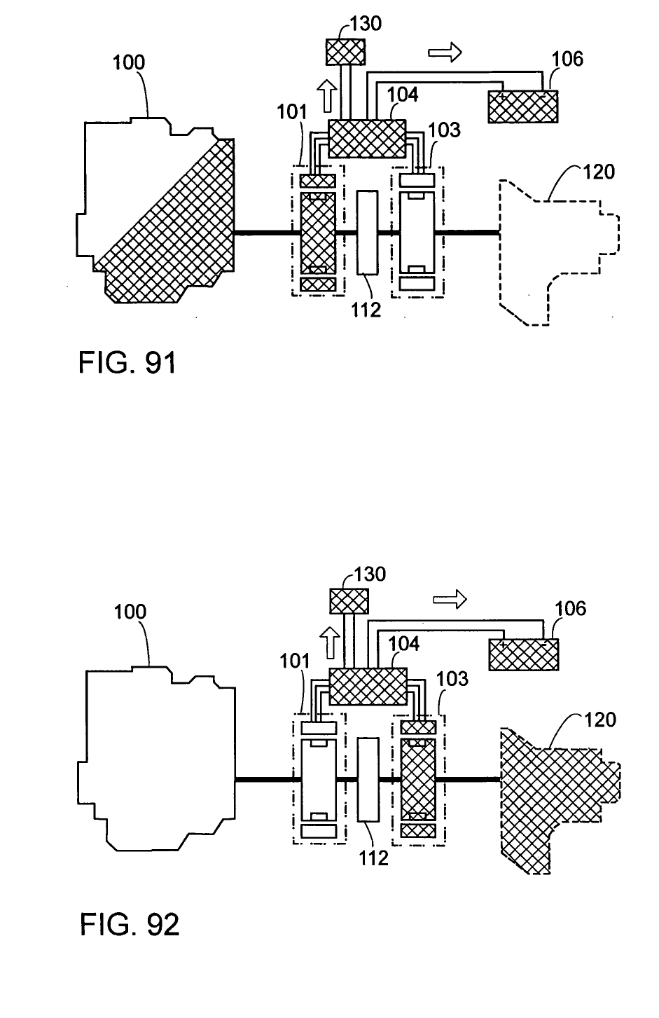

FIG. 91 shows that the preferred embodiment of the system illustrated in FIG. 78 operates on the power from the rechargeable device to drive the primary dynamo-electric unit for driving the load. FIG. 91 shows system function 15 provided by the preferred embodiment illustrated in FIG. 78, wherein, the engine runs at a constant speed to drive the primary dynamo-electric unit to function as a generator for charging the rechargeable device or supplying power to another load.

FIG. 92 shows that the preferred embodiment of the system illustrated in FIG. 78 has the load to draw the secondary dynamo-electric unit to regenerate by reclaiming the kinetics for charging the rechargeable device or supplying power to another load. FIG. 92 shows system function 19 provided by the preferred embodiment illustrated in FIG. 78, wherein, the system has the load to exercise the braking operation to draw the secondary dynamo-electric unit to function as a generator for charging the rechargeable device and supplying power to another load.

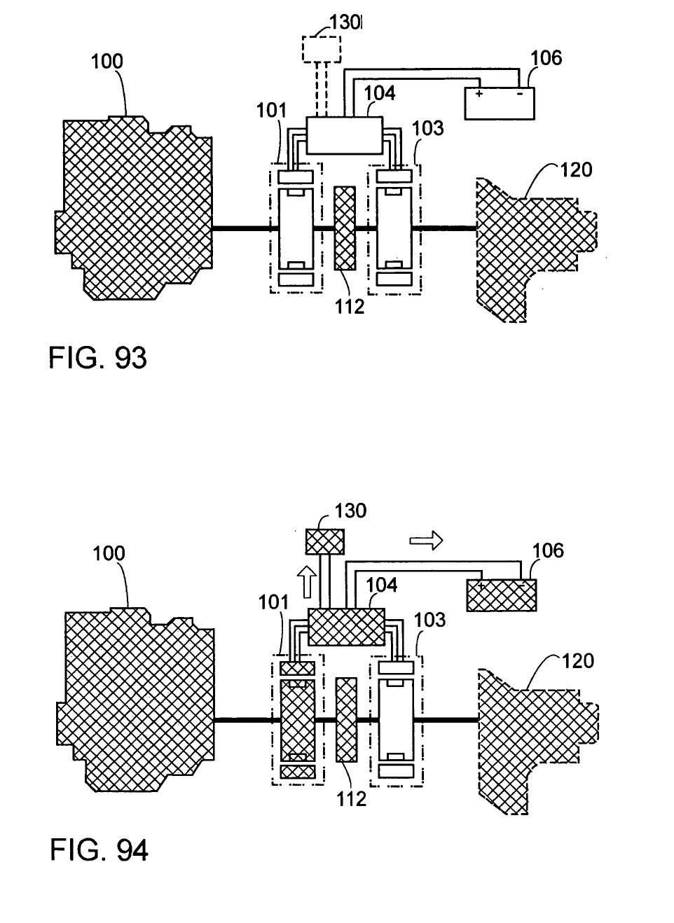

FIG. 93 shows that the preferred embodiment of the system illustrated in FIG. 78 operates on the mechanical damper of the engine to exercise a brake on the load. FIG. 93 shows system function 21 provided by the preferred embodiment illustrated in FIG. 78, wherein, the mechanical damper from the engine exercise the braking operation on the load.

FIG. 94 shows that the preferred embodiment of the system operates on the mechanical damper of the engine to exercise a brake on the load and to drive the primary dynamo-electric unit to regenerate for charging the rechargeable device or supplying power to another load. FIG. 94 shows system function 22 provided by the preferred embodiment illustrated in FIG. 78, wherein, the mechanical damper of the engine exercises the braking operation on the load, meanwhile the primary dynamo-electric unit functions as a generator to regenerate by reclaiming the kinetics so to charge the rechargeable device or to supply power to another load.

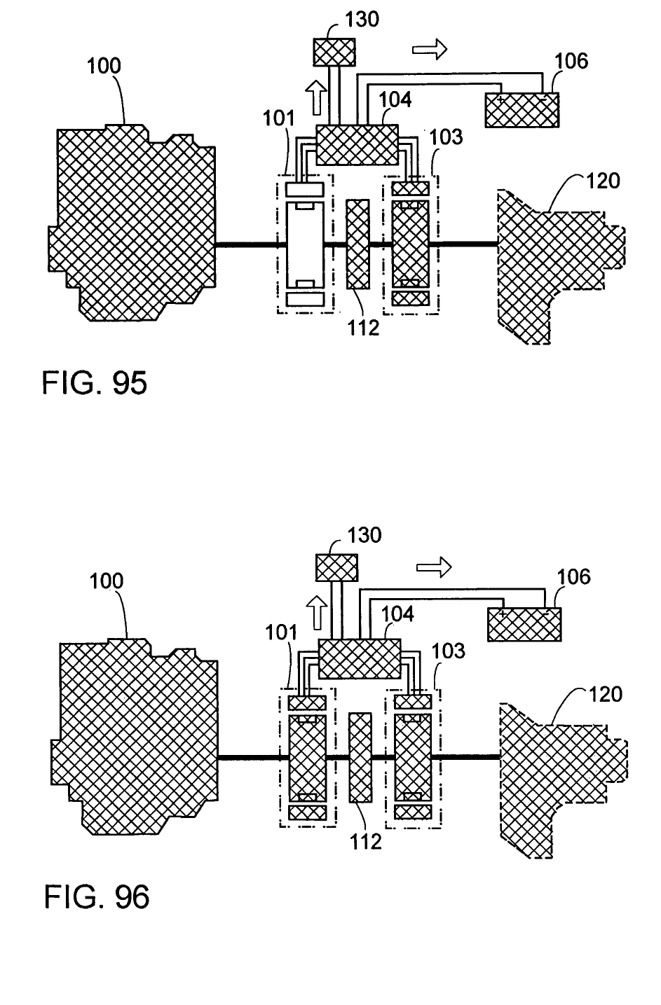

FIG. 95 shows that the preferred embodiment of the system operates on the mechanical damper of the engine to exercise a brake on the load and to drive the secondary dynamo-electric unit to regenerate for charging the rechargeable device or supplying power to another load. FIG. 95 shows system function 23 provided by the preferred embodiment illustrated in FIG. 78, wherein, the mechanical damper of the engine exercises the braking operation on the load, meanwhile the secondary dynamo-electric unit functions as a generator to regenerate by reclaiming the kinetics so to charge the rechargeable device or to supply power to another load.

FIG. 96 shows that the preferred embodiment of the system operates on the mechanical damper of the engine to exercise a brake on the load and to drive both of the primary and the secondary dynamo-electric units to regenerate for charging the rechargeable device or supplying power to another load. FIG. 96 shows system function 24 provided by the preferred embodiment illustrated in FIG. 78, wherein, the mechanical damper of the engine exercises the braking operation on the load, meanwhile both of the primary and the secondary dynamo-electric units function as a generator to regenerate by reclaiming the kinetics so to charge the rechargeable device or to supply power to another load.

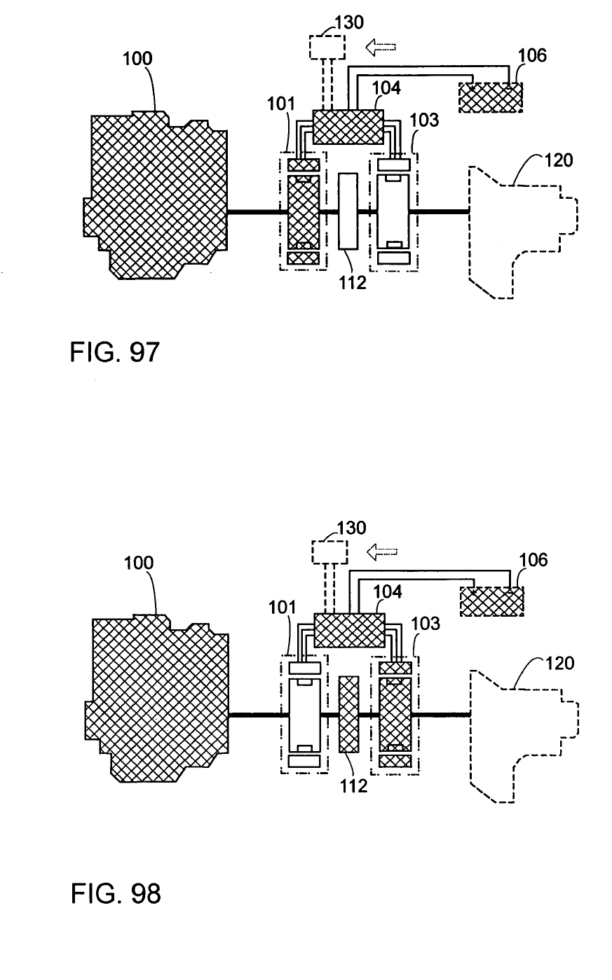

FIG. 97 shows that the preferred embodiment of the system illustrated in FIG. 78 operates on the power form the rechargeable device to drive the primary dynamo-electric unit to start the engine. FIG. 97 shows system function 25 provided by the preferred embodiment illustrated in FIG. 78, wherein, the power from the rechargeable device drives the primary dynamo-electric unit to function as a motor to start the engine.

FIG. 98 shows that the preferred embodiment of the system illustrated in FIG. 78 operates on the power form the rechargeable device to drive the secondary dynamo-electric unit to start the engine. FIG. 98 shows system function 26 provided by the preferred embodiment illustrated in FIG. 78, wherein, the power from the rechargeable device drives the secondary dynamo-electric unit to function as a motor to start the engine.

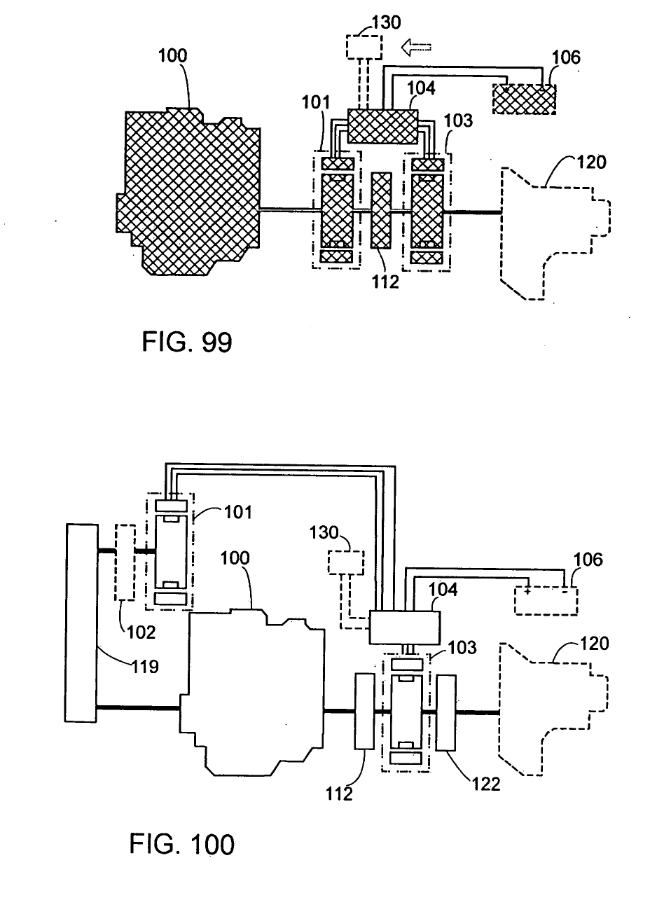

FIG. 99 shows that the preferred embodiment of the system illustrated in FIG. 78 operates on the power form the rechargeable device to drive both of the primary and the secondary dynamo-electric units to start the engine. FIG. 97 shows system function 27 provided by the preferred embodiment illustrated in FIG. 78, wherein, the power from the rechargeable device drives both of the primary and secondary dynamo-electric units to function as a motor to start the engine.

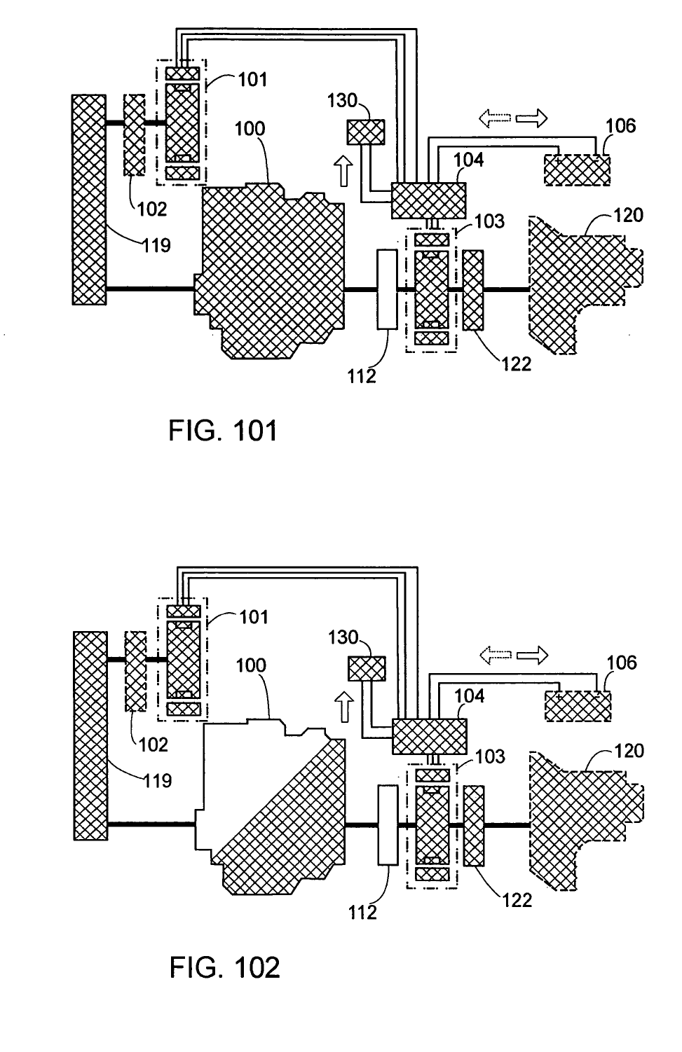

FIG. 100 is a schematic view showing that the preferred embodiment of the system illustrated in FIG. 2 has the primary dynamo-electric unit to be independently and directly driven by the active rotation power source or through a transmission device. Wherein, the system has the engine serving as the active rotation power source 100 directly driven by the primary dynamo-electric unit 101 alone or through the transmission 119 or the clutch 102; the output end of the active rotation power source 100 is directly or through a transmission unit 109 and the clutch 112 coupled to the secondary dynamo-electric unit 103; thereby, the output end of the secondary dynamo-electric unit 103 is coupled to the load 120 through the clutch 122. The primary dynamo-electric unit 101 may function as a generator and a motor as required, or only as a generator. Accordingly, the primary dynamo-electric fails to function as the motor to drive the load 120 or to function alone to regenerate by reclaiming kinetics to exercise brake on the load 120 within the configuration as illustrated in FIG. 2. Alternatively, the system may provide all or any part of those system functions 1˜11, 13, 15˜17, 19 and 21˜27 as listed in Table E. FIGS. 101˜123 show those functions listed in Table E.

FIG. 101 shows that the preferred embodiment of the system illustrated in FIG. 100 adapted with the rechargeable device functions as the series combined power system with controllable engine speed. FIG. 101 shows system function 1 provided by the preferred embodiment illustrated in FIG. 100, wherein, the system is adapted with the rechargeable device to engage in the series combined power operation to drive the load.

FIG. 102 shows that the preferred embodiment of the system illustrated in FIG. 100 adapted with the rechargeable device functions as the series combined power system at a constant engine speed. FIG. 102 shows system function 2 provided by the preferred embodiment illustrated in FIG. 100, wherein, the rechargeable device is adapted to the system and the engine runs at a constant speed to drive the system to engage in the operation of series combined power for driving the load.

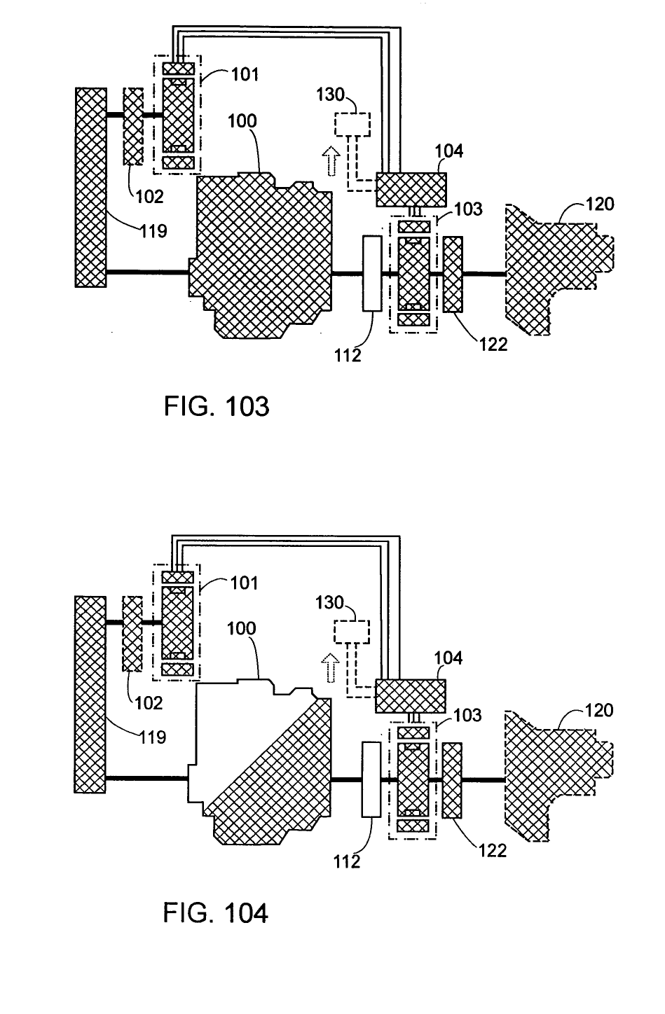

FIG. 103 shows that the preferred embodiment of the system illustrated in FIG. 100 not adapted with the rechargeable device functions as the series combined power system with controllable engine speed. FIG. 103 shows system function 3 provided by the preferred embodiment illustrated in FIG. 100, wherein, the system is not adapted with the rechargeable device and is engaged in the operation of the series combined power for driving the load.

FIG. 104 shows that the preferred embodiment of the system illustrated in FIG. 100 not adapted with the rechargeable device functions as the series combined power system at a constant engine speed. FIG. 104 shows system function 4 provided by the preferred embodiment illustrated in FIG. 100, wherein, the system is not adapted with the rechargeable device, and the engine runs at a constant speed to drive the system to engage in the operation of the series combined power for driving the load.

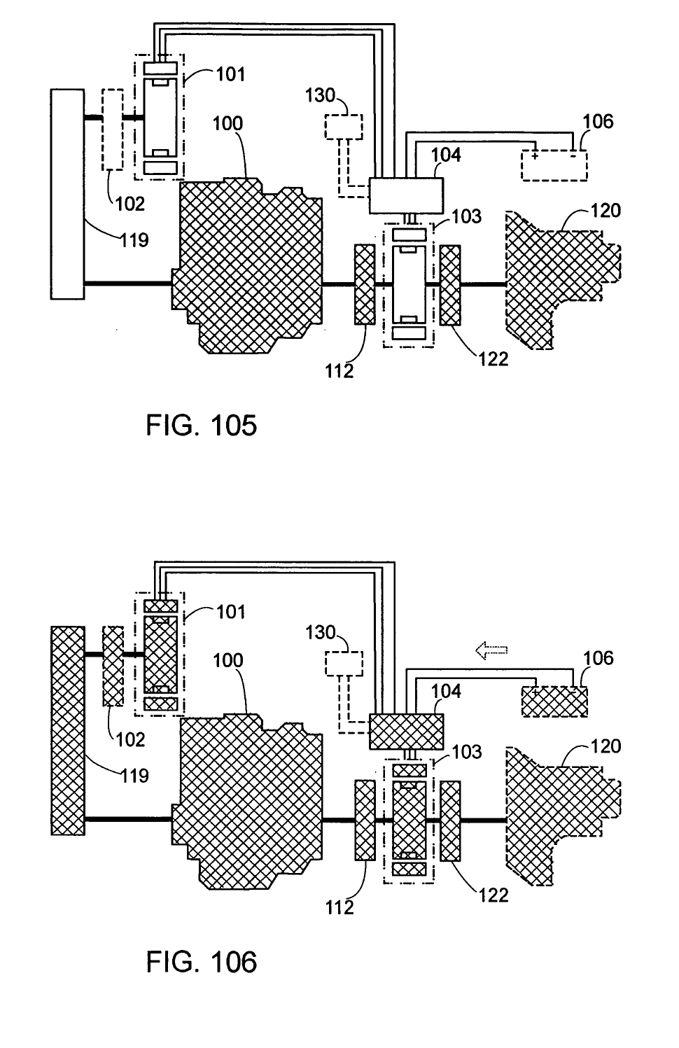

FIG. 105 shows that the preferred embodiment of the system illustrated in FIG. 100 operates on the power form the engine to drive the load. FIG. 105 shows system function 5 provided by the preferred embodiment illustrated in FIG. 100, wherein, the system has the power from the engine to drive the load.

FIG. 106 shows that the preferred embodiment of the system illustrated in FIG. 100 operates on the power from the engine to jointly drive the load with both of the primary and the secondary dynamo-electric units driven by the rechargeable device. FIG. 106 shows system function 6 provided by the preferred embodiment illustrated in FIG. 100, wherein, the system, in case of a heavy load, has the power form the engine, and the primary and the secondary dynamo-electric units driven by the rechargeable device to function as a motor to jointly drive the load.

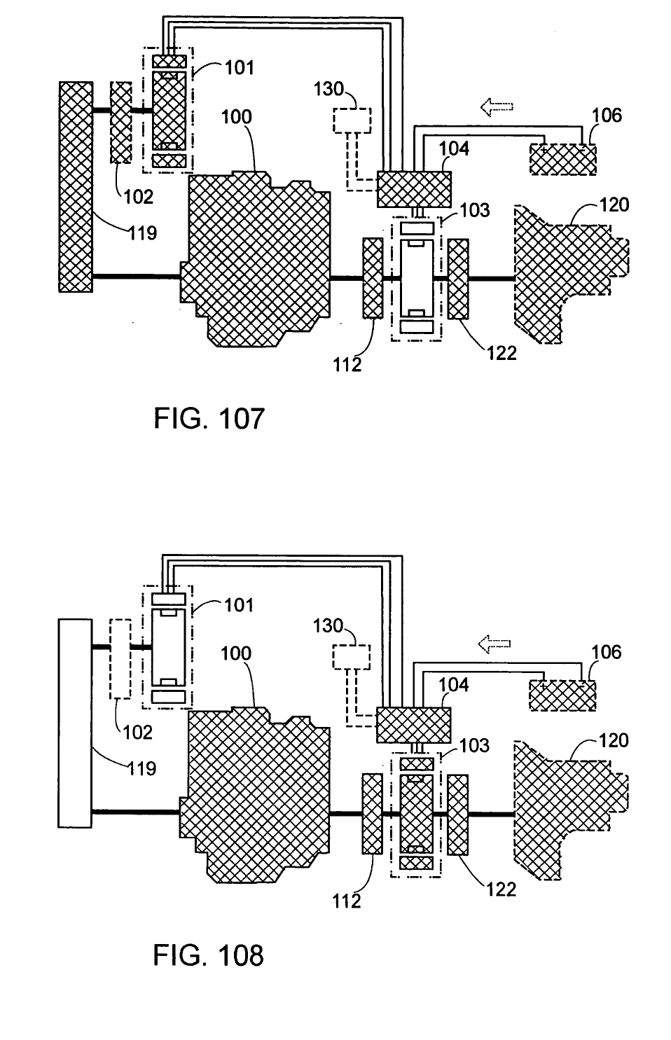

FIG. 107 shows that the preferred embodiment of the system illustrated in FIG. 100 operates on the power from the engine to jointly drive the load with the primary dynamo-electric unit driven by the rechargeable device. FIG. 107 shows system function 7 provided by the preferred embodiment illustrated in FIG. 100, wherein, the system, in case of a heavy load, has the power form the engine, and the primary dynamo-electric unit driven by the rechargeable device to function as a motor to jointly drive the load.

FIG. 108 is a schematic view showing that the preferred embodiment of the system illustrated in FIG. 100 operates on the power from the engine to jointly drive the load with the secondary dynamo-electric unit driven by the rechargeable device. FIG. 108 shows system function 8 provided by the preferred embodiment illustrated in FIG. 100, wherein, the system, in case of a heavy load, has the power form the engine, and the secondary dynamo-electric unit driven by the rechargeable device to function as a motor to jointly drive the load.

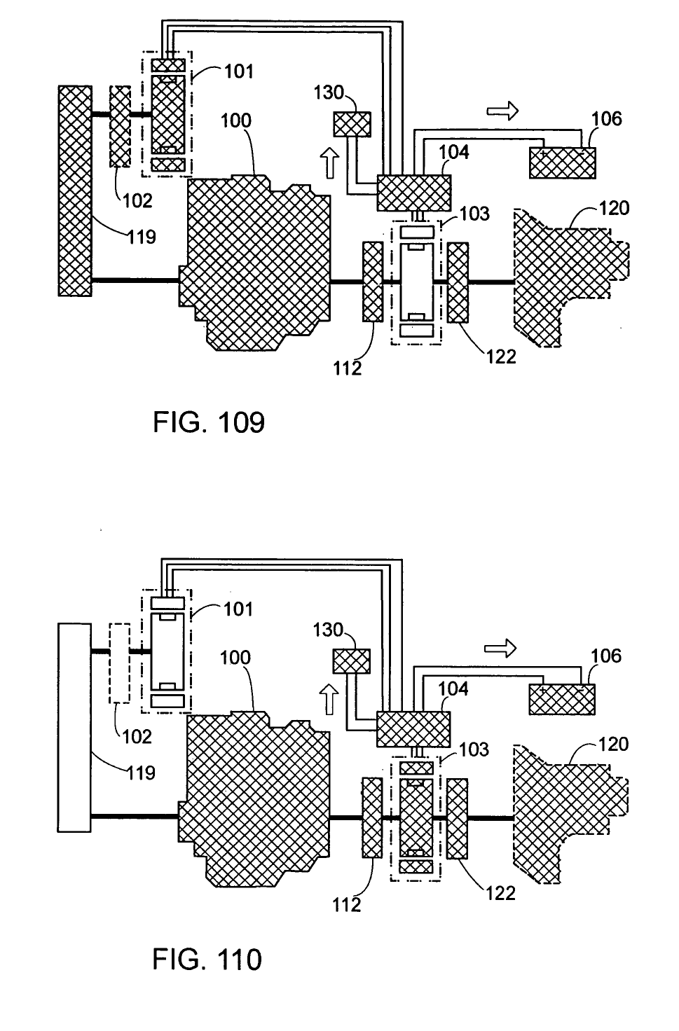

FIG. 109 shows that the preferred embodiment of the system illustrated in FIG. 100 operates on the power of the engine to drive the load, and to drive the primary dynamo-electric unit to function as a generator to charge the rechargeable device or to supply power to another load. FIG. 109 shows system function 9 provided by the preferred embodiment illustrated in FIG. 100, wherein, the power from the engine drives the load and the primary dynamo-electric unit to function as a generator for charging the rechargeable device or supplying power to another load.

FIG. 110 shows that the preferred embodiment of the system illustrated in FIG. 100 operates on the power of the engine to drive the load, and to drive the secondary dynamo-electric unit to function as a generator to charge the rechargeable device or to supply power to another load. FIG. 110 shows system function 10 provided by the preferred embodiment illustrated in FIG. 100, wherein, the power from the engine drives the load and the secondary dynamo-electric unit to function as a generator for charging the rechargeable device or supplying power to another load.

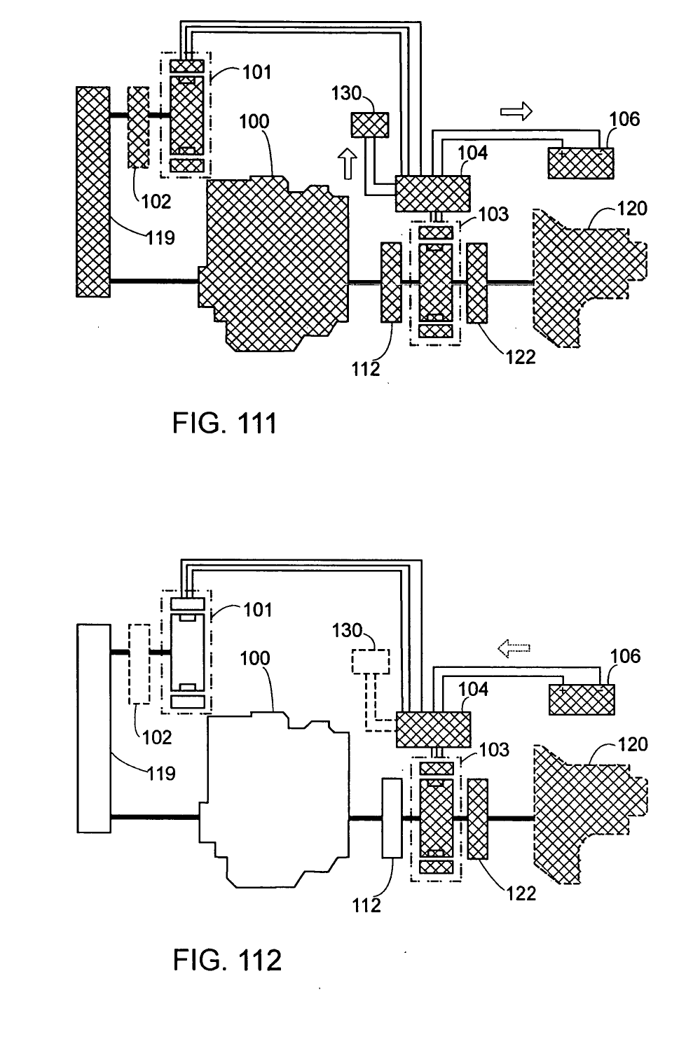

FIG. 111 is a schematic view showing that the preferred embodiment of the system illustrated in FIG. 100 operates on the power of the engine to drive the load, and to drive both of the primary and the secondary dynamo-electric units to function as a generator to charge the rechargeable device or to supply power to another load. FIG. 111 shows system function 11 provided by the preferred embodiment illustrated in FIG. 100, wherein, the power from the engine drives the load and both of the primary and the secondary dynamo-electric units to function as a generator for charging the rechargeable device or supplying power to another load.

FIG. 112 is a schematic view showing that the preferred embodiment of the system illustrated in FIG. 100 operates on the power from the rechargeable device to drive the secondary dynamo-electric unit for driving the load. FIG. 112 shows system function 13 provided by the preferred embodiment illustrated in FIG. 100, wherein, the power from the rechargeable device drives the secondary dynamo-electric unit to function as a motor for driving the load.

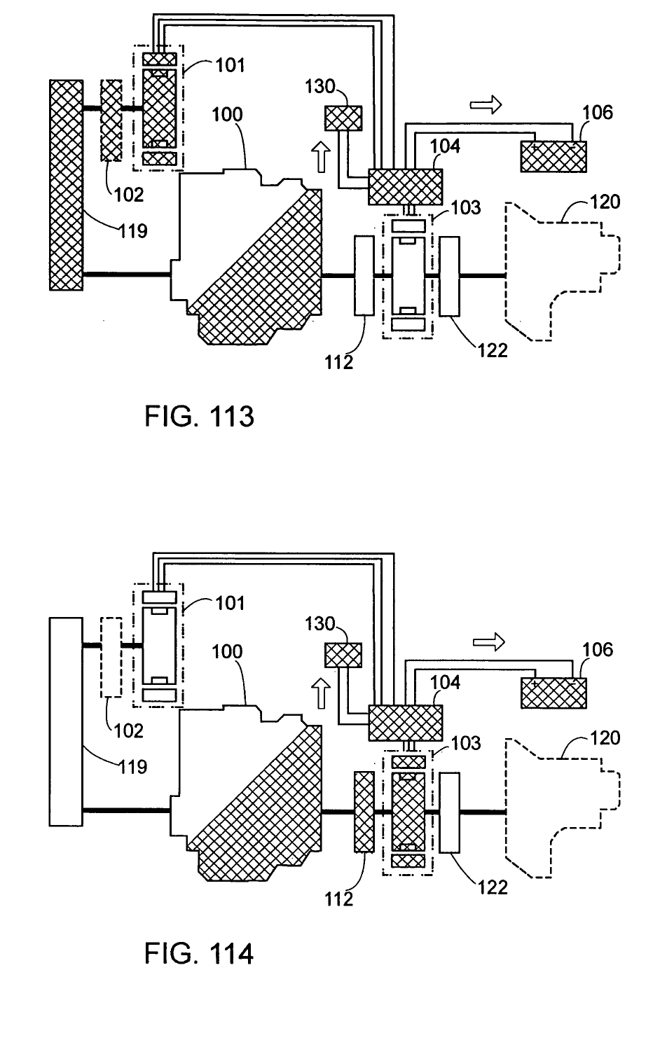

FIG. 113 shows that the preferred embodiment of the system illustrated in FIG. 100 operates with the engine running at a constant speed to drive the primary dynamo-electric unit to function as a generator to charge the rechargeable device or to supply power to another load. FIG. 113 shows system function 15 provided by the primary dynamo-electric unit to function as a generator for charging the rechargeable device or supplying power to another load.

FIG. 114 shows that the preferred embodiment of the system illustrated in FIG. 100 operates with the engine running at a constant speed to drive the secondary dynamo-electric unit to function as a generator to charge the rechargeable device or to supply power to another load. FIG. 114 shows system function 16 provided by the preferred embodiment illustrated in FIG. 100, wherein, FIG. 114 shows system function 16 provided by the preferred embodiment illustrated in FIG. 100, wherein, the engine runs at a constant speed to drive the secondary dynamo-electric unit to function as a generator for charging the rechargeable device or supplying power to another load.

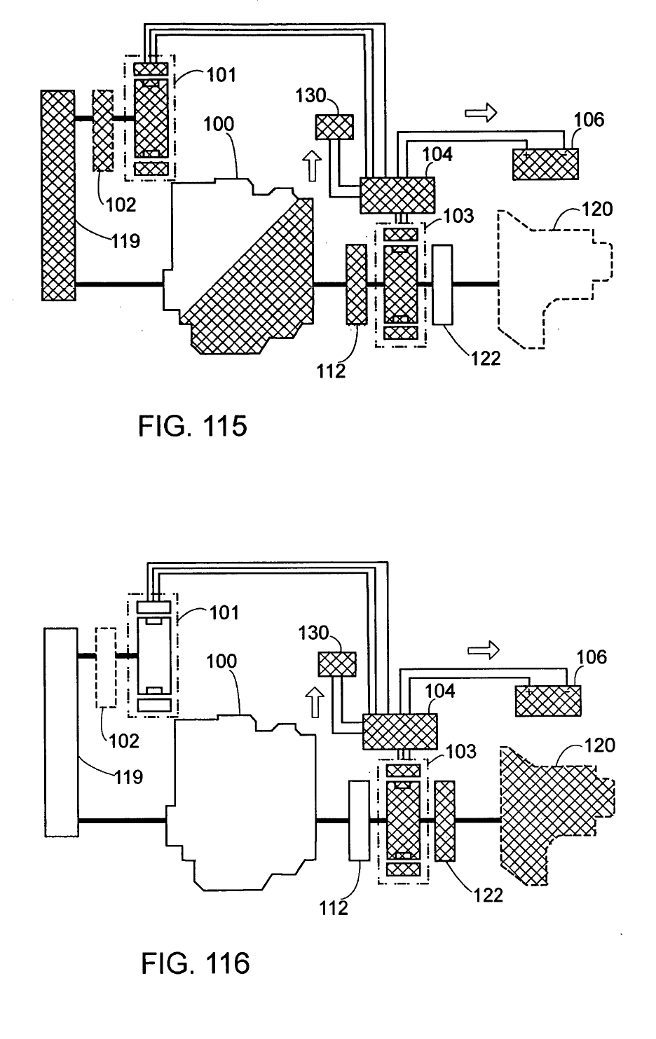

FIG. 115 shows that the preferred embodiment of the system illustrated in FIG. 100 operates with the engine running at a constant speed to drive both of the primary and the secondary dynamo-electric units to function as a generator to charge the rechargeable device or to supply power to another load. FIG. 115 shows system function 17 of the preferred embodiment illustrated in FIG. 100, wherein, the engine runs at a constant speed to drive both of the primary and the secondary dynamo-electric units to function as a generator for charging the rechargeable device or supplying power to another load.

FIG. 116 shows that the preferred embodiment of the system illustrated in FIG. 100 has the load to draw the secondary dynamo-electric unit to regenerate by reclaiming the kinetics for charging the rechargeable device or supplying power to another load. FIG. 116 shows system function 19 provided by the preferred embodiment illustrated in FIG. 100, wherein, the system has the load to exercise the braking operation to draw the secondary dynamo-electric unit to function as a generator for charging the rechargeable device or supplying power to another load.

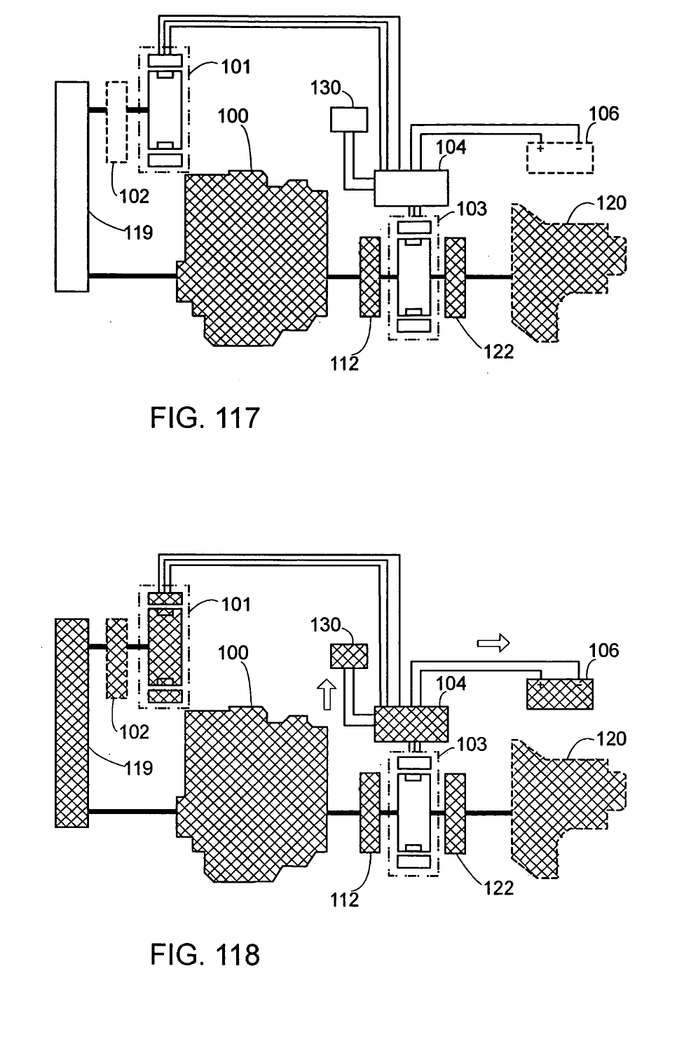

FIG. 117 shows that the preferred embodiment of the system illustrated in FIG. 100 has the mechanical damper of the engine to exercise the brake on the load. FIG. 117 shows system function 21 provided by the preferred embodiment illustrated in FIG. 100, wherein, the mechanical damper from the engine exercises the braking operation on the load.

FIG. 118 shows that the preferred embodiment of the system illustrated in FIG. 100 has the mechanical damper of the engine to exercise a brake on the load and to drive the primary dynamo-electric unit to regenerate for charging the rechargeable device or supplying power to another load. FIG. 118 shows system function 22 provided by the preferred embodiment illustrated in FIG. 100, wherein, the mechanical damper from the engine exercise the braking operation on the load, meanwhile, the primary dynamo-electric unit functions as a generator to regenerate by reclaiming kinetics for charging the rechargeable device or supplying power to another load.

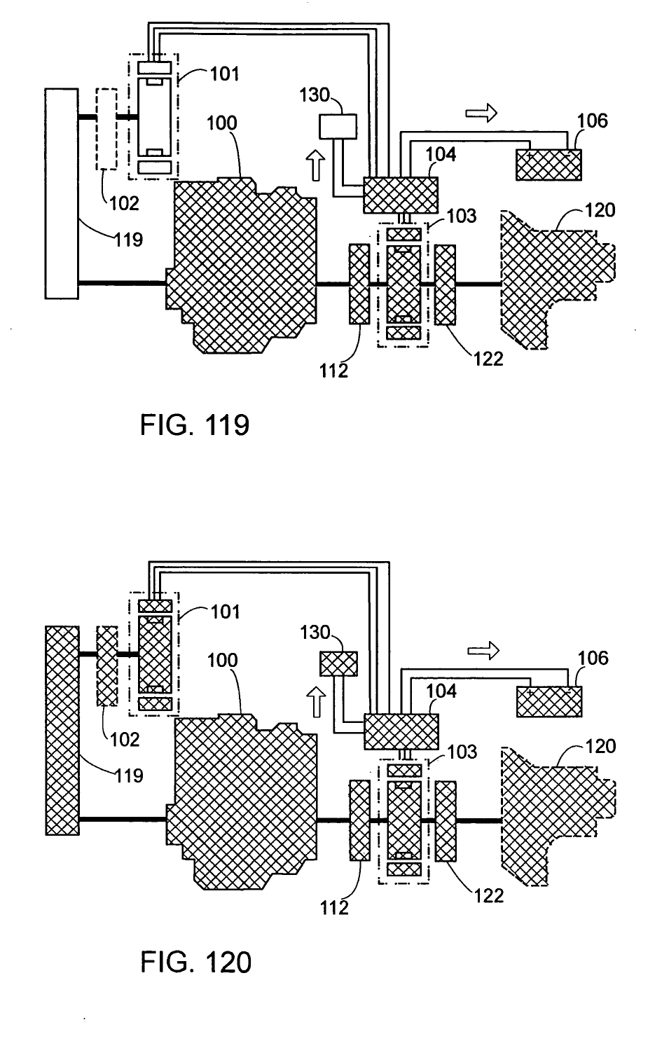

FIG. 119 shows that the preferred embodiment of the system illustrated in FIG. 100 has the mechanical damper of the engine to exercise a brake on the load and to drive the secondary dynamo-electric unit to regenerate for charging the rechargeable device or supplying power to another load. FIG. 119 shows system function 23 provided by the preferred embodiment illustrated in FIG. 100, wherein, he mechanical damper from the engine exercise the braking operation on the load, meanwhile, the secondary dynamo-electric unit functions as a generator to regenerate by reclaiming kinetics for charging the rechargeable device or supplying power to another load.

FIG. 120 is a schematic view showing that the preferred embodiment of the system illustrated in FIG. 100 has the mechanical damper of the engine to exercise a brake on the load and to drive both of the primary and the secondary dynamo-electric units to regenerate for charging the rechargeable device or supplying power to another load. FIG. 120 shows system function 24 provided by the preferred embodiment illustrated in FIG. 100, wherein, the mechanical damper from the engine exercise the braking operation on the load, meanwhile, the primary and the secondary dynamo-electric units function as a generator to regenerate by reclaiming kinetics for charging the rechargeable device or supplying power to another load.

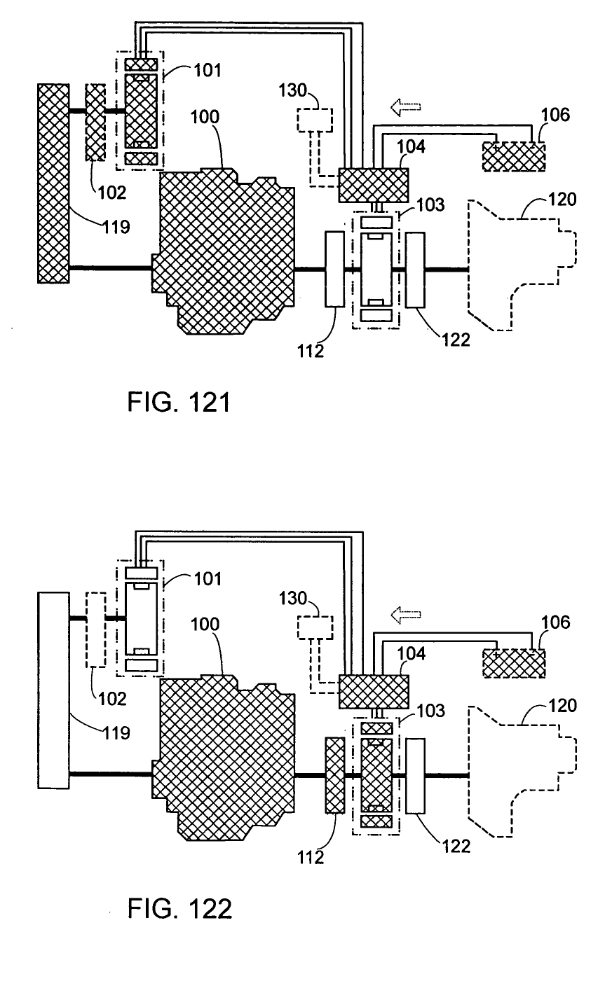

FIG. 121 is a schematic view showing that the preferred embodiment of the system illustrated in FIG. 100 operates on the power from the rechargeable device to drive the primary dynamo-electric unit to start the engine. FIG. 121 shows system function 25 provided by the preferred embodiment illustrated in FIG. 100, wherein, power from the rechargeable device drives the primary dynamo-electric unit to function as a motor to start the engine.

FIG. 122 is a schematic view showing that the preferred embodiment of the system illustrated in FIG. 100 operates on the power from the rechargeable device to drive the secondary dynamo-electric unit to start the engine. FIG. 122 shows system function 26 provided by the preferred embodiment illustrated in FIG. 100, wherein, power from the rechargeable device drives the secondary dynamo-electric unit to function as a motor to start the engine.

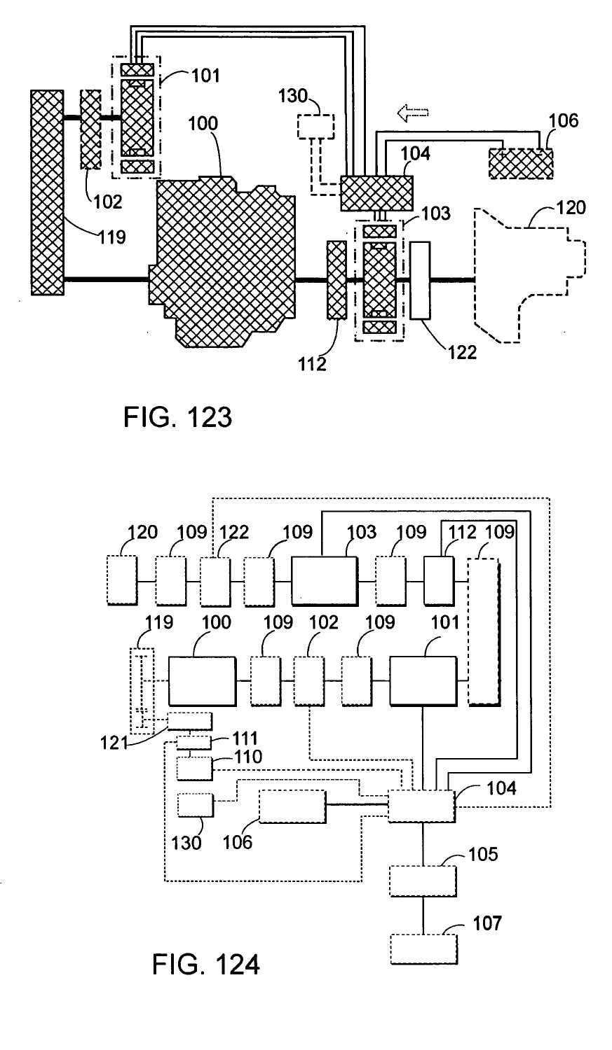

FIG. 123 is a schematic view showing that the preferred embodiment of the system illustrated in FIG. 100 operates on the power from the rechargeable device to drive both of the primary and the secondary dynamo-electric units to start the engine. FIG. 123 shows system function 27 provided by the preferred embodiment illustrated in FIG. 100, wherein, power from the rechargeable device drives both of the primary and the secondary dynamo-electric units to function as a motor to start the engine.

FIG. 124 is a block chart showing that the preferred embodiment of the system illustrated in FIG. 1 has different layouts of spatial configuration among the constituent units without changing the mechanism of the system. Wherein, the shaft of the engine and that of the secondary dynamo-electric unit are arranged in parallel. The structure illustrated is just for reference purpose while based on the mechanical principles illustrated in FIG. 1, 30, 54, 78 or 100, the number of the secondary dynamo-electric unit 103 may be less than, greater than or equal to that of the primary dynamo-electric unit 101 coupled to the same number of the clutch or the variable transmission unit for transmission. Wherein, those multiple secondary dynamo-electric units 103 may individually or jointly drive the load.

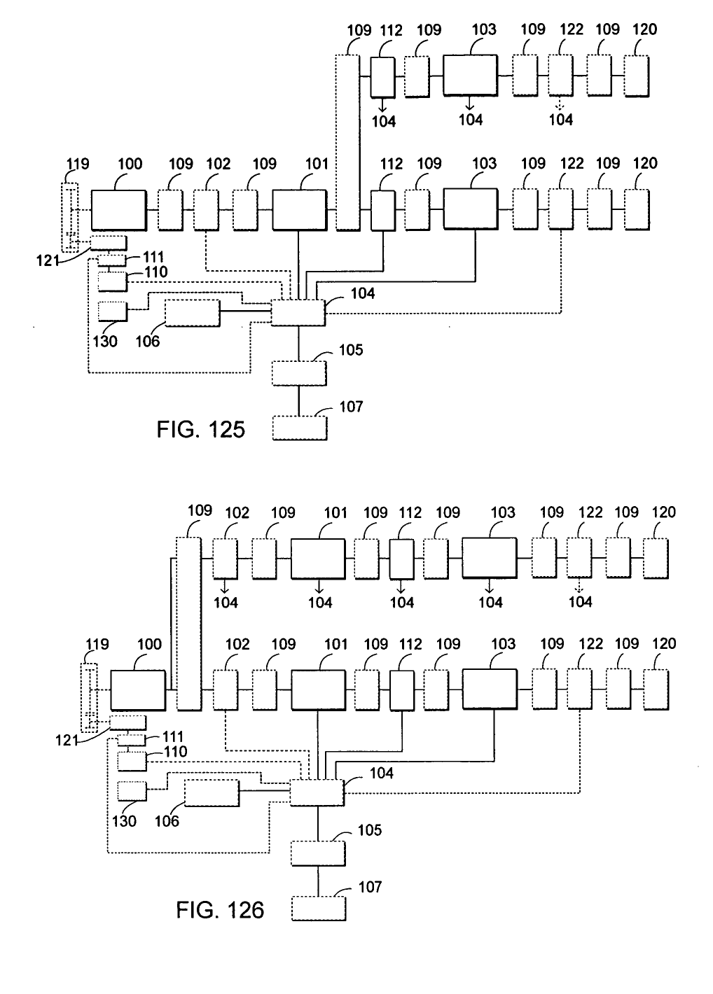

FIG. 125 is a schematic view showing that the preferred embodiment of the system illustrated in FIG. 1 engages in the distribution of power by a variable transmission unit driven by the active power source to drive in sequent two or more than two primary dynamo-electric units, clutches, and the secondary dynamo-electric units for driving the load. Wherein, the variable transmission unit 109 adapted to the output end of the active rotation power source 100 is driven by the active rotation power source 100, the individual output end of the variable transmission unit 109 is provided to respectively drive two or more than two rear end loads same as those provided by the preferred embodiment illustrated in FIG. 1 including multiple primary dynamo-electric units, clutches 112, secondary dynamo-electric units 103 and related transmission units. The variable transmission 109 for power distribution may be provided in the form of semi-automatic, or manual variable transmission device, or one with fixed speed ratio, or a differential gear set, epicyclical gear set, or other variable transmission device of the prior art.

FIG. 126 is a schematic view showing that the preferred embodiment of the system illustrated in FIG. 1 engages in the distribution of power by the variable transmission unit driven by an output end from the primary dynamo-electric unit to drive in sequent two or more than two clutches, and the secondary dynamo-electric units for respectively driving the load. Wherein, the primary dynamo-electric unit 101 drives the variable transmission unit 109 adapted to the output end of the primary dynamo-electric unit 101. The individual output end of the variable transmission unit 109 is provided to respectively drive two or more than two rear end loads same as those provided by the preferred embodiment illustrated in FIG. 1 including multiple secondary dynamo-electric units, clutches 112, secondary dynamo-electric units 103 and related transmission units. The variable transmission 109 for power distribution may be provided in the form of semi-automatic, or manual variable transmission device, or one with fixed speed ratio, or a differential gear set, epicyclical gear set, or other variable transmission device of the prior art.

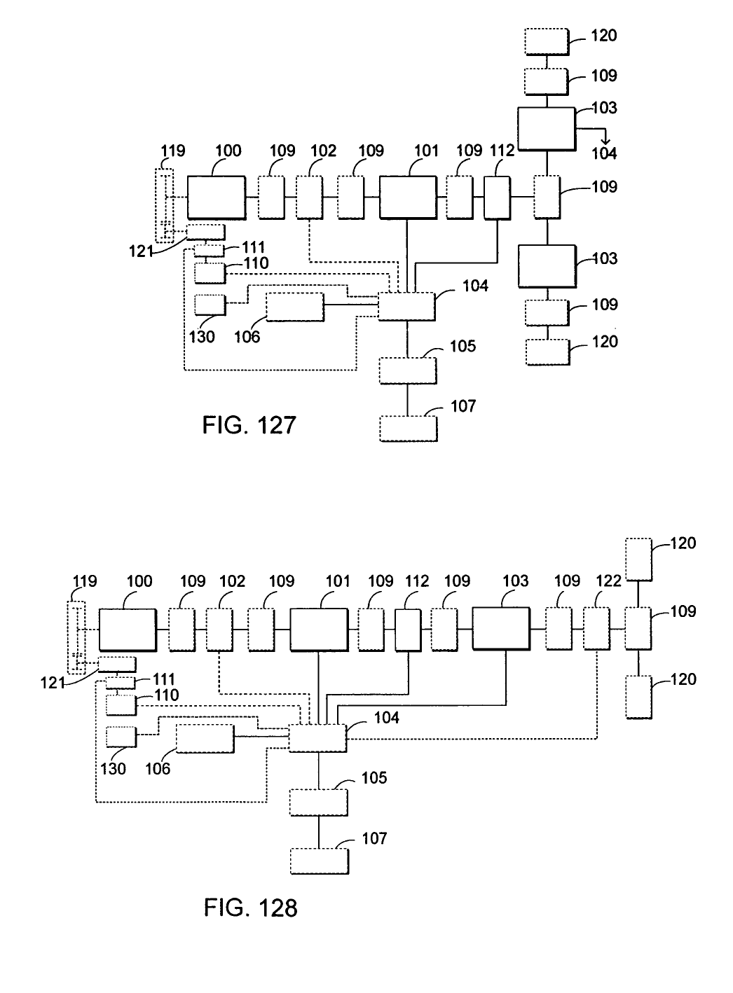

FIG. 127 is a schematic view showing that the preferred embodiment of the system illustrated in FIG. 1 has the clutch driven by the primary dynamo-electric unit to drive the variable transmission unit for power distribution so to drive two or more than two secondary dynamo-electric units. Wherein, the individual output end of the variable transmission unit 109 further driven by the clutch 112 driven by the primary dynamo-electric unit 101 is provided respectively to drive multiple rear end loads same as those provided by the preferred embodiment illustrated in FIG. 1 including multiple secondary dynamo-electric unit 103 and related transmission device. The variable transmission 109 for power distribution may be provided in the form of semi-automatic, or manual variable transmission device, or one with fixed speed ratio, or a differential gear set, epicyclical gear set, or other variable transmission device of the prior art.

FIG. 128 is a schematic view showing that the preferred embodiment of the system illustrated in FIG. 1 has the variable unit at the output end of the system driven by the secondary dynamo-electric unit to engage in power distribution for driving two or more than two units of load. Wherein, the individual output end of the system driven by the secondary dynamo-electric unit 103 is provided respectively to drive multiple rear end loads same as those provided by the preferred embodiment illustrated in FIG. 1 including multiple loads and related transmission device. The variable transmission 109 for power distribution may be provided in the form of semi-automatic, or manual variable transmission device, or one with fixed speed ratio, or a differential gear set, epicyclical gear set, or other variable transmission device of the prior art.

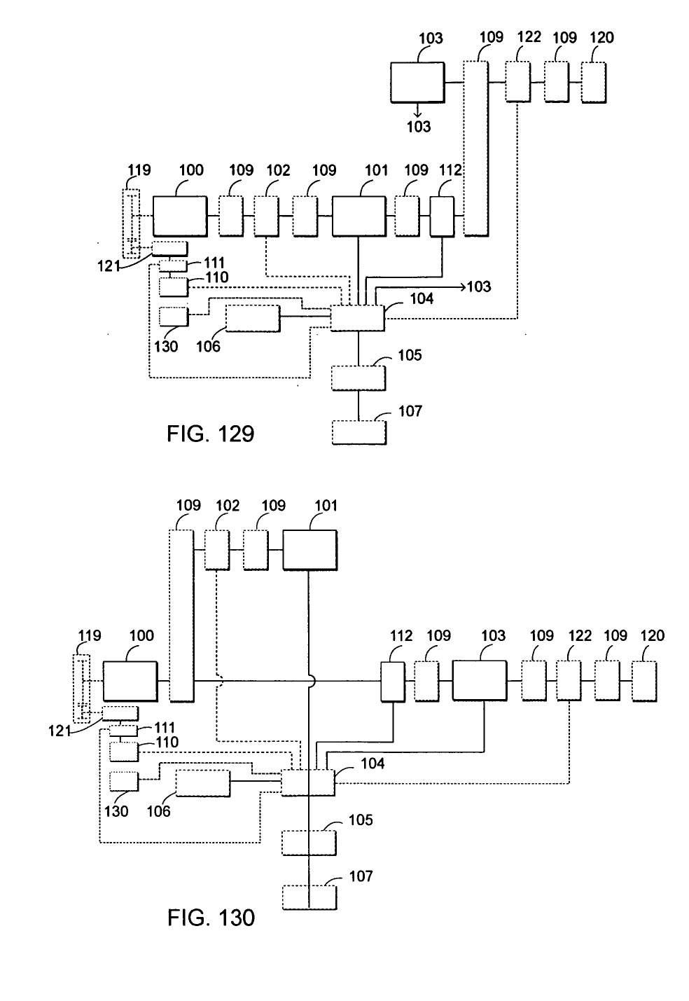

FIG. 129 is a schematic view showing that the preferred embodiment of the system illustrated in FIG. 1 has the individual output end of the variable transmission unit further driven by the clutch driven by the primary dynamo-electric unit to be respectively coupled to the rotary part of the secondary dynamo-electric unit and to the load end. Wherein, the output end of the clutch 112 driven by the primary dynamo-electric unit 101, the output end and the load end of the secondary dynamo-electric unit 103 are incorporated together by the variable transmission unit 109. The variable transmission 109 for power distribution may be provided in the form of semi-automatic, or manual variable transmission device, or one with fixed speed ratio, or a differential gear set, epicyclical gear set, or other variable transmission device of the prior art.

FIG. 130 is a schematic view showing that the preferred embodiment of the system illustrated in FIG. 1 has the output from the active rotation power source to be respectively coupled to the primary dynamo-electric unit through the variable transmission unit driven by the active rotation power source, and coupled to the secondary dynamo-electric unit through the clutch. Wherein, the rotation kinetics outputted by the active rotation power source 100 is directly or through the clutch 102 coupled to the primary dynamo-electric unit 101, and to the secondary dynamo-electric unit 103 through the clutch 112. The variable transmission 109 for power distribution may be provided in the form of semi-automatic, or manual variable transmission device, or one with fixed speed ratio, or a differential gear set, epicyclical gear set, or other variable transmission device of the prior art.

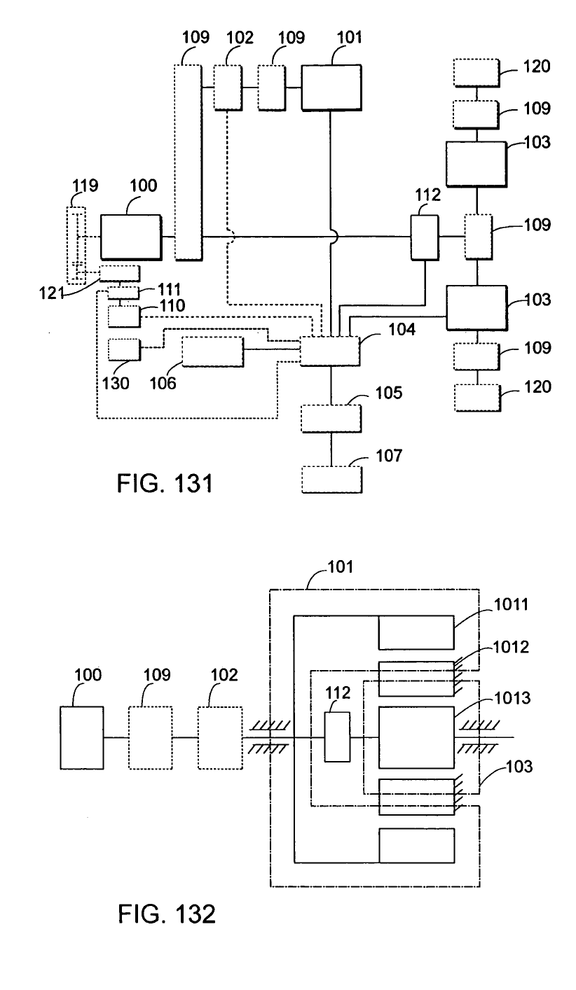

FIG. 131 is a schematic view showing that the preferred embodiment of the system illustrated in FIG. 1 has the output from the active rotation power source respectively coupled through the variable transmission unit driven by the active rotation power source to the primary dynamo-electric unit, and through the clutch to the individual output end of the variable transmission unit driven by the clutch for respectively driving two or more than two units of the secondary dynamo-electric units and loads. Wherein, the rotation kinetics outputted by the active rotation power source 100 may be directly coupled from the variable transmission unit 109 or through the clutch 102 to the primary dynamo-electric unit 101 and coupled to the variable transmission unit 109 through the clutch 112, together with the individual output end of the variable transmission unit 109 coupled through the clutch 112 to respectively drive multiple secondary dynamo-electric units 103 and loads. The variable transmission 109 for power distribution may be provided in the form of semi-automatic, or manual variable transmission device, or one with fixed speed ratio, or a differential gear set, epicyclical gear set, or other variable transmission device of the prior art.

FIG. 132 is a schematic view of another preferred embodiment yet of the system of the present invention that both the primary and the secondary dynamo-electric units share the same structure. Wherein, both of the primary and the secondary dynamo-electric units 101, 103 may be further comprised of a coaxial structure including three layers, respectively an outer circle dynamo-electric structure 1011, a middle circle dynamo-electric structure 1012 and an inner circle dynamo-electric structure 1013. The outer circle dynamo-electric structure 1011 and the interlocked part between the outer circle dynamo-electric structure 1011 and the middle circle dynamo-electric structure 1012 define where provides the function of the primary dynamo-electric unit 101; the inner circle dynamo-electric structure 1013 and the interlocked part between the middle and the inner dynamo-electric structures 1012, 1013 define where provides the function of the secondary dynamo-electric unit 103; the middle circle dynamo-electric structure 1012 does not rotate since its shares the same structure with the other two circle dynamo-electric structures 1011, 1013 and is fixed to the casing of the system. The outer circle dynamo-electric structure 1011 is directly coupled to the active rotation power source 100, or alternatively, the clutch 102 or the variable transmission unit 109 is provided. The clutch 112 is provided between the outer and the inner circle dynamo-electric structures 1011, 1013; and the inner dynamo-electric structure 1013 is coupled to the load driven.

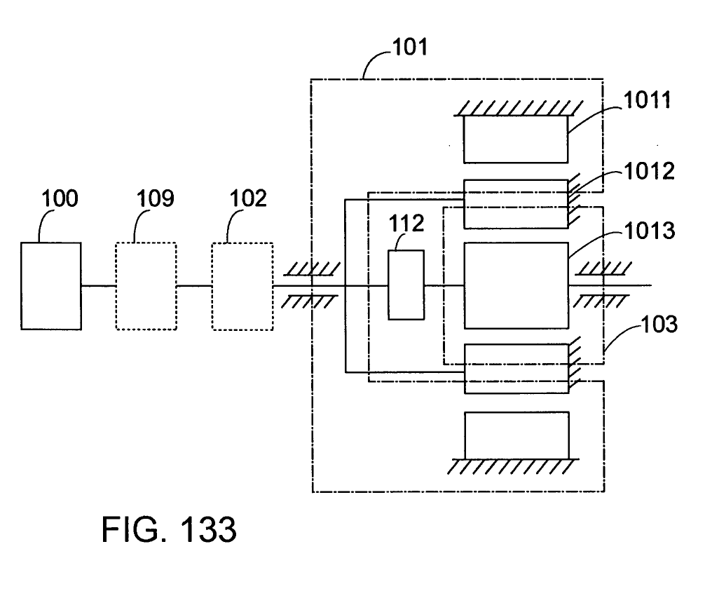

FIG. 133 is another schematic view showing that another preferred embodiment yet of the system of the present invention that both the primary and the secondary dynamo-electric units share the same structure. Wherein, both of the primary and the secondary dynamo-electric units 101, 103 may be further comprised of a coaxial structure including three layers, respectively an outer circle dynamo-electric structure 1011, a middle circle dynamo-electric structure 1012 and an inner circle dynamo-electric structure 1013. The outer circle dynamo-electric structure 1011 and the interlocked part between the outer circle dynamo-electric structure 1011 and the middle circle dynamo-electric structure 1012 define where provides the function of the primary dynamo-electric unit 101; the inner circle dynamo-electric structure 1013 and the interlocked part between the middle and the inner dynamo-electric structures 1012, 1013 define where provides the function of the secondary dynamo-electric unit 103; the outer circle dynamo-electric structure 1011 does not rotate since its shares the same structure with the other two circle dynamo-electric structures 1012, 1013 and is fixed to the casing of the system. The middle circle dynamo-electric structure 1012 is directly coupled to the active rotation power source 100, or alternatively, the clutch 102 or the variable transmission unit 109 is provided. The clutch 112 is provided between the middle and the inner circle dynamo-electric structures 1012, 1013; and the inner dynamo-electric structure 1013 is coupled to the load driven.

The series and parallel combined dual power drive system of the present invention allows arrangements of various spatial configurations without changing the mechanism of the system, and will not be elaborated herein.

To sum up, the series and parallel combined dual power drive system provides the operation as the series combined power system or as the parallel combined power system. While operating as the parallel combined power system for the rotation kinetics from the engine to drive the load at high power and high efficiency, the system can be switched to operate as the series combined power system with the engine unit to drive the primary dynamo-electric unit to function as generator with the power outputted to drive the secondary dynamo-electric unit to function as a motor for driving the load. Furthermore, the optional rechargeable device may or may not be provided; if provided, the power from the rechargeable device drives either or both of the primary and the secondary dynamo-electric units for driving the load or jointly driving the load with the power from the active rotation power source; or the load inversely drives either or both of the primary and the secondary dynamo-electric units to exercise the brake by regenerated power thus to correct the flaws of lower efficiency and high pollution found with the conventional engine running at low speed. Therefore, this application for a patent is duly filed accordingly.

TABLE A

| | | System Function & Fig. No. | | | | | | |
|---|---|---|---|---|---|---|---|---|
| | Function 1 | Function 2 | Function 3 | Function 4 | Function 5 | Function 6 | Function 7 | Function 8 |
| Unit Status | (FIG. 3) | (FIG. 4) | (FIG. 5) | (FIG. 6) | (FIG. 7) | (FIG. 8) | (FIG. 9) | (FIG. 10) |
| Active Rotation | L [symbol] L | Constant | L [symbol] H | Constant | L [symbol] H | L [symbol] H | L [symbol] H | L [symbol] H |
| Power Source 100 | | | | | | | | |
| Clutch 102 | Closed | Closed | Closed | Closed | Closed | Closed | Closed | Closed |
| Primary Dynamo-Electric | As motor or | As motor or | As generator | As generator | Non-operating | As motor | As motor | Non-operating |
| Unit 101 | generator | generator | | | | | | |
| Clutch 112 | Disengaged | Disengaged | Disengaged | Disengaged | Closed | Closed | Closed | Closed |
| Secondary Dynamo-Electric | As motor or | As motor or | As motor | As motor | Non-operating | As motor | Non-operating | As motor |
| Unit 103 | generator | generator | | | | | | |
| Clutch 122 | Closed | Closed | Closed | Closed | Closed | Closed | Closed | Closed |
| Load 120 | Operating | Operating | Operating | Operating | Operating | Operating | Operating | Operating |
| Drive Control Unit 104 | Operation | Operating | Operating | Operating | Non-operating | Operating | Operating | Operating |
| Rechargeable Device 106 | Charge or | Charge or | | | Non-operating | Discharge | Discharge | Discharge |
| | Discharge | Discharge | | | | | | |
| Load 130 | At Random | At Random | At Random | At Random | Non-operating | At Random | Non-operating | At Random |

| | System Function & Fig. No. | | | | | | | |
|---|---|---|---|---|---|---|---|---|
| | Function 9 | Function 10 | Function 11 | Function 12 | Function 13 | Function 14 | Function 15 | Function 16 |
| Unit Status | (FIG. 11) | (FIG. 12) | (FIG. 13) | (FIG. 14) | (FIG. 15) | (FIG. 16) | (FIG. 17) | (FIG. 18) |
| Active Rotation | L [symbol] H | L [symbol] H | L [symbol] H | Non-operating | Non-operating | Non-operating | Constant | Constant |
| Power Source 100 | | | | or Idling | or Idling | or Idling | | |
| Clutch 102 | Closed | Closed | Closed | Disengaged | Disengaged | Disengaged | Closed | Closed |
| Primary Dynamo- | As generator | Non- | As generator | As motor | Non-operating | As motor | As generator | Non-operating |
| Electric Unit 101 | | operating | | | | | | |
| Clutch 112 | Closed | Closed | Closed | Closed | Disengaged | Closed | Disengaged | Closed |
| Secondary Dynamo- | Non- | As generator | As motor | Non-operating | As motor | As motor | Non-operating | As Generator |
| Electric unit 103 | operating | | | | | | | |
| Clutch 122 | Closed | Closed | Closed | Closed | Closed | Closed | Disengaged | Disengaged |
| Load 120 | Operating | Operating | Operating | Operating | Operating | Operating | Non-operating | Non-operating |
| Drive Control Unit | Operating | Operating | Operating | Operating | Operating | Operating | Operating | Operating |
| 104 | | | | | | | | |
| Rechargeable Device | Charge | Charge | Charge | Discharge | Discharge | Discharge | Charge | Charge |
| 106 | | | | | | | | |
| Load 130 | At Random | At Random | At Random | At Random | Non-operating | At Random | At Random | At Random |

| | System Function & Fig. No. | | | | | | | |
|---|---|---|---|---|---|---|---|---|
| | Function 17 | Function 18 | Function 19 | Function 20 | Function 21 | Function 22 | Function 23 | Function 24 |
| Unit Status | (FIG. 3) | (FIG. 4) | (FIG. 5) | (FIG. 6) | (FIG. 7) | (FIG. 8) | (FIG. 9) | (FIG. 10) |
| Active Rotation | Constant | Non-operating | Non-operating | Non-operating | Damper | Damper | Damper | Damper |
| Power Source | | or Idling | or Idling | or Idling | | | | |
| 100 | | | | | | | | |
| Clutch 102 | Closed | Disengaged | Disengaged | Disengaged | Closed | Closed | Closed | Closed |
| Primary Dynamo- | As generator | As generator | Non-operating | As generator | Non-operating | As generator | Non-operating | As generator |
| Electric Unit 101 | | | | | | | | |
| Clutch 112 | Closed | Closed | Disengaged | Closed | Closed | Closed | Closed | Closed |
| Secondary Dynamo- | As generator | Non-operating | As generator | As generator | Non-operating | Non-operating | As generator | As generator |
| Electric Unit 103 | | | | | | | | |
| Clutch 122 | Disengaged | Braking | Braking | Braking | Braking | Braking | Braking | Braking |
| Load 120 | Operating | Operating | Operating | Operating | Non-operating | Operating | Operating | Operating |
| Drive Control Unit | Operating | Operating | Operating | Operating | Non-operating | Operating | Operating | Operating |
| 104 | | | | | | | | |
| Rechargeable | Charge | Charge | Charge | Charge | Non-operating | Charge | Charge | Charge |
| Device 106 | | | | | | | | |
| Load 130 | At Random | At Random | At Random | At Random | At Random | At Random | At Random | At Random |

System Function & Fig. No.

| | Function 25 | Function 26 | Function 27 |
|---|---|---|---|
| Unit Status | (FIG. 27) | (FIG. 28) | (FIG. 29) |
| Active Rotation Power Source 100 | Start | Start | Start |
| Clutch 102 | Closed | Closed | Closed |
| Primary Dynamo-Electric Unit 101 | As motor | Non-operating | As motor |
| Clutch 112 | Disengaged | Closed | Closed |
| Secondary Dynamo-Electric Unit 103 | Non-operating | As motor | As motor |
| Clutch 122 | Disengaged | Disengaged | Disengaged |
| Load 120 | Non-operating | Non-operating | Non-operating |
| Drive Control Unit 104 | Operation | Operating | Operating |
| Rechargeable Device 106 | Charge | Charge | Charge |
| Load 130 | At Random | At Random | At Random |

TABLE B

| | System Function & Fig. No. | | | | | | | |
|---|---|---|---|---|---|---|---|---|
| | Function 1 | Function 2 | Function 3 | Function 4 | Function 5 | Function 6 | Function 7 | Function 8 |
| Unit Status | (FIG. 31) | (FIG. 32) | (FIG. 33) | (FIG. 34) | (FIG. 35) | (FIG. 36) | (FIG. 37) | (FIG. 38) |
| Active Rotation Power | L [symbol] L | Constant | L [symbol] H | Constant | L [symbol] H | L [symbol] H | L [symbol] H | L [symbol] H |
| Source 100 | | | | | | | | |
| Clutch 102 | Closed | Closed | Closed | Closed | Closed | Closed | Closed | Closed |
| Primary Dynamo-Electric | As motor or | As motor or | As generator | As generator | Non-operating | As motor | As motor | Non-operating |
| Unit 101 | generator | generator | | | | | | |
| Clutch 112 | Disengaged | Disengaged | Disengaged | Disengaged | Closed | Closed | Closed | Closed |
| Secondary Dynamo-Electric | As motor or | As motor or | As motor | As motor | Non-operating | As motor | Non-operating | As motor |
| Unit 103 | generator | generator | | | | | | |
| Load 120 | Operating | Operating | Operating | Operating | Operating | Operating | Operating | Operating |
| Drive Control Unit 104 | Operating | Operating | Operating | Operating | Non-operating | Operating | Operating | Operating |
| Rechargeable Device 106 | Charge or | Charge or | | | Non-operating | Discharge | Discharge | Discharge |
| | Discharge | Discharge | | | | | | |
| Load 130 | At Random | At Random | At Random | At Random | Non-operating | At Random | At Random | At Random |

| | System Function & Fig. No. | | | | | | | |
|---|---|---|---|---|---|---|---|---|
| | Function 9 | Function 10 | Function 11 | Function 12 | Function 13 | Function 14 | Function 15 | Function 16 |
| Unit Status | (FIG. 39) | (FIG. 40) | (FIG. 41) | (FIG. 42) | (FIG. 43) | (FIG. 44) | (FIG. 45) | (FIG. 46) |
| Active Rotation Power | L [symbol] H | L [symbol] H | L [symbol] H | Non-operating | Non-operating | Non-operating | Constant | Non-operating |
| Source 100 | | | | or Idling | or Idling | or Idling | | or Idling |
| Clutch 102 | Closed | Closed | Closed | Disengaged | Disengaged | Disengage | Closed | Disengaged |
| Primary Dynamo- | As generator | Non- | As generator | As motor | Non-operating | As motor | As generator | As generator |
| Electric Unit 101 | | operating | | | | | | |
| Clutch 112 | Closed | Closed | Closed | Closed | Disengaged | Closed | Disengaged | Disengaged |
| Secondary Dynamo- | Non- | As generator | As generator | Non-operating | As motor | As motor | Non-operating | As generator |
| Electric Unit 103 | operating | | | | | | | |
| Load 120 | Operating | Operating | Operating | Operating | Operating | Operating | Non-operating | Braking |
| Drive Control Unit | Operation | Operating | Operating | Operating | Operating | Operating | Operating | Operating |
| 104 | | | | | | | | |
| Rechargeable | Charge | Charge | Charge | Discharge | Discharge | Discharge | Charge | Charge |
| Device 106 | | | | | | | | |
| Load 130 | At Random | At Random | At Random | At Random | Non-operating | At Random | At Random | At Random |

| | System Function & Fig. No. | | | | | | |
|---|---|---|---|---|---|---|---|
| | Function 19 | Function 20 | Function 21 | Function 22 | Function 23 | Function 24 | Function 25 |
| Unit Status | (FIG. 47) | (FIG. 48) | (FIG. 49) | (FIG. 50) | (FIG. 51) | (FIG. 52) | (FIG. 53) |
| Active Rotation Power Source | Non-operating | Non-operating | Damper | Damper | Damper | Damper | Start |
| 100 | or Idling | or Idling | | | | | |
| Clutch 102 | Disengaged | Disengaged | Closed | Closed | Closed | Closed | Closed |
| Primary Dynamo-Electric Unit 101 | Non-operating | As generator | Non-operating | As generator | Non-operating | As generator | As motor |
| Clutch 112 | Disengaged | Closed | Closed | Closed | Closed | Closed | Disengaged |
| Secondary Dynamo-Electric | As generator | As generator | Non-operating | Non-operating | As generator | As generator | Non-operating |
| Unit 103 | | | | | | | |
| Load 120 | Braking | Braking | Braking | Braking | Braking | Braking | Non-operating |
| Drive Control Unit 104 | Operating | Operating | Non-operating | Operating | Operating | Operating | Operating |
| Rechargeable Device 106 | Charge | Charge | Non-operating | Charge | Charge | Charge | Discharge |
| Load 130 | At Random | At Random | At Random | At Random | Non-operating | At Random | At Random |

TABLE C

| | System Function & Fig. No. | | | | | | | |
|---|---|---|---|---|---|---|---|---|
| | Function 1 | Function 2 | Function 3 | Function 4 | Function 5 | Function 6 | Function 7 | Function 8 |
| Unit Status | (FIG. 55) | (FIG. 56) | (FIG. 57) | (FIG. 58) | (FIG. 59) | (FIG. 60) | (FIG. 61) | (FIG. 62) |
| Active Rotation Power | L [symbol] L | Constant | L [symbol] H | Constant | L [symbol] H | L [symbol] H | L [symbol] H | L [symbol] H |
| Source 100 | | | | | | | | |
| Primary Dynamo-Electric | As motor or | As motor or | As generator | As generator | Non-operating | As motor | As motor | Non-operating |
| Unit 101 | generator | generator | | | | | | |
| Clutch 112 | Disengaged | Disengaged | Disengaged | Disengaged | Closed | Closed | Closed | Closed |
| Secondary Dynamo-Electric | As motor or | As motor or | As motor | As motor | Non-operating | As motor | Non-operating | As motor |
| Unit 103 | generator | generator | | | | | | |
| Clutch 122 | Closed | Closed | Closed | Closed | Closed | Closed | Closed | Closed |
| Load 120 | Operating | Operating | Operating | Operating | Operating | Operating | Operating | Operating |
| Drive Control Unit 104 | Operating | Operating | Operating | Operating | Non-operating | Operating | Operating | Operating |
| Rechargeable Device 106 | Charge or | Charge or | | | Non-operating | Discharge | Discharge | Discharge |
| | Discharge | Discharge | | | | | | |
| Load 130 | At Random | At Random | At Random | At Random | Non-operating | At Random | At Random | At Random |

| | System Function & Fig. No. | | | | | | | |
|---|---|---|---|---|---|---|---|---|
| | Function 9 | Function 10 | Function 11 | Function 13 | Function 15 | Function 16 | Function 17 | Function 19 |
| Unit Status | (FIG. 63) | (FIG. 64) | (FIG. 65) | (FIG. 66) | (FIG. 67) | (FIG. 68) | (FIG. 69) | (FIG. 70) |
| Active Rotation Power | L [symbol] H | L [symbol] H | L [symbol] H | Non-operating | Constant | Constant | Constant | Non-operating |
| Source 100 | | | | or Idling | | | | or Idling |
| Primary Dynamo- | As generator | Non- | As generator | Non-operating | As generator | Non-operating | As generator | Non-operating |
| Electric Unit 101 | | operating | | | | | | |
| Clutch 112 | Closed | Closed | Closed | Disengaged | Disengaged | Closed | Closed | Disengaged |
| Secondary Dynamo- | Non- | As generator | As generator | As motor | Non-operating | As generator | As generator | As generator |
| Electric Unit 103 | operating | | | | | | | |
| Clutch 122 | Closed | Closed | Closed | Closed | Disengaged | Disengaged | Disengaged | Closed |
| Load 120 | Operating | Operating | Operating | Operating | Non-operating | Non-operating | Non-operating | Braking |
| Drive Control Unit | Operating | Operating | Operating | Operating | Operating | Operating | Operating | Operating |
| 104 | | | | | | | | |
| Rechargeable | Charge | Charge | Charge | Discharge | Charge | Charge | Charge | Charge |
| Device 106 | | | | | | | | |
| Load 130 | At Random | At Random | At Random | At Random | Non-operating | At Random | At Random | At Random |

| | System Function & Fig. No. | | | | | | |
|---|---|---|---|---|---|---|---|
| | Function 21 | Function 22 | Function 23 | Function 24 | Function 25 | Function 26 | Function 27 |
| Unit Status | (FIG. 71) | (FIG. 72) | (FIG. 73) | (FIG. 74) | (FIG. 75) | (FIG. 76) | (FIG. 77) |
| Active Rotation Power Source | Damper | Damper | Damper | Damper | Start | Start | Start |
| 100 | | | | | | | |
| Primary Dynamo-Electric Unit 101 | Non-operating | As generator | Non-operating | As generator | As motor | Non-operating | As motor |
| Clutch 112 | Closed | Closed | Closed | Closed | Disengaged | Closed | Closed |
| Secondary Dynamo-Electric | Non-operating | Non-operating | As generator | As generator | Non-operating | As motor | As motor |
| Unit 103 | | | | | | | |
| Clutch 122 | Closed | Closed | Closed | Closed | Disengaged | Disengaged | Disengaged |
| Load 120 | Braking | Braking | Braking | Braking | Non-operating | Non-operating | Non-operating |
| Drive Control Unit 104 | Non-operating | Operating | Operating | Operating | Operating | Operating | Operating |
| Rechargeable Device 106 | Non-operating | Charge | Charge | Charge | Discharge | Discharge | Discharge |
| Load 130 | At Random | At Random | At Random | At Random | Non-operating | At Random | At Random |

TABLE D

| | System Function & Fig. No. | | | | | | | |
|---|---|---|---|---|---|---|---|---|
| | Function 1 | Function 2 | Function 3 | Function 4 | Function 5 | Function 6 | Function 7 | Function 8 |
| Unit Status | (FIG. 79) | (FIG. 80) | (FIG. 81) | (FIG. 82) | (FIG. 83) | (FIG. 84) | (FIG. 85) | (FIG. 86) |
| Active Rotation Power | L [symbol] L | Constant | L [symbol] H | Constant | L [symbol] H | L [symbol] H | L [symbol] H | L [symbol] H |
| Source 100 | | | | | | | | |
| Primary Dynamo-Electric | As motor or | As motor or | As generator | As generator | Non-operating | As motor | As motor | Non-operating |
| Unit 101 | generator | generator | | | | | | |
| Clutch 112 | Disengaged | Disengaged | Disengaged | Disengaged | Closed | Closed | Closed | Closed |
| Secondary Dynamo-Electric | As motor or | As motor or | As motor | As motor | Non-operating | As motor | Non-operating | As motor |
| Unit 103 | generator | generator | | | | | | |
| Load 120 | Operating | Operating | Operating | Operating | Operating | Operating | Operating | Operating |
| Drive Control Unit 104 | Operating | Operating | Operating | Operating | Non-operating | Operating | Operating | Operating |
| Rechargeable Device 106 | Charge or | Charge or | | | Non-operating | Discharge | Discharge | Discharge |
| | Discharge | Discharge | | | | | | |
| Load 130 | At Random | At Random | At Random | At Random | Non-operating | At Random | At Random | At Random |

| | System Function & Fig. No. | | | | | | | |
|---|---|---|---|---|---|---|---|---|
| | Function 9 | Function 10 | Function 11 | Function 13 | Function 15 | Function 19 | Function 21 | Function 22 |
| Unit Status | (FIG. 87) | (FIG. 88) | (FIG. 89) | (FIG. 90) | (FIG. 91) | (FIG. 92) | (FIG. 93) | (FIG. 94) |
| Active Rotation Power | L [symbol] H | L [symbol] H | L [symbol] H | Non-operating | Constant | Non-operating | Damper | Damper |
| Source 100 | | | | or Idling | | or Idling | | |
| Primary Dynamo- | As generator | Non- | As generator | Non-operating | As generator | Non-operating | Non-operating | As generator |
| Electric Unit 101 | | operating | | | | | | |
| Clutch 112 | Closed | Closed | Closed | Disengaged | Disengaged | Disengaged | Closed | Closed |
| Secondary Dynamo- | Non- | As generator | As generator | As motor | Non-operating | As generator | Non-operating | Non-operating |
| Electric Unit 103 | operating | | | | | | | |
| Load 120 | Operating | Operating | Operating | Operating | Non-operating | Braking | Braking | Braking |
| Drive Control Unit | Operating | Operating | Operating | Operating | Non-operating | Operating | Non-operating | Operating |
| 104 | | | | | | | | |
| Rechargeable | Charge | Charge | Charge | Discharge | Charge | Charge | Non-operating | Charge |
| Device 106 | | | | | | | | |
| Load 130 | At Random | At Random | At Random | At Random | Non-operating | At Random | At Random | At Random |

System Function & Fig. No.

| | Function 23 | Function 24 | Function 25 | Function 26 | Function 27 |
|---|---|---|---|---|---|
| Unit Status | (FIG. 95) | (FIG. 96) | (FIG. 97) | (FIG. 98) | (FIG. 99) |
| Active Rotation Power Source 100 | Damper | Damper | Start | Start | Start |
| Primary Dynamo-Electric Unit 101 | Non-operating | As generator | As motor | Non-operating | As motor |
| Clutch 112 | Closed | Closed | Disengaged | Closed | Closed |
| Secondary Dynamo-Electric Unit 103 | As generator | As generator | Non-operating | As motor | As motor |
| Load 120 | Braking | Braking | Non-operating | Non-operating | Non-operating |
| Drive Control Unit 104 | Operating | Operating | Operating | Operating | Operating |
| Rechargeable Device 106 | Charge | Charge | Discharge | Discharge | Discharge |
| Load 130 | At Random | At Random | At Random | At Random | At Random |

TABLE E

| | System Function & Fig. No. | | | | | | | |
|---|---|---|---|---|---|---|---|---|
| | Function 1 | Function 2 | Function 3 | Function 4 | Function 5 | Function 6 | Function 7 | Function 8 |
| Unit Status | (FIG. 101) | (FIG. 102) | (FIG. 103) | (FIG. 104) | (FIG. 105) | (FIG. 106) | (FIG. 107) | (FIG. 108) |
| Active Rotation Power | L [symbol] L | Constant | L [symbol] H | Constant | L [symbol] H | L [symbol] H | L [symbol] H | L [symbol] H |
| Source 100 | | | | | | | | |
| Clutch 102 | Closed | Closed | Closed | Closed | Disengaged | Closed | Closed | Disengaged |
| Primary Dynamo-Electric | As motor or | As motor or | As generator | As generator | Non-operating | As motor | As motor | Non-operating |
| Unit 101 | generator | generator | | | | | | |
| Clutch 112 | Disengaged | Disengaged | Disengaged | Disengaged | Closed | Closed | Closed | Closed |
| Secondary Dynamo-Electric | As motor or | As motor or | As motor | As motor | Non-operating | As motor | Non-operating | As motor |
| Unit 103 | generator | generator | | | | | | |
| Clutch 122 | Closed | Closed | Closed | Closed | Closed | Closed | Closed | Closed |
| Load 120 | Operating | Operating | Operating | Operating | Operating | Operating | Operating | Operating |
| Drive Control Unit 104 | Operating | Operating | Operating | Operating | Non-operating | Operating | Operating | Operating |
| Rechargeable Device 106 | Charge or | Charge or | | | Non-operating | Discharge | Discharge | Discharge |
| | Discharge | Discharge | | | | | | |
| Load 130 | At Random | At Random | At Random | At Random | Non-operating | At Random | At Random | At Random |

| | System Function & Fig. No. | | | | | | | |
|---|---|---|---|---|---|---|---|---|
| | Function 9 | Function 10 | Function 11 | Function 13 | Function 15 | Function 17 | Function 19 | Function 21 |
| Unit Status | (FIG. 109) | (FIG. 110) | (FIG. 111) | (FIG. 112) | (FIG. 113) | (FIG. 114) | (FIG. 115) | (FIG. 116) |
| Active Rotation Power | L [symbol] H | L [symbol] H | L [symbol] H | Non-operating | Constant | Constant | Constant | Non-operating |
| Source 100 | | | | or Idling | | | | or Idling |
| Clutch 102 | Closed | Disengaged | Closed | Disengaged | Closed | Disengaged | Closed | Disengaged |
| Primary Dynamo- | As generator | Non- | As generator | Non-operating | As generator | Non-operating | As generator | Non-operating |
| Electric Unit 101 | | operating | | | | | | |
| Clutch 112 | Closed | Closed | Closed | Disengaged | Disengaged | Closed | Closed | Disengaged |
| Secondary Dynamo- | Non- | As generator | As generator | As motor | Non-operating | As generator | As generator | As generator |
| Electric Unit 103 | operating | | | | | | | |
| Clutch 122 | Closed | Closed | Closed | Closed | Disengaged | Disengaged | Disengaged | Closed |
| Load 120 | Operating | Operating | Operating | Operating | Non-operating | Non-operating | Non-operating | Braking |
| Drive Control Unit | Operating | Operating | Operating | Operating | Operating | Operating | Operating | Operating |
| 104 | | | | | | | | |
| Rechargeable | Charge | Charge | Charge | Discharge | Charge | Charge | Charge | Charge |
| Device 106 | | | | | | | | |
| Load 130 | At Random | At Random | At Random | At Random | At Random | At Random | At Random | At Random |

| | System Function & Fig. No. | | | | | | |
|---|---|---|---|---|---|---|---|
| | Function 21 | Function 22 | Function 23 | Function 24 | Function 25 | Function 26 | Function 27 |
| Unit Status | (FIG. 117) | (FIG. 118) | (FIG. 119) | (FIG. 120) | (FIG. 121) | (FIG. 122) | (FIG. 123) |
| Active Rotation Power Source 100 | Damper | Damper | Damper | Damper | Start | Start | Start |
| Clutch 102 | Disengaged | Closed | Disengaged | Closed | Closed | Disengaged | Closed |
| Primary Dynamo-Electric Unit 101 | Non-operating | As generator | Non-operating | As generator | As motor | Non-operating | As motor |
| Clutch 112 | Closed | Closed | Closed | Closed | Disengaged | Closed | Closed |
| Secondary Dynamo-Electric | Non-operating | Non-operating | As generator | As generator | Non-operating | As motor | As motor |
| Unit 103 | | | | | | | |
| Clutch 122 | Closed | Closed | Closed | Closed | Disengaged | Disengaged | Disengaged |
| Load 120 | Braking | Braking | Braking | Braking | Non-operating | Non-operating | Non-operating |
| Drive Control Unit 104 | Non-operating | Operating | Operating | Operating | Operating | Operating | Operating |
| Rechargeable Device 106 | Non-operating | Charge | Charge | Charge | Discharge | Discharge | Discharge |
| Load 130 | At Random | At Random | At Random | At Random | Non-operating | At Random | At Random |

1. A series and parallel combined dual power system operates as a series combined power system, or as a parallel combined power system; the power from an engine directly drive the load; the system engages in the operation as the series combined power system incase of a light load; the load is driven by the engine in case of a normal load; an optional rechargeable device is adapted to the system; either or both of a primary and a secondary dynamo-electric units functions as a motor on the power from the rechargeable device to jointly drive the load with the power from the engine; and functions to provide power drive in case of a light load.

2. A series and parallel combined dual power system as claimed in claim 1, wherein, the engine functions as the active rotation power source to directly drive a load, the system provides the following functions:
Operating as a series combined power system, wherein, the engine drives a primary dynamo-electric unit to function as a generator with the power generated to drive a secondary dynamo-electric unit to output mechanical rotation kinetics to drive the load and regulate the engine to operate at a constant speed yielding higher energy efficiency; the constant speed operation is defined as the range of operation speed wherein the engine is running at lower fuel consumption but paid the operation region with comparatively higher fuel saving of comparatively higher output power so to reach the brake specific fuel consumption; or when an optional rechargeable device is added to the system, the power generated by the primary dynamo-electric unit as driven by the engine charges the rechargeable device, or the power from the rechargeable device and that from the primary dynamo-electric unit jointly drive the secondary dynamo-electric unit to function as a motor to output to regulate the engine operating in a constant speed of comparatively higher energy efficiency; again, the constant speed operation is defined as the range of operation speed wherein the engine is running at lower fuel consumption but paid the operation region with comparatively higher fuel saving of comparatively higher output power so to reach the brake specific fuel consumption;
The load is driven by the rotation kinetics from the engine power;
When adapted with the optional rechargeable device, the system provides the operation of the parallel combined power system for the power from the rechargeable device to drive either or both of the primary and the secondary dynamo-electric units to function as a motor to jointly drive the load with the power from the engine, or in case of a light load, the kinetics form the engine is used to drive either or both of the primary and the secondary dynamo-electric units to function as a generator to charge the rechargeable device or supply power to another load;
The power from the rechargeable device drives either or both of the primary and the secondary dynamo-electric units to function as a motor for driving a load;
The power from the engine drives either or both of the primary and the secondary dynamo-electric units to function as a generator to charge the rechargeable device or to supply power to another load;
The load is used to inversely drive either or both of the primary and the secondary dynamo-electric units to function as a generator to charge the rechargeable device or supply power to another load;
Mechanical damper of the engine functions as the brake, or if the rechargeable device is adapted, either or both of the primary and the secondary dynamo-electric units operates at the same time as a generator to charge the rechargeable device or to supply power to another load for creating the braking function by regeneration;
The rechargeable device drives either or both of the primary and the secondary dynamo-electric units to function as a motor to start the engine; and
The system provides all or any part of those functions described above.
The system by providing all or any part of those functions described above corrects the defectives of the lower efficiency and higher pollution found with the engine when operating at low power output and low speed.

3. A series and parallel combined dual power system as claimed in claim 1 is essentially comprised of:
An active rotation power source (100): comprised of one or multiple internal combustion engines, external combustion engine or other rotation kinetics power sources of the prior art, an rotary part of the active power source (100) is directly or through either or both of an optional clutch (102) and an optional variable transmission unit (109), coupled to a primary dynamo-electric unit (101);
The primary dynamo-electric unit (101): comprised of one or multiple AC, DC, brushless, brush, synchronous or asynchronous rotation dynamo-electric device providing functions as a generator, or switched functions between those of a generator and a motor; a rotary part of the primary dynamo-electric unit (101) is coupled to a secondary dynamo-electric unit (103) through a clutch (112), or as required through the clutch (112) and the variable transmission unit (109);
Clutches (102), (112), (122): related to a single way clutch or a clutch controlled by manual, mechanical force, eccentric force, air pressure, hydraulic flow, or electromagnetic force used to transmit or interrupt the transmission of the mechanical rotation kinetics; one or multiple clutches (112) is required while one or multiple clutches (102) and clutches (122) may be provided or not; or idling shaft function provided at random by a clutch disposed to the input end of the load or by a variable transmission device is used to replace that of the clutch (122);
The secondary dynamo-electric unit (103): comprised of one or multiple AC, DC, brushless, brush, synchronous or asynchronous rotation dynamo-electric device providing functions as a generator, or switched functions between those of a generator and a motor; a rotary part of the secondary dynamo-electric unit (103) is coupled to a secondary dynamo-electric unit (103) through a clutch (112), or as required through the clutch (112) and the variable transmission unit (109);
A drive control unit (104): an optional item, comprised of electro-mechanical or solid-status circuit to control the power generated by the primary dynamo-electric unit (101) functioning as a generator when the system operates as the series combined power system so to drive the secondary dynamo-electric unit (103) and charge a rechargeable device (106), or control either of the generation output functions, or control the power from the rechargeable device (106) to drive either or both of the primary and the secondary dynamo-electric units (101), (103) functioning as a motor, the drive control unit (104) controls voltage, amperage, polarity (in case of a DC), torque and phase (in case of an AC) to manipulate revolving direction, speed, torque and abnormality protection of the dynamo-electric unit; or when either or both of the primary and the secondary dynamo-electric units are inversely driven by the load to function as a generator, the driven control unit (104) controls the charging power transmitted to the rechargeable device (106) or to another load thus to manipulate the dynamo-electric unit to function as a brake by regeneration;
A central control unit: an optional item, comprised of a solid-status, or an electro-mechanical device, or chip and related working software, subject to the control by a control interface (107) to further control functions provided by the series and parallel dual power system, particularly in achieving the optimal fuel consumption and pollution control; controls the relative functions provided among the first dynamo-electric unit (101), the secondary dynamo-electric unit (103) and the rechargeable device (106) by manipulating the drive control unit (104); and controls the monitor and interaction of the feedback among all units in the system;
The rechargeable device (106): an optional item, related to a rechargeable battery, super capacitor, or any other rechargeable device;
The control interface (107): an optional item, related to a solid-state, or electro-mechanical device, or chip and related software, subject to the manual input or input of control signal to control the operation of the series and parallel combined dual power system;
The variable transmission unit (109): comprised of a variable transmission device of fixed speed ration, or automatic, semi-automatic, or manual variable transmission device, or a differential gear set, epicyclical gear set, or other variable transmission device; is provided at where between the active rotation power source (100) and the clutch (102), or between the clutch (102) and the rotary part of the primary dynamo-electric unit (101), or between the rotary part primary dynamo-electric unit (101) and that of the clutch (112), or between the rotary part of the clutch (112) and that of the secondary dynamo-electric unit (103), or between the rotary part of the secondary dynamo-electric unit (103) and that of the clutch (122), or between the rotary part of the clutch (122) and that of the load; and
A redundant rechargeable device (110): comprised of a rechargeable battery, super capacitor, a flywheel for energy storage, or other rechargeable battery device with the power controlled by a start switch (111) to drive a start motor (121) of the engine set of the active rotation power source (100), thus to directly or through a transmission device start the engine set, or supply power to the peripheral equipment or another power driven load (130); all the redundant rechargeable device (110), the start switch (111) and the start motor (121) are optional items.
The rotation kinetics outputted from the system may be provided to drive a load of an air, land, or surface craft and other industrial equipment that is required to receive the input of the rotation mechanical kinetics.

4. A series and parallel combined dual power system as claimed in claim 3, wherein, the system provides all or part of the following functions:
When the system operates as the series combined power system, the engine is controlled to run from low speed to high speed or run at a constant speed for driving the primary dynamo-electric unit to function as a generator; if the rechargeable device (106) is not adapted, the power generated drives the secondary dynamo-electric unit (103) to function as a motor to output rotation kinetics for driving the load (120); if the system is adapted with the rechargeable device (106) and in case of a light load, the power generated from the primary dynamo-electric unit drives the secondary dynamo-electric unit (103) while charging the rechargeable device (106); or in case of a heavy load, the power generated form the primary dynamo-electric unit (101) and that from the rechargeable device (106) jointly drive the secondary dynamo-electric unit (103) to output rotation kinetics for driving the load (120) and regulate the engine to operate at a constant speed yielding higher energy efficiency; the constant speed operation is defined as the range of operation speed wherein the engine is running at lower fuel consumption but paid the operation region with comparatively higher fuel saving of comparatively higher output power so to reach the optimal brake specific fuel consumption; or when an optional rechargeable device is added to the system, the power generated by the primary dynamo-electric unit as driven by the engine charges the rechargeable device, or the power from the rechargeable device and that from the primary dynamo-electric unit jointly drive the secondary dynamo-electric unit to function as a motor to output to regulate the engine operating in a constant speed of comparatively higher energy efficiency; again, the constant speed operation is defined as the range of operation speed wherein the engine is running at lower fuel consumption but paid the operation region with comparatively higher fuel saving of comparatively higher output power so to reach the brake specific fuel consumption;
The load (102) is driven by the rotation kinetics from the engine power;
When adapted with the optional rechargeable device (106), the system provides the operation of the parallel combined power system for the power from the rechargeable device (106) to drive either or both of the primary and the secondary dynamo-electric units (101), (103) to function as a motor to jointly drive the load (120) with the power from the engine, or in case of a light load, while driving the load (120), the power form the engine is used to drive either or both of the primary and the secondary dynamo-electric units (101), (103) to charge the rechargeable device (106) or supply power to another load (130); in case of a heavy load, the power from the rechargeable device (106) drives either or both of the primary and the secondary dynamo-electric units (101), (103) for jointly driving the load with the power from the engine;
The power from the rechargeable device (106) drives either or both of the primary and the secondary dynamo-electric units (101), (103) to function as a motor for driving the load (120);
The power from the engine drives either or both of the primary and the secondary dynamo-electric units (101), (103) to function as a generator to charge the rechargeable device (106) or to supply power to another load (130);
The load (102) is used to inversely drive either or both of the primary and the secondary dynamo-electric units (101), (103) to function as a generator to charge the rechargeable device (106) or supply power to another load (130);
Mechanical damper of the engine functions as the brake, or if the rechargeable device (106) is adapted, either or both of the primary and the secondary dynamo-electric units (101), (103) operates at the same time as a generator to charge the rechargeable device (106) or to supply power to another load (130) for creating the braking function by regeneration;
The rechargeable device (106) drives either or both of the primary and the secondary dynamo-electric units (101), (103) to function as a motor to start the engine; and
The system provides all or any part of those functions described above.

5. A series and parallel combined dual power system as claimed in claim 3, wherein, the functions of the system provided by the interaction among all key power units include:
System functions 1, 2: related to that the rechargeable device (106) is adapted for the system to function as the series combined power system for driving the load;
System functions 3, 4: related to that the rechargeable device (106) is not adapted to the system, and the system functions as the series combined power system for driving the load;
System function 5: related to that the power from the engine as the active power source (100) drives the load (120);
System functions 6, 7, and 8: related to that the power from the engine as the active power source (100) and the power from the rechargeable device (106) jointly drive either or both of the primary and the secondary dynamo-electric units (101), (103) to function as a generator so to jointly drive the load (120);
System functions 9, 10, and 11: related to that the power from the engine as the active power source (100) drives the load (120) and drives at the same time either or both of the primary and secondary dynamo-electric units (101), (103) to function as a generator so to charge the rechargeable device (106) or supply power to another power driven load (130) (including any external load not specified);
System functions 12, 13, and 14: related to that the power from the rechargeable device (106) drives either or both of the primary and the secondary dynamo-electric units (101), (103) to function as a motor for driving the load (120);
System functions 15, 16, and 17: related to that the power from the engine as the active power source (100) drives either or both of the primary and the secondary dynamo-electric units (101), (103) to function as a generator so to charge the rechargeable device (106) or supply power to another power driven load (130) (including any external load not specified);
System functions 18, 19, and 20: related to that the load (120) inversely draws either or both of the primary and the secondary dynamo-electric units (101), (103) to function as a generator so to charge the rechargeable device (106) or supply power to another power driven load (130) (including any external load not specified) for achieving the purpose of regenerating by reclaiming the kinetics to exercise the brake;
System function 21: related to that the mechanical damper of the engine as the active power source (100) exercises the brake on the load (120);
System functions 22, 23, and 24: related to that the mechanical damper of the engine as the active power source (100) exercises the brake on the load (120), and either or both of the primary and the secondary dynamo-electric units (101), (103) simultaneously functions as the regeneration to charge the rechargeable device (106) or another load (130) driven by power, and further to exercise the brake on the load (120);
System functions 25, 26, and 27: related to that the power from the rechargeable device (106) drives either or both of the primary and the secondary dynamo-electric units (101), (103) to function as a motor for starting the engine.

6. A series and parallel combined dual power system as claimed in claim 3, wherein, the system provides all or any part of those functions listed in Table A:
System function 1: a rechargeable device is adapted to the system to drive the load;
System function 2: the system is adapted with the rechargeable device while the engine is running at a constant speed to drive the system to provide series combined power operation for driving the load;
System function 3: the system without the adaptation of the rechargeable device provides the series combine power operation to drive the load;.
System function 4: the system without the adaptation of the rechargeable device has the engine running at a constant speed to drive the system to provide the series combine power operation to drive the load;
System function 5: the system drives the load by the power from the engine.
System function 6: the system has the power from the engine and both of the primary and the secondary dynamo-electric units functioning as a motor in case of a heavy load to jointly drive the load;
System function 7: the system has the power from the engine and the primary dynamo-electric unit functioning as a motor driven by the rechargeable device in case of a heavy load to jointly drive the load;
System function 8: the system has the power from the engine and the secondary dynamo-electric unit functioning as a motor driven by the rechargeable device in case of a heavy load to jointly drive the load.
System function 9: the power from the engine drives the load, and the primary dynamo-electric unit to function as a generator for charging the rechargeable device or supplying power to another load;
System function 10: the power from the engine drives the load, and the secondary dynamo-electric unit to function as a generator to charge the rechargeable device or to supply power to another load;
System function 11: the power from the engine drives the load and both of the primary and the secondary dynamo-electric units to function as a generator for charging the rechargeable device or supplying power to another load.
System function 12: the power form the rechargeable device drives the primary dynamo-electric unit to function as a motor for driving the load;
System function 13: the power from the rechargeable device drives the secondary dynamo-electric unit to function as a motor for driving the load;
System function: the power form the rechargeable device drives both of the primary and the secondary dynamo-electric units to function as a motor for driving the load;
System function 15: the engine runs at a constant speed to drive the primary dynamo-electric unit to function as a generator for charging the rechargeable device or supplying power to another load;
System function 16: the engine runs at a constant speed to drive the secondary dynamo-electric unit to function as a generator for charging the rechargeable device or supplying power to another load;
System function 17: the engine runs at a constant speed to drive both of the primary and the secondary dynamo-electric units to function as a generator for charging the rechargeable device or supplying power to another load;
System function 18: the system has the load to operate as the brake to draw the primary dynamo-electric unit for functioning as a generator to charge the rechargeable device or to supply power to another load;
System function 19: the system has the load to exercise the operation of a brake so to draw the secondary dynamo-electric unit to function as a generator for charging the rechargeable device or supplying power to another load;
System function 20: the system has the load to exercise the operation of a brake to draw both of the primary and the secondary dynamo-electric units to function as a generator for charging the rechargeable device or supplying power to another load;
System function 21: the engine has the damper to exercise the operation of brake on the load;
System function 22:, the engine is used as the damper to exercise brake on the load while the primary dynamo-electric functions as a generator to regenerate by reclaiming the kinetics for regenerating so to charge the rechargeable device or to supply power to another load;
System function 23: the secondary dynamo-electric unit functions as a generator to regenerate by reclaiming the kinetics for regenerating so to charge the rechargeable device or to supply power to another load;
System function 24: both of the primary and the secondary dynamo-electric units functioning as a generator to regenerate by reclaiming the kinetics so to charge the rechargeable device or to supply power to another load;
System function 25: the power from the rechargeable device drives the primary dynamo-electric unit to function as a motor to start the engine;
System function 26: the power from the rechargeable device drives the secondary dynamo-electric unit to function as a motor to start the engine; and
System function 27: the power from the rechargeable device drives both of the primary and the secondary dynamo-electric units to function as a motor to start the engine. The constant speed of the engine among those system functions described above is defined as the range of operation speed wherein the engine is running at lower fuel consumption but paid the operation region with comparatively higher fuel saving of comparatively higher output power so to reach the optimal brake specific fuel consumption.

7. A series and parallel combined dual power system as claimed in claim 3, wherein, the series and parallel combined dual power system of the present invention has the engine as the active power with its essential structure and functions described as follows:
The rotary part of the engine serving as the active rotation power source (100) is directly couple to that of the primary dynamo-electric unit (101); or alternatively, an optional clutch (102) or a variable transmission unit (109) may or may not be provided between the active rotation power source (100) and the primary dynamo-electric unit (101);
The rotation kinetics outputted from the engine serving as the active rotation power source (100) drives the rotary part of the primary dynamo-electric unit (101) to function as a generator; the clutch (112) is provided between the rotary part of the primary dynamo-electric unit (101) and that of the secondary dynamo-electric unit (103); when the system is converted into the operation as the series combined power system, the clutch (112) is not coupled; instead, the engine serving as the active rotation power source (100) drives the primary dynamo-electric unit to function as a generator with the outputted power to further drive the secondary dynamo-electric unit to function as a motor for driving the load; if as required, the system is adapted with the rechargeable device (106) and other power driven load, the power generated by the primary dynamo-electric unit charges the rechargeable device (106) or supplies power to another load in case of a light load or no-load;
In the normal load, the clutch (112) located between both of the primary and the secondary dynamo-electric units is closed; the optional clutch (102) may or may not be provided between the rotary part of the engine serving as the active rotation power source (100) and that of the primary dynamo-electric unit (101); if the clutch (102) is provided, it is also closed; the optional clutch (122) may or may not be provided between the secondary dynamo-electric unit (103) and the load; and if the clutch (1122) is provided, it is also closed so that the rotation kinetics outputted form the engine serving as the active rotation power source (100) drives the load through the rotary part of the primary dynamo-electric unit (101) and that of the secondary dynamo-electric unit (103). If as required, the optional rechargeable device (106) is provided and in case of a heavy load, the clutch (112) is closed and the system indicates operation of the parallel combined power system. The optional clutches (102) and (122) may or may not be provided to the system. If the clutch (102) is provide, it is also closed; if the clutch (122) is provided, it is also closed; instead, the power from the rechargeable device (106) drives either or both of the primary and the secondary dynamo-electric units (101), (103) to function as a motor with the rotation kinetics outputted and that from the engine to jointly drive the load. In case of a light load, either or both of the primary and the secondary dynamo-electric units (101), (103) is converted to function as a generator for charging the rechargeable device (106) or supplying power to another load;
If the rechargeable device (106) and the clutch (102) are provided to the system, the clutch (102) is disengaged and the clutch (112) is closed, then the power from the rechargeable device drives either or both of the primary and the secondary dynamo-electric units (101), (103) to output rotation kinetics for driving the load; if the clutch (112) is disengaged, then the rechargeable device (106) drives the secondary unit (103) to output rotation kinetics for driving the load; and including but not limited to those secondary functions with or without the optional items as the case may be:
The clutch (112) is disengaged (if the optional clutch (102) is adapted, it is also closed), and the power from the rechargeable device (106) drives the primary dynamo-electric unit (101) to function as a motor for starting the engine serving as the active rotation power source (100);
The power from the rechargeable device (106), or that from the redundant rechargeable device (110) drives the optional start motor (124) through the optional start switch (111) to start the engine serving as the active rotation power source (100) through the variable transmission unit (109);
The clutch (112) is controlled to indicate disengaged status while the power from the rechargeable device (106) controls the speed, torque, and orientation of the secondary dynamo-electric unit (104) to function as a motor through the drive control unit (104) for outputting to drive the load; and
The clutch (112) is controlled to indicate closed status for the engine serving as the active rotation power source (100) to revolve in positive or negative orientation through the optional variable transmission unit (109) to output kinetics to drive the load.
For environmental consideration, the demands of the driving power in case that the engine fails, and the energy storage demands when the regenerated power exercises a brake, the series and parallel combined dual power drive system of the present invention may be adapted with the optional rechargeable device (106), so to control the generation power when the rotation kinetics from the engine serving as the active rotation power source (100) drives the primary dynamo-electric unit (101) to serve as a generator, and further to charge the rechargeable device (106) in case of no-load, light load or at other proper time, or to supply power to another power driven load (130). Functions provided by the system include:
When the system operates as the series combined power system, it controls the clutch (112) to indicate disengaged status (as required, the clutch (102) and the clutch (122) may or may not be provided to the system; if the clutch (102) is provided, it is closed; if the clutch (122) is provided, it is also closed). As the system operates as the series combined power system, the rotation kinetics from the engine serving as the active rotation power source (100) drives the primary dynamo-electric unit (101) to function as a generator with the power generated while directly driving the secondary dynamo-electric unit to function as a motor for driving the load (120), further charges at random the rechargeable device (106) when adapted, or supplies power to another load (130) for the engine serving as the active rotation power source (100) to operate in a range featuring higher energy efficiency;
When the system operates as the parallel combined power system, the clutch (112) is closed (as required, the clutch (102) and the clutch (122) may or may not be provided to the system; if the clutch (102) is provided, it is closed; if the clutch (122) is provided, it is also closed), and the rotation kinetics fro the engine serving as the active rotation power source (100) directly drives the load (120); if the rechargeable device (106) is adapted and in case of a light load (120), the engine drives either or both of the primary and the secondary dynamo-electric units (101), (103) to function as a generator to charge the rechargeable device (106) or to supply power to another power driven load (130) for the active rotation power source (100) to operate in a range feature higher energy efficiency;
When the system operates as the parallel combined power system, the clutch (112) is controlled to indicate closed status (as required, the clutch (102) and the clutch (122) may or may not be provided to the system; if the clutch (102) is provided, it is closed; if the clutch (122) is provided, it is also closed), the power from the rechargeable device (106) drives either or both of the primary and the secondary dynamo-electric units (101), (103) to operate as a motor to output rotation kinetics together with that outputted from the engine serving as the active rotation power source to jointly drive the load;
When the system controls the clutch (112) to indicate disengaged status on the drive power outputted from the rechargeable device (106), the power from the rechargeable device (106) also drives the secondary dynamo-electric unit (103) to drive the load (120), or controls the clutch (112) to indicate closed status (if the optional clutch (102) is adapted, it is also controlled to indicate closed status), and the power from the rechargeable device (106) drives either or both of the primary and the secondary dynamo-electric units (101), (103) to function as a motor for driving the load (120); and if the clutch (122) is adapted to the system, the clutch (122) also indicates closed status;
If the system operates as a generator to control the clutch (112) to indicate disengaged status (if the optional clutch (102) is adapted, it indicates closed status), and the engine serving as the active rotation power source (100) drives the primary dynamo-electric unit (101) to function as a generator to output power, or when the optional clutch (122) is adapted to the system and the clutch (122) indicates disengaged status (if the optional clutch (102) is adapted, it is also controlled to indicate closed status), the engine serving as the active rotation power source (100) drives either or both of the primary and the secondary dynamo-electric units (101), (103) to function as a generator to output power to charge the rechargeable device (106) or to supply power to another power driven load (130);
Both of the primary and the secondary dynamo-electric units to regenerate by reclaiming the kinetics for exercising the brake, the clutch (112) indicates disengaged status, and the secondary dynamo-electric unit (103) is converted to function as a generator to charge the rechargeable device (106) or to supply power to another power driven load (130); if the optimal clutch (122) is adapted to the system, both clutches (10), (112) indicate closed status; or when the optimal clutch (102) is adapted to the system with the clutch (102) indicating disengaged status and the clutch (112) indicating closed status, then either or both of the primary and the secondary dynamo-electric units (101), (103) is converted to function as a generator for charging the rechargeable device (106) or supplying power to another power driven load (130) to exercise the brake by the regenerated power, and if the optional clutch (122) is adapted to the system, the clutch (122) indicates closed status;
The mechanical damper of the engine is directly used to exercise the brake, or if the rechargeable device (106) is adapted, either or both of he primary and the secondary dynamo-electric units (101), (103) functions at the same time as a generator to charge the rechargeable device (106) or to supply power to another power driven load (130) for providing the brake by the regenerated power;
When the power from the rechargeable device (106) drives the dynamo-electric unit to start the engine, the clutch (112) is controlled to indicate disengaged status, the power from the rechargeable device (106) drives the primary dynamo-electric unit (101) to function as the start motor to start the engine serving as the active rotation power source (100); or when the optional clutch (122) is adapted to the system, the clutch indicates disengaged status and the clutch (112) indicates closed status, and the power from the rechargeable device (106) drives either or both of he primary and the secondary dynamo-electric units (101), (103) to function as a start motor to start the engine serving as the active rotation power source (100); and
The system provides all or any of those functions described above.

8. A series and parallel combined dual power system as claimed in claim 3, wherein, the system is not adapted with a clutch between the output end and the load. As illustrated in FIG. 30, the clutch (112) is not adapted to where between the output end and the load side of the system. If the input end of the load is adapted with a clutch, the variable transmission dose not provide idling shift function, and the secondary dynamo-electric unit (103) fails to function as a generator driven by the engine serving as the active power source (100) of the system, nor as a motor to start the engine claimed in claim 6; and the system may be selected to provide system functions 1˜15, and all or any part of system functions 18˜15 listed in Table B.

9. A series and parallel combined dual power system as claimed in claim 3, wherein, no optional clutch (102) is provided at where between the engine serving as the active rotation power source (100) and the primary dynamo-electric unit (101); therefore, the primary dynamo-electric unit (101) does not function as a motor to drive the load as claimed in claim 5, nor regenerates by reclaiming the kinetics to exercise the brake; instead, the system as selected provides all or any part of those system functions 1˜11, 13, 15˜17, 19, 21˜27 as listed in Table C.

10. A series and parallel combined dual power system as claimed in claim 3, wherein, there is no clutch (102) provided between the engine serving as the active rotation power source (100) and the primary dynamo-electric unit (101); nor the clutch (122) provided between the output end and the load side of the system; if the input end of the load is not adapted with a clutch, the variable transmission device does not provide idling function, then the secondary dynamo-electric unit (103) fails to provide the function as a generator for the engine driven by the active power source (100) or as a start motor to start the engine among the system functions as claimed in claim 6; nor the primary dynamo-electric unit (101) to function as a motor to drive the load or regenerate by reclaiming the kinetics for exercising the brake among those functions as claimed in claim 6. The system may provide all or any part of system functions 1˜11, 13, 15, 19, and 21˜25 of those functions listed in Table D.

11. A series and parallel combined dual power system as claimed in claim 3, wherein, the system has the engine serving as the active rotation power source (100) directly driven by the primary dynamo-electric unit (101) alone or through the transmission (119) or the clutch (102); the output end of the active rotation power source (100) is directly or through a transmission unit (109) and the clutch (112) coupled to the secondary dynamo-electric unit (103); thereby, the output end of the secondary dynamo-electric unit (103) is coupled to the load (120) through the clutch (122). The primary dynamo-electric unit (101) may function as a generator and a motor as required, or only as a generator. Accordingly, the primary dynamo-electric fails to function as the motor to drive the load (120) or to function alone to regenerate by reclaiming kinetics to exercise brake on the load (120) within the configuration as claimed in claim 6. Alternatively, the system may provide all or any part of those system functions 1˜11, 13, 15˜17, 19 and 21˜27 as listed in Table E.

12. A series and parallel combined dual power system as claimed in claim 1, wherein, the number of the secondary dynamo-electric unit (103) may be less than, greater than or equal to that of the primary dynamo-electric unit (101) coupled to the same number of the clutch or the variable transmission unit for transmission; and those multiple secondary dynamo-electric units (103) may individually or jointly drive the load; and different layouts of spatial configuration among the constituent units are allowed without changing the mechanism of the system.

13. A series and parallel combined dual power system as claimed in claim 3, wherein, the variable transmission unit (109) adapted to the output end of the active rotation power source (100) is driven by the active rotation power source (100), the individual output end of the variable transmission unit (109) is provided to respectively drive two or more than two rear end loads same as those claimed in claim 3 including multiple primary dynamo-electric units, clutches (112), secondary dynamo-electric units (103) and related transmission units; and the variable transmission (109) for power distribution may be provided in the form of semi-automatic, or manual variable transmission device, or one with fixed speed ratio, or a differential gear set, epicyclical gear set, or other variable transmission device of the prior art

14. A series and parallel combined dual power system as claimed in claim 3, wherein, the variable transmission unit (109) adapted to the output end of the primary dynamo-electric unit (101) is driven by the primary dynamo-electric unit (101). The individual output end of the variable transmission unit (109) is provided to respectively drive two or more than two rear end loads same as those claimed in claim 3 including multiple secondary dynamo-electric units, clutches (112), secondary dynamo-electric units (103) and related transmission units; and the variable transmission (109) for power distribution may be provided in the form of semi-automatic, or manual variable transmission device, or one with fixed speed ratio, or a differential gear set, epicyclical gear set, or other variable transmission device of the prior art.

15. A series and parallel combined dual power system as claimed in claim 3, wherein, the individual output end of the variable transmission unit (109) further driven by the clutch (112) driven by the primary dynamo-electric unit (101) is provided respectively to drive multiple rear end loads same as those claimed in claim 3 including multiple secondary dynamo-electric unit (103) and related transmission device; and the variable transmission (109) for power distribution may be provided in the form of semi-automatic, or manual variable transmission device, or one with fixed speed ratio, or a differential gear set, epicyclical gear set, or other variable transmission device of the prior art.

16. A series and parallel combined dual power system as claimed in claim 3, wherein, the individual output end of the system driven by the secondary dynamo-electric unit (103) is provided respectively to drive multiple rear end loads same as those claimed in claim 3 including multiple loads and related transmission device; and the variable transmission (109) for power distribution may be provided in the form of semi-automatic, or manual variable transmission device, or one with fixed speed ratio, or a differential gear set, epicyclical gear set, or other variable transmission device of the prior art.

17. A series and parallel combined dual power system as claimed in claim 3, wherein, the output end of the clutch (112) driven by the primary dynamo-electric unit (101), the output end and the load end of the secondary dynamo-electric unit (103) are incorporated together by the variable transmission unit (109); and the variable transmission (109) for power distribution may be provided in the form of semi-automatic, or manual variable transmission device, or one with fixed speed ratio, or a differential gear set, epicyclical gear set, or other variable transmission device of the prior art.

18. A series and parallel combined dual power system as claimed in claim 3, wherein, the rotation kinetics outputted by the active rotation power source 100 is directly or through the clutch (102) coupled to the primary dynamo-electric unit (101), and to the secondary dynamo-electric unit (103) through the clutch (112); and the variable transmission (109) for power distribution may be provided in the form of semi-automatic, or manual variable transmission device, or one with fixed speed ratio, or a differential gear set, epicyclical gear set, or other variable transmission device of the prior art.

19. A series and parallel combined dual power system as claimed in claim 3, wherein, the rotation kinetics outputted by the active rotation power source (100) may be directly coupled from the variable transmission unit (109) or through the clutch (102) to the primary dynamo-electric unit (101) and coupled to the variable transmission unit (109) through the clutch (112), together with the individual output end of the variable transmission unit (109) coupled through the clutch (112) to respectively drive multiple secondary dynamo-electric units (103) and loads; and the variable transmission (109) for power distribution may be provided in the form of semi-automatic, or manual variable transmission device, or one with fixed speed ratio, or a differential gear set, epicyclical gear set, or other variable transmission device of the prior art.

20. A series and parallel combined dual power system as claimed in claim 3, wherein, both of the primary and the secondary dynamo-electric units (101), (103) may be further comprised of a coaxial structure including three layers, respectively an outer circle dynamo-electric structure (1011), a middle circle dynamo-electric structure (1012) and an inner circle dynamo-electric structure (1013); the outer circle dynamo-electric structure (1011) and the interlocked part between the outer circle dynamo-electric structure (1011) and the middle circle dynamo-electric structure (1012) define where provides the function of the primary dynamo-electric unit (101); the inner circle dynamo-electric structure (1013) and the interlocked part between the middle and the inner dynamo-electric structures (1012), (1013) define where provides the function of the secondary dynamo-electric unit (103); the middle circle dynamo-electric structure (1012) does not rotate since its shares the same structure with the other two circle dynamo-electric structures (1011), (1013) and is fixed to the casing of the system; the outer circle dynamo-electric structure (1011) is directly coupled to the active rotation power source (100), or alternatively, the clutch (102) or the variable transmission unit (109) is provided; and the clutch (112) is provided between the outer and the inner circle dynamo-electric structures (1011), (1013); and the inner dynamo-electric structure (1013) is coupled to the load driven.

21. A series and parallel combined dual power system as claimed in claim 3, wherein, both of the primary and the secondary dynamo-electric units (101), (103) may be further comprised of a coaxial structure including three layers, respectively an outer circle dynamo-electric structure (1011), a middle circle dynamo-electric structure (1012) and an inner circle dynamo-electric structure (1013); the outer circle dynamo-electric structure (1011) and the interlocked part between the outer circle dynamo-electric structure (1011) and the middle circle dynamo-electric structure (1012) define where provides the function of the primary dynamo-electric unit (101); the inner circle dynamo-electric structure (1013) and the interlocked part between the middle and the inner dynamo-electric structures (1012), (1013) define where provides the function of the secondary dynamo-electric unit (103); the outer circle dynamo-electric structure (1011) does not rotate since its shares the same structure with the other two circle dynamo-electric structures (1012), (1013) and is fixed to the casing of the system; the middle circle dynamo-electric structure (1012) is directly coupled to the active rotation power source (100), or alternatively, the clutch (102) or the variable transmission unit (109) is provided; and the clutch (112) is provided between the middle and the inner circle dynamo-electric structures (1012), (1013); and the inner dynamo-electric structure (1013) is coupled to the load driven.
